(19) United States
(12) Patent Application Publication
(10) Pub. No.: US 2023/0285806 A1
(43) Pub. Date: Sep. 14, 2023

(54) SYSTEMS AND METHODS FOR INTELLIGENT FITNESS SOLUTIONS

(71) Applicant: ASENSEI, INC., San Francisco, CA (US)

(72) Inventors: Steven Webster, Calistoga, CA (US); William Jeffrey Burgar, Hertfordshire (GB); Ross Andrew Arnott, Edinburgh (GB)

(21) Appl. No.: 18/119,091

(22) Filed: Mar. 8, 2023

Related U.S. Application Data
(60) Provisional application No. 63/317,637, filed on Mar. 8, 2022.

(51) Int. Cl. A63B 24/00; G06T 17/00; G06T 7/20; G06T 7/70; G06T 7/00; A63B 71/06

(52) U.S. Cl. CPC A63B 24/0075; G06T 17/00; G06T 7/20; G06T 7/70; G06T 7/0002; A63B 71/0622; G06T 2207/30196; A63B 2071/0625; A63B 2220/05; A63B 2071/0636; A63B 2220/17; A63B 2024/0068; A63B 2230/62

(57) ABSTRACT

Systems and methods are provided for provided for recognizing movements of a moving body and presenting multimedia content according to the movements to provide instructional learning. As an example of the systems and methods, movement recognition is provided that generates a body object stream from raw data of movements, recognizes techniques for the movements based on the body object stream, and assesses a performance of the techniques. A coaching intelligence is provided that fetches and communicates multimedia content descriptive of the techniques according to the performance and based on one or more configuration files defining coaching strategies and a mapping of multimedia content. The systems and methods provided herein can be leveraged for recognition of human movements in a fitness environment for provisioning of multimedia content consumable for instructional learning of techniques performed as part of a fitness or exercise routine.

### CROSS-REFERENCE TO RELATED APPLICATIONS

This application claims the benefit of U.S. Patent Provisional Application No. 63/317,637, filed on Mar. 8, 2022, entitled “SYSTEMS AND METHODS FOR INTELLIGENT FITNESS SOLUTIONS,” which is hereby incorporated by reference.

### BACKGROUND

An area of ongoing research and development is in fitness management. In particular as various forms of exercise are continuously developed, there exists a need for systems for coaching users in the various forms of exercise.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example infrastructure in which systems disclosed herein may operate in accordance with various embodiments.

FIG. 2 is a schematic block diagram of an example human movement recognition system according to embodiments of the present disclosure.

FIG. 3A depicts an example body object model representation of a posture created by the human movement recognition system of FIG. 2, according to an embodiment of the present disclosure.

FIG. 3B depicts an illustrative example of inferring an orientation of an example segment of the body object of FIG. 3A in accordance with an embodiment of the present disclosure.

FIG. 4 illustrates an example block diagram of a exercise routine data structure in accordance with embodiments of the present disclosure.

FIG. 5 is a schematic representation of a process for recognizing a technique from a body object stream in accordance with embodiments of the present disclosure.

FIG. 6 is a schematic block diagram of an example coaching intelligence system in accordance with embodiments of the present disclosure.

FIG. 7 illustrates an example nuance trait matrix in accordance with an embodiment of the present disclosure.

FIG. 8 is a schematic block diagram of an example model creation system 800 in accordance with embodiments of the present disclosure.

FIG. 9 is an example computer system that may be used to implement various features of human movement recognition and coaching intelligence of the present disclosure.

The figures are not exhaustive and do not limit the present disclosure to the precise form disclosed.

### DETAILED DESCRIPTION

Embodiments of the technology disclosed herein provide for human movement recognition that can be leveraged for recognizing movements and characterizing a quality and correctness of the movement. Embodiments disclosed herein can detect postures of a movement performed by a human over time from raw data collected by sensors. Sensors, according to various embodiments, include, but are not limited to, image sensor data capturing one or more image frames of the performed movement, inertial measurement unit (IMU) sensor data of detected motion, and any sensor capable of collecting positional and orientation data. The detected postures performed by the human being can be used to recognize specific postures corresponding to a known movement from a plurality of known movements. The embodiments disclosed herein can utilize the recognized postures to recognize the movement performed by the human being as the known movement and determine a measure of performance of that movement relative to a known movement.

In detecting postures, embodiment disclosed herein provides for processing raw data to generate a model representation of postures, a collection of which over a period of time represent a movement performed by the human being. Implementations disclosed herein can be capable of recognizing specific movements by locating one or more sequence of postures of the known movement (referred to herein as “sequence movements”) within the detected postures using a configurable system of comparators and nuance movements for each sequence movement. Comparators and nuance movements can be leveraged for detecting a presence or absence of positive or negative aspects of a particular sequence movement. Embodiments disclosed herein can recognize sequence movements and look for specific nuance movements not only against a single “gold standard” but against a configurable rubric that allows individual coaches or organizations to define how a particular movement, modality, sport, etc., should be performed at different levels of competence and, in various implementations, according to a coaching strategy or style. These implementations allow individuals and organizations to describe coaching strategies that outline how to watch, correct, and coach human movement by observing an individual's performance in real-time. Further, the disclosed technology cleanly separates the role of coach and developer, so that developers can build real-time dynamic and personalized user experiences powered by human movement recognition, with minimal understanding of the underlying movement activity (such as a sport) required.

Various embodiments disclosed herein provide for creation of multimedia content that can be dynamically presented to an individual based on observation, recognition, and evaluation of their movements. The embodiments disclosed herein can function to make decisions about which multimedia content to present to an individual and when to present content based on a coaching strategy that is in place. Accordingly, embodiments disclosed herein can provide for digital coaching and/or instructional interface that mimics real-world in-person instructional approaches. For example, embodiments disclosed herein can leverage the performance measure of a recognized movement to access a mapping of instructional data (referred to herein as an “asset map”) and present instructional content to the human performing the movement on a graphical user interface (e.g., visually, auditory, tactile, or the like) for improving or confirming the performance of the movement. Embodiments disclosed herein may store a plurality of asset maps, each associated with a different known movement. When a movement is recognized, the corresponding mapping can be accessed for providing instructional content related to the recognized movement. Depending on the performance of the recognized movement, an instructional piece of content can be fetched using the mapping that is specifically targeted to the performance, for example, to correct improper performance.

Some embodiments of the present disclosure can leverage movement recognition for creating known movements and the associated asset mapping. For example, the embodiments disclosed herein can obtain raw data provided by an user performing a known movement, which the disclosed embodiments can extract postures and/or movements therefrom and store them for training on recognizing the movement when performed by another person. The known movements can be annotated to provide for sequence movements and/or comparators that can then be used in recognizing the movement performed by another.

Implementations disclosed herein are described in the context of human movement recognition, and more particularly, in the context of recognizing exercises performed as part of a fitness or exercise routine. However, the disclosed technology is not intended to be limited to the illustrative examples. Recognition of human movement and particularly in performing complex exercise routines may be particularly well suited to benefit from the technology disclosed herein, but other applications are equally well suit. For example, the disclosed technology may be applicable to any area in which training of a human may be performed through performing movements, such as driving a vehicle, plane, etc. In another example, the disclosed technology could be implemented for use in issuing instructions to the visually and/or hearing impaired. The disclosed technology can be used in providing instructions for healthcare applications, such as, but not limited to, assisting someone in following a prescribed program of physical therapy. As another example, embodiments disclosed herein are also applicable to industrial athlete applications, such as where athletic training is provided to workers in physically demanding jobs to improve their ability to perform the job more effortlessly and injury free. As another example, embodiments disclosed herein may be used in animal movement recognition that can facilitate training applications, issuing commands, etc. In an illustrative example, movements by a pet, such as a dog, may be recognized through sequence movements of a dictionary of pet movements, and based on the movements content may be presented which can be used to train the animal (e.g., audio commands). Accordingly, the embodiments disclosed herein can be utilized for recognizing movements performed by a moving body, whether living bodies or non-living, inanimate objects, and providing instructional content according to the recognized movements.

It should be noted that the terms “optimize,” “optimal” and the like as used herein can be used to mean making or achieving performance as effective or perfect as possible. However, as one of ordinary skill in the art will recognize, perfection cannot always be achieved. Accordingly, these terms can also encompass making or achieving performance as good or effective as possible or practical under the given circumstances, or making or achieving performance better than that which can be achieved with other settings or parameters.

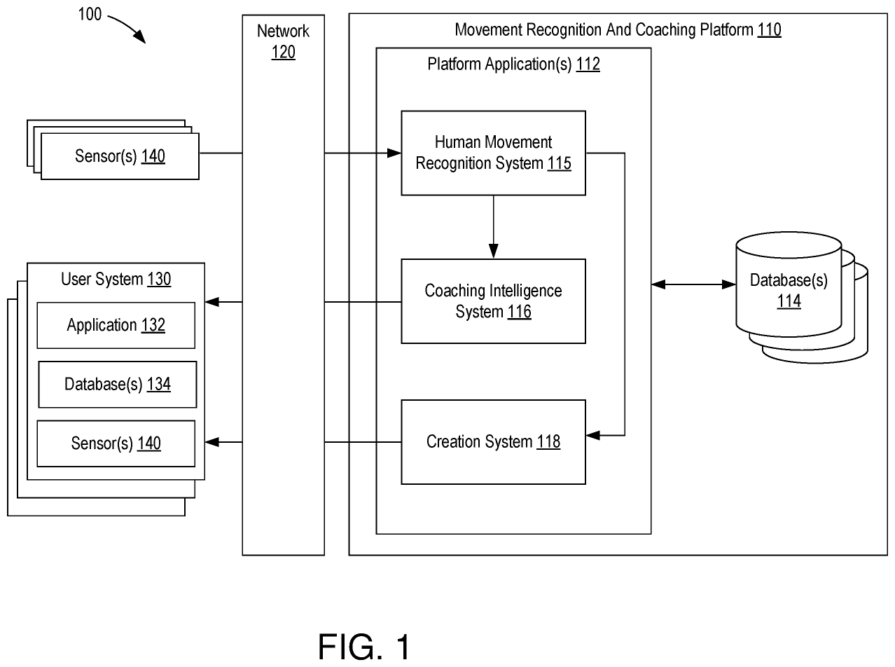

FIG. 1 illustrates an example infrastructure 100 in which the disclosed system may operate, according to an embodiment. The infrastructure may comprise a movement recognition and coaching platform 110, which may be implemented as one or more servers that host and/or execute one or more of the various functions, processes, and/or methods described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to application(s) 112 and/or one or more datastores 114. Application(s) 112 comprises a movement recognition system 115, a coaching intelligence system 116, and a model creation system 118, each of which is communicatively connected to datastore(s) 114. In addition, platform 110 may be communicatively connected to one or more user systems 130 via one or more network(s) 120. Platform 110 may also be communicatively connected to one or more sensors 140 via network(s) 120. In some implementations, platform 110 maybe be implemented as one or more hardware processes of a user system 130 that executes one or more of the various functions, processes, and/or methods described herein.

Network(s) 120 may comprise the Internet, and platform 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. While platform 110 is illustrated as being connected to various systems through a single network(s) 120, it should be understood that platform 110 may be connected to the various systems via different sets of one or more networks. For example, platform 110 may be connected to a subset of user systems 130 and/or sensors 140 via the Internet, but may be connected to one or more other user systems 130 and/or sensors 140 via an intranet. Furthermore, while only a few user systems 130 and sensors 140, one server application(s) 112, and one set of datastore(s) 114 are illustrated, it should be understood that the infrastructure may comprise any number of user systems, platform applications, sensors, and databases.

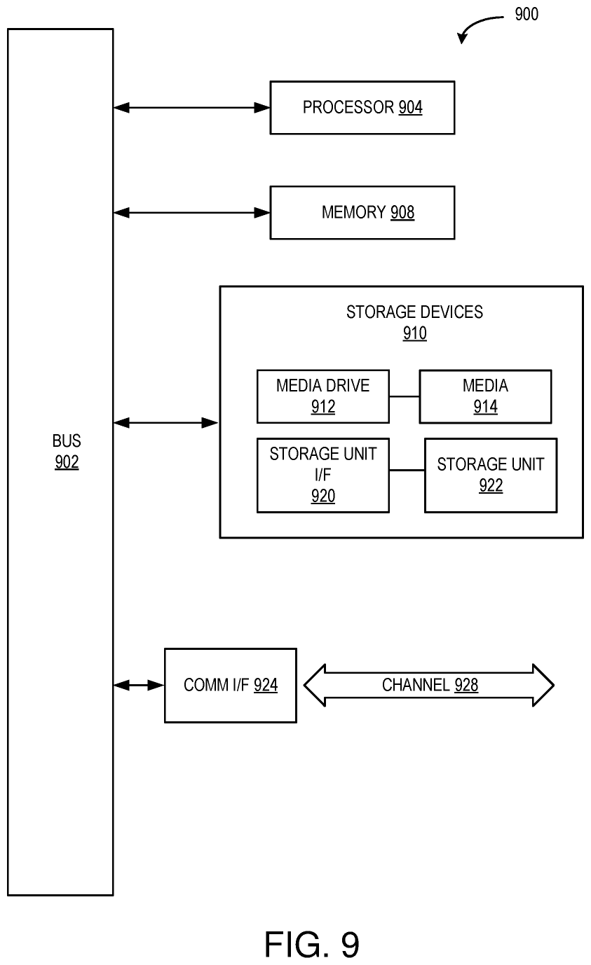

User system(s) 130 may comprise any type or types of computing devices capable of wired and/or wireless communication, including without limitation, desktop computers, laptop computers, tablet computers, smart phones or other mobile phones, wearable mobile devices, servers, game consoles, televisions, set-top boxes, electronic kiosks, and the like. User systems 130 may also comprise connected fitness equipment, which include fitness equipment (such as, but not limited to, bikes, rowing machines, climbing machine, strength training machines, smart mirrors, free weights, kettlebells, etc.) comprising a computation system (such as computing component 900 of FIG. 9) and capable of wired and/or wireless communication. Some implementations of connected fitness equipment may comprise a display screen and/or a tablet computer removably attached or permanently affixed thereto. Such user system(s) 130 may comprise one or more sensors 140. User system(s) 130 refers (refer) to devices and/or systems associated with individuals, such as users, athletes, coaches, instructors, etc. on platform 110. In another example, user system(s) 130 may be associated with brick and mortar facilities, such as training facilities, gyms, health clubs, boutique fitness studios, boxing studios, rowing studios, yoga studios, etc. (collectively these facilities are referred to herein as “connected gyms”).

Platform 110 may comprise web servers which host one or more websites and/or web services. In embodiments in which a website is provided, the website may comprise one or more user interfaces, including, for example, webpages generated in HyperText Markup Language (HTML) or other languages. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., datastore(s) 114) that are locally and/or remotely accessible to platform 110. Platform 110 may also respond to other requests from user system(s) 130.

Sensors 140 may comprise any type of sensor capable of collecting raw data that can be utilized by platform 110 to determine posture and/or movement of a human being, such as inertial measurement unit (IMU) sensors, optical sensors, motion detection sensors, pressure sensors, capacitive sensors, inductive sensors, resistive sensors, etc. Example sensors 140 according to embodiments disclosed herein include, but are not limited to, image sensors (e.g., cameras, infrared sensors, and the like) configured to capture image data (e.g., image frames, a plurality of which sequentially provide video), depth sensors configured to acquire multi-point distance information, point cloud sensors (e.g., LiDAR, RADAR, and the like), IMU sensors (e.g., gyroscopes to measure and report angular velocity along pitch, yaw, and roll axis; accelerometers, such as 2-axis and/or 3-axis accelerometers and the like, to measure and report specific force along perpendicular axes; and the like). Sensors 140 may comprise any type or types of sensors capable of wired and/or wireless communication. For example, sensors 140 may be capable of wired and/or wireless communication with platform 110 via user system(s) 130 and/or network(s) 120. In another example, sensors 140 included in a user system 130 may provide raw data collected by sensors 140, which can be communicated to platform 110 via user system 130.

Platform 110 may further comprise, be communicatively coupled with, or otherwise have access to one or more datastore(s) 114. In an example implementation, datastores 114 may be implemented as, for example, database(s). For example, platform 110 may comprise one or more database servers which manage one or more datastores 114. A user system 130, sensor 140, and/or application(s) 112 executing on platform 110 may submit data (e.g., user data, form data, etc.) to be stored in datastore(s) 114, and/or request access to data stored in datastore(s) 114. Any suitable database may be utilized, including without limitation MySQL™, Oracle™, IBM™, Microsoft SQL™, Sybase™, Access™, and the like, including cloud-based database instances and proprietary databases. Data may be sent to platform 110, for instance, using a POST request supported by HTTP, via FTP, etc. This data, as well as other requests, may be handled, for example, by server-side web technology, such as a servlet or other software module (e.g., application(s) 112), executed by platform 110. In another implementation, datastore(s) 114 may be implemented as random access memory (RAM) or other dynamic memory or non-transitory storage medium that can be used for storing information and instructions to be executed by a hardware processor (e.g., as described below in connection with FIG. 9). Datastore(s) 114 may also be implemented as a read only memory (“ROM”) or other static storage device.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130 can define its (their) own user interfaces, and rely on the web service to implement or otherwise provide the backend processes, methods, functionality, storage, etc., described herein. For example, in such an embodiment, a client application 132, communicatively coupled to a datastore 134, executing on one or more user system(s) 130 may interact with applications 112 executing on platform 110 to execute one or more or a portion of one or more of the various functions, processes, methods, and/or software modules described herein. Datastore 134 may be similar to datastore 114 in implementation. Client application 132 may be “thin,” in which case processing is primarily carried out server-side by application(s) 112 on platform 110. A basic example of a thin client application is a browser application, which simply requests, receives, and renders webpages at user system(s) 130, while the application(s) 112 on platform 110 is responsible for generating the webpages and managing database functions. Alternatively, the client application may be “thick,” in which case processing is primarily carried out client-side by user system(s) 130. In some “thick” implementations, application(s) 132 comprises movement recognition system 115, coaching intelligence system 116, and model creation system 118, each of which is communicatively connected to datastore(s) 134. It should be understood that client application 132 may perform any amount of processing, relative to application(s) 112 on platform 110, at any point along this spectrum between “thin” and “thick,” depending on the design goals of the particular implementation. In some implementations, platform 110 may be implemented as software development kit (SDK) that can be compiled into application(s) 132 on a user system 130, application(s) hosted on an edge or cloud server, or applications shared or distributed between user system 130 and the edge or cloud server. In any case, the application described herein, which may wholly reside on either platform 110 (e.g., in which case application(s) 112 performs all processing) or user system(s) 130 (e.g., in which case application 132 performs all processing) or be distributed between platform 110 and user system(s) 130 (e.g., in which case application(s) 112 and client application 132 both perform processing), can comprise one or more executable software modules that implement one or more of the processes, methods, or functions of the application(s) described herein.

Sensors 140 are configured to provide raw data to platform 110 that can be used by platform 110 to recognize movement of one or more human beings. The raw data can be communicated to platform 110 and stored in datastore(s) 114. Sensors 140 may comprise any type of sensor capable of collecting raw positional and/or movement data that can be used by platform 110 to detect positions and/or movements, such as inertial measurement unit (IMU) sensors, optical sensors, motion detection sensors, etc. Example sensors 140 according to embodiments disclosed herein include, but are not limited to, image sensors (e.g., cameras, infrared sensors, and the like) configured to capture image data (e.g., image frames, a plurality of which sequentially provide video), depth sensors configured to acquire multi-point distance information, point cloud sensors (e.g., LiDAR, RADAR, and the like), IMU sensors (e.g., gyroscopes to measure and report angular velocity along pitch, yaw, and roll axis; accelerometers, such as 2-axis and/or 3-axis accelerometers and the like, to measure and report specific force along perpendicular axes; and the like). Sensors 140 may be capable of wired and/or wireless communication. For example, sensors 140 may be capable of wired and/or wireless communication with platform 110 via user system(s) 130 and/or network(s) 120. In another example, sensors 140 may be part of a user system 130, which can communicate raw data collected by sensors 140 to platform 110 via network(s) 120.

As alluded to above, platform 110 includes movement recognition system 115 that can function to detect movement of one or more human beings as a plurality of postures for each human being over a period of time. Sensors 140 can collect raw data over the period of time, and movement recognition system 115 can use the raw data in detecting a number of postures over that time period. A given period of time can consist of a plurality of instances in time (referred herein as “slices”). Raw data collected by sensors 140 at each slice can be used by movement recognition system 115 to determine relative positions and orientations of body parts (e.g., the head, arms, legs, torso, shoulders, etc.) of the human being for that slice. The relative positions and orientations can be used to determine a posture for that slice. Postures can be stored by movement recognition system 115 in datastore(s) 114 (or datastore 134, depending on the implementation) as posture data, each associated with a slice (e.g., via a timestamp).

Movement recognition system 115 can also function to detect one or more movements performed by the one or more human beings. As used herein, movement can be a function of postures over a period of time. As described above, movement recognition system 115 can determine postures over a period of time (e.g., for each slice of the period of time). Movement recognition system 115 can track relative changes between postures across a plurality of slices to recognize a movement. For example, a movement can be recognized by determining positional changes in a second posture associated with a second slice relative to a first posture associated with a first slice. Tracking the changes across a number of slices can be used to recognize a full movement. For example, movement recognition system 115 can determine, as a weight lifter lowers their torso to a bottom posture of a squat movement, that the weight lifter is lowering their torso by comparing a previous posture (e.g., full upright position with chest up and shoulders back) to the current posture (e.g., bottom or maximum depth of the squat). Movement recognition system 115 can recognize the change in posture as a movement due to relative change between postures. Thus, movement recognition system 115 can function to capture movement in real-time as postures change over time, which can be stored in datastore(s) 114 as movement data. Accordingly, movement recognition system 115 can detect postures over time that are indicative of the one or more movements performed by a human. Other types of movement can be detected by movement recognition system 115, such as movement of a human traversing a space (referred to herein as a capture volume). Where movement is intended to encompass more postures, the movement can be referred to as movement in space or capture volume. Additional details on methods and systems for recognizing movement by comparing detected movement and/or postures against a dictionary of movements can be found, for example, in U.S. Pat. No. 11,302,214, the disclosure of which is incorporated herein by reference in its entirety.

The period of time over which postures define movements may be any length of time over which one or more movements are performed. For example, in the case of a squat, the period of time may correspond to an amount of time for the weight lifter to transition from an upright posture, down into a bottom or maximum depth posture of the squat, and back up to the upright posture. In some implementations, the slices of the time period may be periodic having a consistent interval therebetween. For example, in the case of image sensors capturing video of the squat, slices may correspond to each nth image frame, where n is an integer greater than 0. In another example, the interval may be time based, for example, every nth second, nth minute, etc.

Embodiments herein provide for numerous approaches for collecting raw data using sensors 140. For example, according to various embodiments disclosed herein, sensors 140 may include an image sensor, such as a camera or similar optical sensor. An image sensor captures sequential image frames of movements performed by one or more human beings. In this case, an image frame may represent a slice from which a posture of the human can be captured, and image frames may be capture according to any desired frame rate (e.g., 24 frames-per-second, 60 fps, 120 fps, etc.). The sequential image frames form a video of the one or more persons performing movements (e.g., a number of postures over time). In an example implementation, the image sensor can be included as part of a user system 130, such as a smartphone. In another example, image sensors installed on a television, computer, laptop, and/or tablet can be used as a sensor 140. For example, a television image sensor may be utilized for motion capture of an individual while at-home or at a kiosk environment, such as in a gym, studio, or retail store setting.

In some implementations, a plurality of image sensors (either from the same user system or multiple user systems) can be used to capture images of movements, for example, by capturing multiple viewpoints through a combination of fields of view (FOVs) of each image sensor, which may assist in identifying postures and improving accuracy of movement recognition. For example, a portion of a person may be occluded from a FOV of a first image sensor at certain points over the time period. A FOV of one or more other image sensors that capture the occluded portion may be utilized to supplement that of the first image sensor. In another example, combining multiple FOVs for multiple image sensors can be used for motion capture of one or more persons as the one or more persons move about a geographic area (referred to herein as a capture volume). For example, one or more persons may move around a room, field, or other defined area while performing movements, and multiple image sensors may be used to track the one or more persons' movements throughout the capture volume.

In another example, sensors 140 may be disposed on fitness equipment, such as connected fitness equipment capable of wired and/or wireless communication (e.g., connected bike, connected rowing machine, connected climbing machine, connected strength training machine, connected smart mirror, or the like). Connected fitness equipment may be a user system 130 and/or communicatively connected to a user system 130. In this example, the sensor 140 may be used for capturing raw data of an individual as they perform movements on the connected equipment. Additionally, sensors 140 of a connected fitness equipment can be used to capture raw data of an individual within the FOV of the sensor 140, such as, but not limited to, the floor, a yoga mat, or using other pieces of equipment that are not connected, such as weights, a kettlebell, and like.

In some embodiments, sensors 140 may be physically separate from user systems 130. For example, security cameras, web cameras, and/or other types of image sensors may be affixed to sections of the capture volume (e.g., affixed in a room setting such as a gym, fitness studio, or the like). Such arrangements may allow for capturing raw data of one or more individuals at the same time, as well as capturing raw data as the individuals move about the capture volume. Furthermore, affixed image sensors may provide for reduced vibration that could result from hand held implementations. In another implementation, one or more sensors 140 may be mounted on a tripod. In an illustrative example, the tripod may comprise a gimbal assembly and configured to change an orientation of mounted sensors 140 using the gimbal assembly so as to follow an individual as they move about a capture volume.

In another implementation, one or more sensors 140 can be provided affixed an applicable garment, such as a shirt, pants, body suit, or the like. In this example, a person may wear the garment and the sensors can be used to collect raw data from which platform 110 can determine posture and/or movement. The garment may be a connected garment capable of wired or wireless communication to platform 110 via network(s) 120. In an example implementation, the garment comprises a constellation of IMU sensors affixed and/or embedded therein, which can generate a stream of raw data pertaining to orientation and position of each sensor to platform 110 or another user system (e.g., a smart phone, computer, table, or the like) via wired or wireless connection. Further details regarding the sensors affixed to a garment can be found, for example, in U.S. Pat. No. 11,302,214, the disclosure of which is incorporated herein by reference in its entirety.

In another example, a sparse network of sensors affixed to the user and/or to equipment can provide raw data for use by platform 110. In this example, postures and/or movement may be obtained, in part, by solving for movement constraints imposed by the equipment. For example, a fitness bench may comprise one or more pressure sensors that can discern when someone is correctly lying on the bench on their back for a cable machine bench press, which can be used to allow for the positioning of two cables, that the user is pulling on, to be sufficient to determine full body biomechanics of a bench press.

In an example implementation, the platform 110 can maintain a dictionary of known movements in datastore(s) 114. The movement recognition system 115 can compare a detected movement of one or more persons to known movements held in the dictionary, and recognize the movements of the one or more persons by locating the corresponding known movements. For example, known movements can be encoded as a sequence movement that consists of a number of key postures. The number of key postures may be fewer than a total number of postures that make up an entire movement. The sequence movements may be provided in an order according to the known movement. Movement recognition system 115 can detect postures performed by the person and identify whether or not any of the performed postures matches, within a set tolerance, a key posture of the sequence movement. Once a first key posture is located, movement recognition system 115 can check if the person performed a second key posture for the sequence movement, and so on. A full movement can be recognized by movement recognition system 115 based on finding a match for each key posture of the sequence movement from the postures performed by the person. As used herein, “match” refers to finding a detected posture that is close enough (e.g., within acceptable tolerances) to a key posture to consider the detected posture as indicative or otherwise representative of the key posture, such that movement recognition system 115 can consider the detected posture as at least an attempt by the user to perform the key posture.

As an illustrative example, assume a squat movement can be matched using three key postures: a first key posture for full upright position with chest up and shoulders back, a second key posture for bottom or maximum depth of the squat, and a third key posture for full upright position with chest up and shoulders back. Additional intermediate postures may be present between the above listed key postures, but are not considered in this illustrative example. Movement recognition system 115 may compare a posture performed by the person (e.g., based on raw data from sensors 140) to the first key posture. If a performed posture matches the first key posture, movement recognition system 115 may recognize that the person may have started to perform a squat. Then movement recognition system 115 may track postures until it finds a match for the second key posture, and search performed postures to find a match to the second key posture. Once all three key postures are matched, movement recognition system 115 may recognize a squat movement was performed. As an example, postures performed by the human may be required to be performed in the same order as the key postures for a recognition to be successful. That is, once a performed posture is matched, only the posture performed after the matched posture may be considered while searching for a next key posture.

Based on recognizing the match, movement recognition system 115 can take appropriate action. In one example, movement recognition system 115 may repeat the matching process multiple times in a row based on detecting repeated first key postures following a last key posture, which can indicate a user is performing multiple repetitions (e.g., reps) in a row, forming a set. In another example, upon recognizing the movement, movement recognition system 115 may analyze postures performed by the person to determine a performance measure of the movement, for example, by determining a quality and/or correctness of the detected movement relative to the known movement. That is, how close the detected movement matches to the held known movement. In an example implementation, known movements can be encoded with nuance movements that consist of a number of nuance postures for gauging a performance of the movement. Movement recognition system 115 can compare detected postures to nuance postures and measure a deviation or closeness to the nuance posture for detected postures. This deviation or closeness can be converted to a performance measure for gauging the users' correctness and/or quality in performing the movement. A detected movement may be labeled with a determined performance measure and stored in datastore(s) 114 as movement data. In some embodiments, a performance measure may be provided on a movement basis, posture basis, etc.

As alluded to above, platform 110 also comprises a coaching intelligence system 116 configured to mimic real-world in-person instructional approaches by providing digital coaching through an instructional user interface (UI) according to the performance level. In implementations disclosed herein, “user interface” will be used herein to refer to any type of user interfaces, such as but not limited to, graphical user interfaces (GUI), accessible user interfaces, audio user interfaces, voice user interfaces, gesture user interfaces, and any combination thereof. The coaching intelligence system 116 may function to manage the presentation of the content via the UI based on the movement recognized by movement recognition system 115. Content can include audio content, such as explanations and auditory instructions; visual content, such as pictures, videos, text, etc.; tactile content, such as haptic feedback. Content can be presented to the user via a display of or coupled to a user system 130, speakers of or coupled to the user system 130, tactile feedback of or coupled to the user system 130, etc. Content managed by the coaching intelligence system 116 can relate to movements, techniques, exercises, etc. For example, content managed by the coaching intelligence system 116 can be a video showing proper execution of a movement and include motions of an athlete or instructor performing moves during a session. Depending upon implementation-specific or other considerations, the coaching intelligence system 116 can present content to a user after performing an analysis of motions made by the user, which may be overlaid on a presentation of the user's movement. For example, if a user is making motions in executing a specific move and is performing the specific move incorrectly, then the coaching intelligence system 116 can select content to present to the user based on the incorrect posture during all or a portion of the specific move. Further, depending upon implementation-specific or other considerations, the coaching intelligence system 116 can determine, in real-time, content to present to a user as the user changes posture.

For example, coaching intelligence system 116 can function to determine content to present to a user based on the performance measure associated with a detected movement. The coaching intelligence system 116 can obtain the performance measure from the datastore(s) 114 and present content to the user via a UI based on the performance measure. The specific content presented may be selected to improve the performance measure. For example, in the case of a squat, if the performance measure indicates that the user is not going deep enough into the squat (e.g., not down to the maximum depth), then content may be selected to instruct the user to correct the movement. As another example, if the performance measure indicates that the user's knees extend too far over the toes, then content may be selected to instruct the user to correct the movement and pull the user's knees back by moving weight onto the heels.

In presenting content to a user, the coaching intelligence system 116 can present content non-linearly. Content can be presented non-linearly in that different portions of content within a stream of content, e.g. a video, can be displayed to a user out of the order in which the portions of content are in the stream of content. For example, if a user is regressing in executing a move, then platform 110 can determine to present beginner content to the user in executing the move. In another example, if a user is advancing in executing moves, then platform 110 can determine to present advanced content to the user.

In another example, types of content presented to the user may be based on the performance measure. For example, audio content describing a corrective measure may be presented if the performance measure is within a first threshold of the movement stored in the movement datastore. However, if the performance measure is outside of the first threshold, a video content showing the corrective measure may be presented. In another example, a low performance measure on a first subset of reps may result in a first type of content (e.g., audio), while repeated low performance may result in a second type of content (e.g., video).

The coaching intelligence system 116 can function to access an asset map of content that can be presented to a user for a given movement, exercise, etc. For example, each sequence movement held in the sequence movement datastore may be mapped to an asset map for that sequence movement held and, upon matching a detected movement to a given sequence movement, the asset map for that sequence movement can be accessed for presenting content to improve performance of the detected movement. As used herein, an “asset map” refers to a set of content for a given movement mapped to content including annotations on moves, including descriptions and/or thresholds of motions made in executing a move correctly. Annotations of a move can include terms that define a posture of the move, such as angles and orientations of limbs, back, joints, speed, acceleration, torque, momentum, steadiness, stillness, smoothness of motion, etc. in correctly executing the move. For example, annotations of a move can specify that a user should bend their legs by 100 degrees and lower their torso 1 foot in performing, for example, a maximum depth of a squat. In some implementations, sequence movements and/or asset maps for the movements can be generated by detecting motions performed by a reference athlete or instructor. For example, a reference movement can be generated from captured motions of an instructor in performing moves properly, and an asset map for that movement generated from captured motions of an instructor performing incorrect movements. Content of the asset map may also be entered by an instructor commenting on common mistakes. The asset map may serve to map certain content to the incorrect movement and/or mistakes. For example, if a performance level for a given movement indicates that a specific mistake is made by the user (e.g., knees extending too far beyond the toes), the asset map can function to retrieve content specifically targeted to correcting the detected mistake.

The asset map can provide for content based, at least in part, on a library of postures for a sequence movement. The library of postures can be stored in a datastore storing correct posture data including specifications of motions used to execute the posture, which can include a time parameter for moving from a first posture to a second posture. By generating an asset map based at least in part on a library of common moves, the coaching intelligence system 116 can use the asset map to recognize a move from the content, user movement data in response to the content, and/or movement data used to create the content, and subsequently annotate the content to create an entry in the asset map using posture data. In some implementations, posture data can be generated based upon input received from users. For example, an instructor can add moves to a library of moves and/or posture data including specifications of the correct moves through implementation of movement recognition system 115. Correct posture data can also include specifications of motions made during the execution or common errors in performing moves. For example, if a common error made by users is raising their right foot, then common motions data can include that raising a right foot is a common error.

Coaching intelligence system 116 can be configured to determine content to present to a user according to a set training routine or exercise program. A program can include goals of a user in athletic and/or fitness endeavors and may include a set of movements. In an example, the set of movements may be repetitions of the same movement (e.g., a set of reps of a movement), or a number of movements performed in a specific or random order, etc. In managing a program, the coaching intelligence system 116 can communicate content to the user according to the exercise program. For example, based on a performance measure of the user while performing the program, the coaching intelligence system 116 can select content targeted at improving the performance measure of the movement and the content to the user. Communicating in this context may refer to transmitting, either internally within user system 130 and/or via network(s) 120 or any method of providing content held in a datastore to a user for presentation via a user interface. In various embodiments, coaching intelligence system 116 can manage a training program according to movement data received from the movement recognition system 115. For example, the coaching intelligence system 116 can determine that a rower exhibits poor technique (“a poor drive”) that is symptomatic of poor leg strength and core stability based on movement data of the rower, and subsequently provide content recommending leg strength and core exercises that can be added to the exercise program to improve the poor technique. As another example, coaching intelligence system 116 may provide content that comments on or otherwise informs the user that the exhibited technique is below a set standard.

As will be detailed below, model creation system 118 can function to create information and definitions for configuring the movement recognition system 115 and/or coaching intelligence system 116. Model creation system 118 may provide an interface from which a coach or instructor can define aspects that are executed by the movement recognition system 115 and/or coaching intelligence system 116, such as but not limited to, techniques, exercises, nuance movements, as well as asset maps and coaching strategies. Model creation system 118 can be implemented to create any configuration file as needed for defining the various parameters of movement recognition system 115 and/or coaching intelligence system 116 for performing the above-described functionality and processes.

Model creation system 118 can act as a interface for a coach or instructor to generate one or more movements and/or the asset map, which can be stored in the sequence movement datastore (e.g., datastore(s) 114) as sequence movement data. As described above, sequence movements stored in the datastore and/or asset maps for the movements can be generated by detecting motions performed by a reference athlete or instructor. For example, a sequence movement can be generated from captured motions of an instructor performing moves properly through application of movement recognition system 115. Each posture of the sequence movement may be added to the library of postures for the movement. A plurality of the postures may be designated as key postures for use by the movement recognition system 115, as described above. From sequence movement data, model creation system 118 may extract specifications of motions for executing the movement from the postures in the library. For example, model creation system 118 can function to detect relative positions and orientations between body parts and between sequential postures, which can define movements required to transition between postures. A time parameter can be extracted between postures to provide times between each posture, as well as a total movement time parameter.

In some implementations, the asset map for a sequence movement can be generated from captured motions of an instructor performing movements. For example, model creation system 118 can function to provide one or more correct movements for a technique and/or one or more incorrect movements for a technique, for example, by using movement recognition system 115 to recognize the movements performed by the instructor. As an illustrative example, the instructor can perform a correct movement, which can be detected by movement recognition system 115, and model creation system 118 can function to designate the detected movement as a correct movement for the technique. In another example, an instructor may designate the movement as a correct movement. From the correct movement, model creation system 118 can be utilized to designate a sequence movement of the technique, which can be used by movement recognition system 115 as a lowest common denominator of a known technique for recognizing movements performed by another. Similarly, movement recognition system 115 may detect a movement performed by the instructor, which can be designated, in model creation system 118, as a nuance movement containing an error. The instructor (or another user) may supply annotations in the form of content (e.g. audio, video, textual, etc.) that identifies the error and/or explains how to correct the error, which can be associated with the nuance movement. This can be performed a number of times for the same and/or different nuance movements for a given technique, for both positive (e.g. movements that an instructor is looking for in confirming the technique is performed correctly) and negative (e.g., faulty movements) nuance movements. Model creation system 118 can then use the annotations to construct an asset map for a given technique that maps content to nuance movements. During runtime, coaching intelligence system 116 can access the asset map based on movement recognition system 115 recognizing a movement performed by a human that matches a nuance movement and can retrieve the mapped content for provisioning to the user for that nuance movement.

In one example, the model creation system 118 can function to ingest a correct movement and an incorrect movement, as designated by an instructor for example, and detect differences between the correct and incorrect movements for generating a nuance movement. For example, model creation system 118 may detect differences between postures of a correct movement and postures of an incorrect movement, which can be used to construct a nuance movement from those differences.

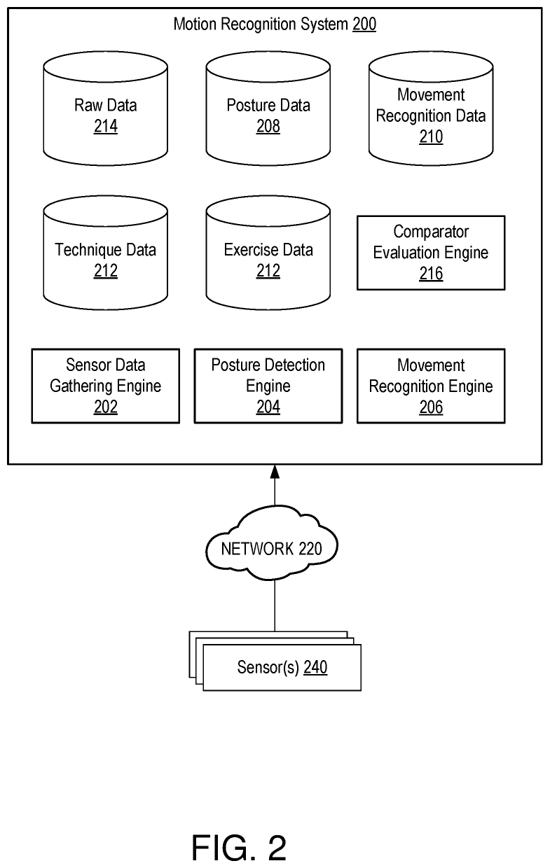

FIG. 2 is a schematic block diagram of an example human movement recognition system 200 according to embodiments of the present disclosure. FIG. 2 depicts human movement recognition system 200 communicably coupled to sensors 240. In one example, human movement recognition system 200 may be coupled to sensors via a network 120 (as shown in FIG. 1), while in another example, human movement recognition system 200 may be executed on a device on which sensors 240 are installed. Human movement recognition system 200 may be an example implementation of movement recognition system 115, described above in connection with FIG. 1. Sensors 240 may be substantially similar to sensors 140 of FIG. 1. Human movement recognition system 200 comprises a sensor data gathering engine 202, a posture detection engine 204, a movement recognition engine 206, and a comparator evaluation engine 216. Human movement recognition system 200 also comprises a posture datastore 208, a movement datastore 210, a technique datastore 212, and an exercise datastore 218.

The sensor data gathering engine 202 can function to gather raw data collected by sensors 240. Sensor data gathering engine 202 may function to obtain raw data directly from sensors 240 and/or from a raw data datastore 214. For example, sensors 240 may collect raw data that can be streamed to raw data datastore 214 as a raw data stream. In various implementations, the sensor data gathering engine 202 can add timestamps to indicate when the raw movement data was gathered or generated. Timestamps can be used to determine lengths of movements (or a collection of movements) and times at which movements or poses were performed or achieved. In various embodiments, the sensor data gathering engine 202 functions to gather raw sensor data for each slice of a time period over which a movement is performed. The sensor data gathering engine 202 can add a timestamp corresponding to each slice of the time period. The raw data may be provided as data from which positional and/or movement information of one or more persons within a capture volume can be derived. In an illustrative example, raw data may comprise sequential image frames, each of which captures an image of a human in a pose for a slice of the time period. Collectively, the image frames provide a video of the human performing a movement. Sensor data gathering engine 202 can add timestamps to each image frame indicating a slice of the time period for which the user performs the pose.

Posture detection engine 204 can function to detect postures of one or more human beings over a period of time using raw sensor data from gathering engine 202. In an illustrative example, posture detection engine 204 is configured to generate an intermediary data structure as movement data, in which movement is encoded as a series of postures over time. The movement data can be stored in movement datastore 210. The posture detection engine 204 provides for translating raw sensor data into the intermediary data structure, which can be used to train movement recognition engine 206 to recognize human movements and obtain performance measures of the movement (e.g., quality and/or correctness). For example, posture detection engine 204 can function to detect movements performed by a human using raw data, which can be compared to sequence movements stored in technique datastore 212. The human movement recognition system 200 can perform comparative analysis of the detected movement against sequence movements to recognize a movement, as well as determine a performance measure of the recognized movement based on the stored sequence movement.

Posture detection engine 204 can function to detect postures of one or more human beings over a period of time from a stream of raw sensor data. The stream of raw data may be referred to as a raw data stream, where each slice in the raw data stream corresponds to a posture performed by a person. Posture detection engine 204 can process the raw data stream to detect a series of postures, where each posture corresponds to a slice of the raw data stream. The series of postures can be stored in posture datastore 208 as posture data. Each detected posture may be labeled with a timestamp according to the timestamp of the raw data used to detect a respective posture. In an illustrative example, posture detection engine 204 can function to process the raw data stream to detect a pose of a human for each slice of the stream and generate a posture in the form of a model representation of the pose for each slice. The series of postures in the form of model representations is referred to herein as a “body object stream” (also referred to herein as “body object data stream”).

In an illustrative implementation, posture detection engine 204 can, for each slice, detect body parts from raw data for that slice and relative positions/orientations of body parts to construct a body object model representation (referred to herein as “body object”, “body object data”, “model representation,” or “body object model representation”). In constructing the model representation, one or more detected body parts may be grouped together as a body element (e.g., chest and abdominals can be grouped as a torso body part), which can comprise a body object segment labeled with a position and/or orientation for the collection of body elements. For example, in the case of a raw data stream provided as a series of image frames (each representing a slice), posture detection engine 204 may execute computer vision algorithms, such as pose and/or object recognition and detection techniques, to detect body parts of a human body from each image frame and store the one or more detected body parts as body elements, where each body element comprises a body object segment and a corresponding position and orientation. Positions and orientations of body object segments can be stored as quaternions. Each quaternion can be provided as a vector defining the position and orientation of the associated body object. Posture detection engine 204 can then use the object segments and associated quaternions to construct a body object model representation of the posture performed by the human.

According to various implementations, posture detection engine 204 can generate a body object model representation as a skeletal model representation. In an illustrative example, the model representation may be provided in 3D space as a 3D skeleton. In other examples, a 2D coordinate space may be used. Posture detection engine 204 can generate a model representation for each slice, each of which defines a posture for the respective slice of a time period. In an illustrative example, each posture can be provided as a body object model representation composed of an arbitrary number of body object segments. Each body object segment may be representative of one or more body parts of a human body and/or one or more bones of the one or more body parts that make up the body object. For example, a body object segment may represent a single bone, such as a humerus in the case of an upper arm body object. In another example, a body object segment may represent a plurality of bones, such as the ulna and radius bones in the case of a forearm body object. However, the ulna and radius bones may be represented by separate segments in some implementations. In another example, a body object segment need not correspond to bones, but may correspond to a body part of the human being, for example, a forearm, upper arm, etc.

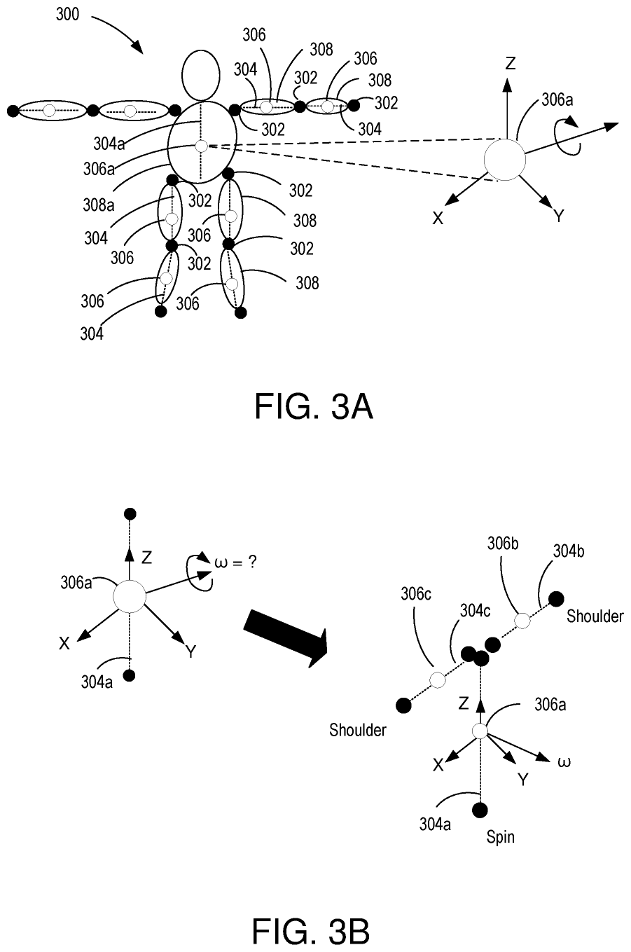

FIG. 3A depicts an example body object model representation 300 provided in 3D space according to an illustrative example. Referring to FIG. 3A, the model representation 300 is constructed from a plurality of body elements 308 (e.g., torso, shoulders, etc.) of a person and joints. Joints can be represented as nodes 302 that are connected by body object segments 304. While FIG. 3A illustrates certain body elements and associated body object segments, it will be appreciated that more or fewer body elements and body object segments may be provided. For example, additional body elements and body object segments representing hands, fingers, feet, toes, etc. may be provided, each of which may consist of nodes and segments. Other examples include, but are not limited to, object segments for a neck, body objects for hips, etc. As another example, each arm or leg may be represented as a single body object segment, instead of two as shown in FIG. 3A. Similarly, while the torso is depicted as a single body object segment, the torso can be divided into multiple body object segments (e.g., chest and abdominals). The number of objects and body object segments may depend on the desired application.

Each body object segment 304 can be associated with a quaternion node 306, which describes a position in space, an orientation about that position in space, and a heading direction in a normalized coordinate frame (e.g., a reference coordinate frame) for a given segment 304. In some implementations, the normalized coordinate frame may be defined by a reference posture (referred to herein as an “identity posture”). In one example, the identity posture may be a posture in which a person is standing upright with arms by their side. In another example, the identity posture may be a first posture (e.g., first slice) of a movement performed by a human. Each quaternion node 306 can be stored in the posture data as a vector associated with a respective object segment 304 and provide position in a normalized coordinate frame (e.g., x, y, and z as shown in FIG. 3A), orientation about an axis of the normalized coordinate frame (e.g., w), and a heading or facing direction (if present) for that respective body object segment 304. In the identity posture, each quaternion node may represent a “identity quaternion” for each body object that the quaternion node is assigned to track.

As an illustrative example, shown in FIGS. 3A and 3B, body object segment 304a, defined between two defined end points, may correspond to a spine or torso represented as body element 308a (FIG. 3A). Posture detection engine 204 may populate a quaternion node 306a for the body object segment 304a, which includes the positional data along the normalized coordinate frame. There may be an infinite number of rotations of the bone about a longitudinal axis between the end points. One such example rotation, which can be determined either directly or indirectly (e.g., discerned or inferred) from the raw data, may be represented as an orientation w included in the quaternion 306a. A number of object segments, each associated with a determined quaternion, may collectively define a complete model representation 300. While each bone segment has an individual position and orientation, the completed skeletal represent can be used to identify a posture of the human from the collective positions and orientations of the bone segments.

In some implementations, for example, in computer vision applications, information defining body object segment orientations and/or heading direction of the user may not be ascertainable directly from the raw data stream. Posture detection engine 204 can function to handle this situation, for example, by using raw data to infer orientations and/or heading directions from body object segments. For example, quaternions for one or more body object segments can be used to discern orientations and/or heading directions for another body object segment. FIG. 3B depicts an illustrative example of inferring orientation for a spine body object segment from information describing shoulder body object segments. In the illustrative example of FIG. 3B, which does not illustrate the body element 308a for clarity of illustration, body object segment 304a represents a segment of the spine having quaternion node 306a. However, the orientation of the body object segment 304a cannot be determined directly from body object segment 304a alone, because it is represented as a single linear segment along a longitudinal axis. Accordingly, posture detection engine 204 can leverage information of body object segments 306b and 306c, each representing a shoulder in this example, to infer an orientation of body object segment 304a. As another example, positions and orientations of fingers may be used to discern an orientation of ulnar or radial bones in an arm body object, because orientation of the figures can be related to an orientation of the arm. Similarly, toes can be used to discern an orientation of a tibia or fibula in a leg body object. In yet another example, hip joints may be used to infer information regarding a longitudinal orientation of a lower spine segment.

Posture detection engine 204 can also function to infer a facing direction for the model representation using positions and orientations of the body object segments. For example, the orientations and positions of body object segments relative to each other may be used to derive a facing direction of the model representation, and, thus, the human being. Referring again to FIG. 3B, a heading direction of the model representation can be inferred using segments 306a and 306b, for example, by recognizing which segment corresponds to a right shoulder and which corresponds to a left shoulder. In an illustrative example, posture detection engine 204 can use positions and orientations of body object segments to identify the human posture relative to the identity posture and a facing direction, such as but not limited to, that the human is lying on the floor facing up (e.g., performing a sit up) or facing the floor (e.g., performing a push up).

Posture detection engine 204 can function to obtain as much information as possible from sensor data gathering engine 202 and create a body object with the available information for populating the posture data. For example, in a case where raw data can be used directly to provide position, orientation, and facing directions, the posture detection engine 204 can use this information to generate the body object model representation. In another example, such as in computer vision techniques relying on processing images, positions of bones may be probabilistic. In this case, posture detection engine 204 may generate a measure of confidence and/or probability in the determined position and orientation of the body object segments. The confidence and/or probability may be provided as a trust score, which can be used for improving subsequent identification and recognition of a posture or movement. For example, posture detection engine 204 may associate each body object with a number of possible positions and/or orientations that are detected from the raw data, each of which can include a measure of confidence in the position and/or orientation. A number of postures can be derived from the various positions and/or orientations in consideration of the measured confidence, such that each identified posture can also be associated with an overall measure of confidence. Measured confidence/probability may be stored as trust scores in metadata associated with body objects and/or postures. In some cases, a weighting can be applied to positions and/or orientations based on the measured confidence, which can inform the determination of a posture from the model representation.

Accordingly, posture detection engine 204 can populate sparse data sets, derived directly from raw sensor data, of position, orientation, and/or heading direction for body objects and body object model representations to generate dense data sets that provide improved accuracy of posture detection. The dense data sets, which can be stored in posture datastore 208, can be used in recognition of movements. Thus, through inference of orientation and/or heading direction by posture detection engine 204, a full data set directly from sensors 240 is not necessary for recognizing human movement.

In some embodiments, posture detection engine 204 may label posture data with information discerned directly or indirectly from sensors 240. This data may include, but is not limited to, speed, velocity, acceleration, force, power, torque, pressure, direction of movement, change in direction of movement, or any other biomechanical data that can be captured by sensors 240 during capture and/or calculated during translation. Biomechanical data may comprise breathing rates, breathing patterns, heart rates, electromyography signals, among others. This information may be stored with posture data in posture datastore 208 and may be used along with the postures over the period of time to recognize the movement, as described below.

A series of body object model representations over time, including at least body object segments and quaternions, generated by posture detection engine 204 may each be considered an intermediary data structure, which collectively provides a body object stream. These intermediary data structures, and resulting body object stream, can provide for plug-and-play usability for detecting movements of one more persons in the systems disclosed herein, as well as in external systems. For example, by translating raw data that captures human poses over time into the intermediary data structures, backwards and forwards compatibility can be provided with a myriad of external systems that can be configured to ingest the data structures and process them as needed to perform other tasks. Accordingly, posture detection engine 204 provides for human movement detection and reconstruction that is compatible with, and untethered from, a specific implementation of motion capture.

Movement recognition engine 206 can function to recognize one or more techniques of a human being from a body object stream. As will be detailed below, a technique may refer to one or more known movements and nuances associated with those movements. As described above, movement can be provided as a number of postures over a period of time that are represented in the body object stream. In the case of human movement recognition system 200, the body object stream can be used by movement recognition engine 206 to recognize a technique from a body object stream, where each slice of the body object stream (e.g., each body object model representation) corresponds to a posture held in posture datastore 208. For example, a performed movement can be recognized using a known starting posture of a technique to a known end posture of a technique, perhaps passing through known intermediate postures therebetween. In this example, each posture of the body object stream, defined by a model representation, contains a number of body object segments and quaternions. In an example implementation, the plurality of known postures (referred to herein as “key postures”) may be grouped together as a sequence movement, and this sequence movement defines a “lowest common denominator” of a technique to be recognized. The “lowest common denominator” as used herein refers to a minimum acceptable standard for which movement recognition engine 206 will acknowledge detected movements as representing performance of an intended technique.

A plurality of sequence movements can be held in a technique dictionary, for example in technique datastore 212, each of which can correspond to a recognizable technique. In an illustrative example, a technique may be a squat, and a sequence movement for the squat may be a set of key postures that define the lowest common denominator of movements that could be characterized as a squat. For example, a first key posture may be provided as a fully upright posture with chest up and shoulders back, a second key posture as a bottom depth of the squat; and a third key posture as a return to the fully upright posture. In various embodiments, movement recognition engine 206 functions to obtain postures for a given body object stream from posture datastore 208 and compare each posture to key postures of a movement sequence obtained from technique datastore 212. If movement recognition engine 206 determines the obtained postures match each key posture in the movement sequence, within acceptable tolerances, then movement recognition engine 206 can recognize the movement and label the body object stream as the technique corresponding to the sequence movement. The labeled body object stream can be stored as movement data in movement datastore 210.

Thus, movement recognition engine 206 can function to generate movement data from a body object stream of intermediary data structures from posture data. In generating movement data, movement recognition engine 206 can use features of body object segments inferred by posture detection engine 204 (e.g., orientation and/or heading direction), which can be used to provide a full characterization of the movement by tracking the features across the window of movement of the body object stream. In some implementations, the intermediary data structures can include measures of confidence based on the posture data, which can correspond to a confidence and/or probability that the recognized technique accurately reflects the movement performed by the human. Similarly, the body object stream can include a measure of confidence derived from an aggregate of the measures of confidence for each posture of the body object stream.

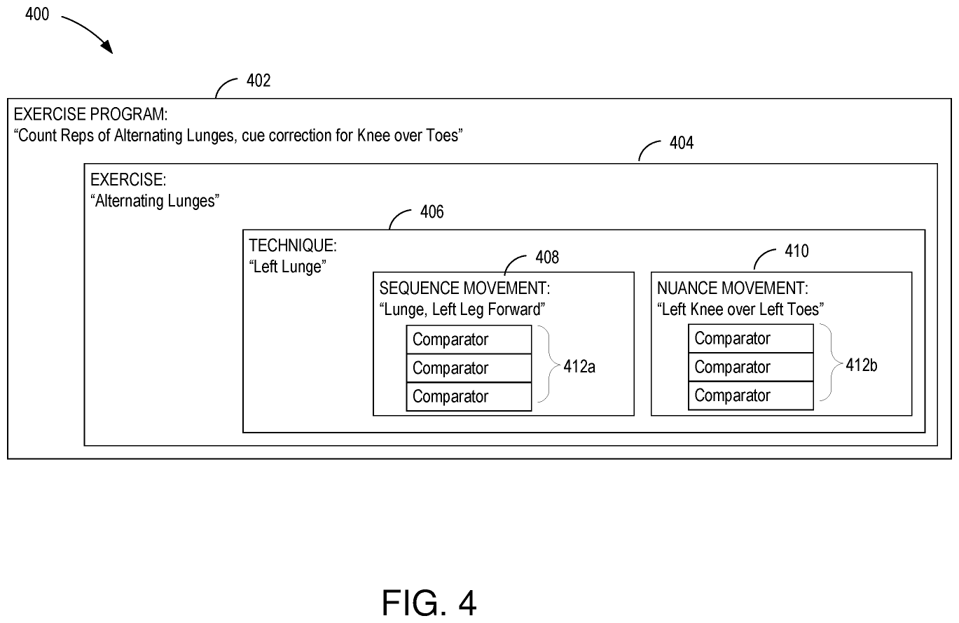

Technique datastore 212 can be configured to store the technique dictionary of techniques and exercises referencing techniques. In an example implementation, technique datastore 212 can store a hierarchal exercise routine data structure as shown in FIG. 4. More particularly, FIG. 4 illustrates an example block diagram of exercise routine data structure 400 in accordance with embodiments disclosed herein. Exercise routine data structure 400 comprises a plurality of hierarchical abstraction layers, each of which encapsulates a lower abstraction layer. In this example, each higher layer may issue calls to data defining features of the lower layer. In exercise routine data structure 400, an exercise routine layer 402 encapsulates an exercise layer 404 that consists of one or more exercises called by exercise routine layer 402. Exercise layer 404 encapsulates a technique layer 406 that consists of one or more techniques called by exercise layer 404. Technique layer 406 encapsulates a sequence movement layer 408 that consists of one or more sequence movements called by technique layer 406 and a nuance movement layer 410 that consists of one or more nuance movements called by technique layer 406.

A “technique” as used herein and throughout the present disclosure refers to one or more sequence movements and a number of nuance movements for the sequence movements. In an example implementation, each technique may comprise of one sequence movement. Defined as such, a technique comprises the lowest common denominator of how a movement should be performed by the sequence movement. A technique also comprises nuance movements that, together with the sequence movement, can describe an ideal execution of the technique. An “exercise”, as used herein and throughout the present disclosure, refers to a collection of one or more techniques, which may be described as being performed in series or in parallel. An “exercise routine” or “exercise program”, as used herein and throughout the present disclosure, refers to a collection of exercises to be performed in a prescribed way, which may be a specific order or random as described in the exercise routine. An exercise routine may also be referred to as an exercise program.

As described above, each sequence movement comprises a number of known (or key) postures that define a minimum acceptable standard for which movement recognition engine 206 can acknowledge the performance of an intended technique. As shown in FIG. 4, a sequence movement comprises a number of comparators 412a that movement recognition engine 206 is looking for in detected postures (e.g., the lowest common denominator of a key posture or sequence movement) to match with a key posture. Additional details on comparators are provided below. A sequence movement and its comparators can allow movement recognition engine 206 to recognize an honest attempt by an individual to perform a technique as it was shown or explained to them. Further, the sequence movement can be leveraged to judge that the movement performed was sufficiently close to the intended technique through its comparators, such that additional instructions can be presented to a user to move the user's performance from “good enough” to “as good as possible.”

Nuance movements also comprise a number of comparators 412b that can define an ideal execution of technique. Nuance movements, like sequence movements, may represent known postures of the technique that can be compared to detected postures. Nuance movements represent ideal postures that can be compared to detected postures to quantify a performance of the movement. The quantitative comparison of comparators to body objects, as described below, can provide a measure of performance that can be translated to a qualitative understanding of the user competence in performing a technique. This understanding can be leveraged to present detailed instructions and observations of the quality and correctness of the movement relative to the ideal performance of the technique. A coaching metaphor for nuance movements may be that a coach could watch an individual as they perform a movement and look for particular nuanced movements in the performance. In one instance, the coach may be looking for something that could occur at any moment in the movement (“such as dropping one's guard during a boxing punch”). In another instance, the coach may only choose to observe a nuance at a particular moment in the movement, such as observing the collapse of the knees, only when the individual has reached the bottom of a lunge.

While FIG. 4 illustrates a specific example of exercise routine data structure 400, other exercise routines, exercise, techniques, etc. can be used to populate an exercise routine data structure for any desired routine. For example, the exercise routine layer 402 may provide a number of exercises to be performed in an ordered set (e.g., a super-set). Exercise layer 404 may consist of each exercise identified in an exercise routine layer 402, and each exercise may consist of techniques for performing the exercise, and so on. The number of exercises comprised in exercise routine layer 402 and/or techniques in exercise layer 404 may be dependent on the exercise routine for which a exercise routine data structure is provided.

Encapsulation of sequence movements and nuance movements within a technique allows for objective measurement of the quality of a performance of a technique. Further, the encapsulation provides for longitudinal observation of the improvement or deterioration in the quality of a performance of a technique over time. For example, returning to FIG. 2, movement recognition engine 206 can function to measure the performance of a technique through evaluation of nuance movements, which can be tracked over time and used to inform a number of user experiences. Movement recognition engine 206 can track performance of techniques over time to determine if performance has improved or deteriorated. The performance can be further related to other conditions, such as fatigue, intensity, or in relation to other metrics such as heart rate variability or mobility assessment scores, which can further inform user experiences.

Referring to FIG. 2, in recognizing movement, movement recognition engine 206 can function to compare postures of a body object stream to key postures for recognizing a movement from an body object stream. As an illustrative example, movement recognition engine 206 can recognize postures using a system of comparators that define the key postures a coach or instructor could recognize (e.g., comparators 412a of FIG. 4). For example, a comparator may be associated with a body object segment in a key posture and can define a position and orientation of the body object segment in the key posture relative to a reference object in the sequence movement. In an example, the reference object may be a vector in a reference coordinate frame, such as an identity quaternion corresponding to a body object segment being tracked. In another example, the reference object may be a unit vector in the reference frame. A collection of comparators can thus describe a key posture. Comparators may be stored in technique datastore 212 associated with respective key postures, for example, by labeling body object segments of key postures with corresponding comparators.

Movement recognition engine 206 can execute a comparison of comparators for a key posture to body object segments of body object representatives of a detected posture for matching a detected posture to the nuance posture, thereby recognizing a technique. For example, movement recognition engine 206 can compare a quaternion of a body object segment for a detected posture to a quaternion in the key posture defined by the comparator and determine how closely the quaternion of detected posture matches the quaternion of the key posture. In an illustrative example, movement recognition engine 206 calculates a dot product between the quaternion, where a result of zero indicates an exact match. While examples described herein provide for using a dot product, other methods may be equally applicable, for example but not limited to, a Euclidean distance where a shorter distance is indicative of a closer match, a cosine similarity, and Pearson correlation coefficient, among others. From the results, a degree of matching (e.g., degree of similarity or closeness) between the quaternions can be determined.

As an illustrative example, a comparator may be “left shin being vertical.” In this example, to recognize that an body object segment for a left shin body object segment is vertical (e.g., matches the comparator), movement recognition engine 206 can compare a quaternion of the shin body object segment, for example a y-axis or longitudinal axis value of the body object segment, to a y-axis in the reference coordinate frame using a dot product. A dot product of zero may indicate that the left shin is perfectly vertical. In another example, movement recognition engine 206 can compare the quaternion of the shin body object segment for a current posture to the identity quaternion for the shin object using a dot product.

In another example, a comparator may be “the arm is bent at 90 degrees” irrespective of rotation of the arm around the shoulder. In this instance, rather than the quaternion for the body object segment being compared to the y-axis of the reference coordinate system, the quaternions compared can comprise a longitudinal axis of an upper arm body object segment and a longitudinal axis of a lower arm bone body object segment.

In another implementation, an arbitrary vector may be used other than a longitude axis. For example, in recognizing good arm position in a TRX Y-Fly movement, an arbitrary vector may be a unit vector of (1,1,1) indicating a perfect line along which the arm would align at the start position of a Y-Fly.

In recognizing that an body object segment matches a comparator, movement recognition engine 206 can be set with an acceptable tolerance for each comparator from which the body object segment in a current posture may deviate from a respective comparator. In an example implementation, each comparator may comprise the acceptable tolerance. The tolerance may be defined as a range of angles within which the comparator can be considered close enough to be matched. The range of angles may depend on specific implementations and which comparator is considered. For example, in performing a maximum depth of a squat, a comparator for the left quad is horizontal may permit a tolerance of 5 degrees above or below, while a comparator for the chest being upright may be 5 degrees forward but only 2 degrees backward. According to various implementations, movement recognition engine 206 can function to dynamically adjust the acceptable tolerance in real-time during run-time. Thus, for example, if someone is performing an exercise well within a first tolerance, movement recognition engine 206 can dynamically adjust the acceptable tolerance to a second, narrower acceptable tolerance selected to hold the person to a higher standard of executing the technique.

In some implementations, a child comparator may be created from nesting other existing comparators (referred to as parent comparators). For example, a parent comparator “Both Shins Vertical” may be created as a composite from existing comparators “Left Shin Vertical” and “Right Shin Vertical”. In this case, posture detection engine 204 can recognize a match for “Both Shins Vertical” parent comparator through a logical AND of the nested parent comparators. Nesting of comparators can allow for higher levels of abstraction of human movement to recognize a unique position with a single comparator, in the language of the modality or movement being described. As another example, a parent comparator may be named “Bottom of a Squat” which can nest child comparators describing the shins, thighs, and perhaps torso position. Additionally, nesting and reusing comparators can also offer computation performance and resource scale benefits in runtime responsible for recognition of comparators.

Movement recognition engine 206 can comprise or be coupled to a comparator evaluation engine 216 configured to perform evaluations of comparators, for example, by comparing body object segments (e.g., segments and/or quaternions) to the features defined by the comparators. For each comparator of a key posture, the movement recognition engine 206 can designate one of three states: matched, not matched, or vetoed. Matched may refer to a case where the dot product of the comparison fall within the acceptable tolerance range, while not matched refers to a case where the dot product falls outside of the tolerance range. Vetoed refers to a case where movement recognition engine 206 the comparator is invalid or not considered for a given detected movement. States may be stored in movement datastore 210, associated with a slice of the body object stream for which the comparator was designated. In the case of nested comparators, comparator evaluation engine 216 can evaluate a comparator tree (e.g., parent comparator connected to nested child comparators, which may each in turn be a parent comparator for another set of nested child comparators). In this case, a state assigned to a nested comparator can be promulgated through connected child comparators where appropriate, for example, a not-matched state for a nested comparator can be carried through child comparators without further evaluation. In an example implementation, the comparator tree can be flattened and duplicates removed to optimize the speed and performance of the calculations. For example, different parent comparators may be connected to one or more duplicate child comparators that need not be evaluated multiple times, and the states of a nested comparator for one parent comparator may be shared with another parent comparator.

For each slice of a body objects stream, the comparator evaluation engine 216 can function to generate comparator results, which can be stored in movement datastore 210. In an illustrative example, the comparator results can comprise a look up table for each slice of the body object stream that can be queried to retrieve the results for any of the comparators. For a no-match state, the comparator results can provide a reason and cause for the comparators not matching. In the example of recognizing the bottom of the squat, a comparator result may not pass, and the reason may be provided as “the torso is leaning too far forward.” The cause may be a triggered by calculating the deviation of the body object segment of the current slice from the comparator and generating a human readable cause from the calculation. The cause calculation can also allow communication at the highest level in the comparator tree as to why the position is not being recognized. The comparator evaluation engine 216 can continue to walk through comparators of the tree to an arbitrary depth, offering a way to move someone from a wrong position to a correct position, body part by body part.

In human movements, there may be body positions that can be ambiguous, which can be described using the veto state. In one example of trying to discern a push up from a sit up, observing only the y-axis of the body moving may be sufficient to recognize that either a push up or a sit up is being performed, but not discern which of the two is being performed. A veto state on the z-axis of the chest can be used to discern which way the person is facing, thereby allowing the comparator evaluation engine 216 to veto that “a push up cannot be performed facing the ceiling”. Vetoes offer a method of separating movements that might otherwise be difficult to distinguish.

In accordance with embodiments disclosed herein, each sequence movement can be defined as an ordered list of comparators, stored in technique datastore 212, that define key postures for that sequence movement. These key postures and corresponding comparators can provide for the lowest common denominator of the sequence movement. The movement recognition engine 206 can function to utilize comparator evaluation engine 216 to match comparators in the list with body object segments of a given slice of the body object stream. If a comparator of the list for a key posture is matched by the comparator evaluation engine 216, movement recognition engine 206 can move down the list to the next comparator and execute the comparator evaluation engine 216 to perform matching with the next comparator. Movement recognition engine 206 continues in sequence until a not-matched state is detected for a comparator or the entire list of comparators for the key posture is matched. Movement recognition engine 206 can function to repeat the process for the next key posture in its list of comparators. For a repetitious exercise sequence (e.g., “do 10 squats”), posture detection engine 204 can loop back to the first key posture and check for a match with the first comparator in the sequence again, in a continual loop.

In some implementations, movement recognition engine 206 can function to report sequence movement events to the movement datastore 210, which can be associated with a detected movement or slice of body object stream. For example, movement recognition engine 206 may timeout when a process (e.g., posture detection, comparator comparison, etc.) gets stuck, in which case movement recognition engine 206 may report stuck events. Stuck events can be configurable from one movement in a sequence to the next. Stuck events may trigger content presented on a user system including, but not limited to, “How long it has been waiting”; reports the comparator that movement recognition engine 206 is looking for, and not yet matching; and reports a “cause array” which allows the movement recognition engine 206 to indicate why the comparator isn't matching. In an example implementation, the cause array can be the ordered list of comparators that are failing, starting from the comparator closest to the root node in the comparator tree (e.g., “the grossest error described at the highest level of abstraction, such as stand upright”) all the way down to the lowest level reason (e.g., “you are not considered standing up straight because your legs are too far apart”). Another example sequence movement event may include a matched comparator event in which a match was detected. In this case, posture detection engine 204 may report a partial event detected, along with a duration from the last partial event to the current partial event, which comparator is currently matched; which comparator is next; and optionally convenience data, such as current index in sequence and sequence length. Another example sequence movement event may include a matched final comparator of sequence. In this case, posture detection engine 204 may report a full event, along with optionally sending a total rep count so far and send the duration of the full rep. These sequence movement events can be stored in movement datastore 210 throughout the sequence movement, which allows a coaching system to perform stuck reporting, guided learning, and body-part-by-body-part correction for a proper pose.

Movement recognition engine 206 can function to recognize a movement performed by a human. In an illustrative example, movement recognition engine 206 can receive a movement detected by posture detection engine 204 and compare the detected movement to sequence movements from the technique dictionary held in the technique datastore 212. Movement recognition engine 206 can function to recognize a movement by locating a corresponding sequence movement from the dictionary. For example, as described above, each sequence movement can be encoded as a number of key postures and a detected posture can be used to search first key postures of sequence movements to locate a match, within acceptable tolerances. Movement recognition engine 206 selects a sequence movement when a detected posture matches a first key posture of a sequence movement. Once a sequence movement is located, movement recognition engine 206 can proceed to match subsequent key postures of the sequence movement. When all key postures are matched, movement recognition engine 206 may tag the body object stream as recognized as the technique corresponding to the sequence movement.

Through the use of comparators and defined acceptable tolerance for sequence movements, movement recognition engine 206 can be provided the lowest common denominator of a movement which can be used to recognize that even an imperfect technique performed by a human can be recognized as a specific technique from a dictionary of techniques. Accordingly, movement recognition engine 206 can provide for an ability to recognize movements, not just by an “exact match” of a performance or by simple “classification” of the exercise as looking sufficiently alike a machine learning classifier trained on multiple videos of the exercise, but instead through a qualitative understanding of the minimum acceptable performance of a technique.

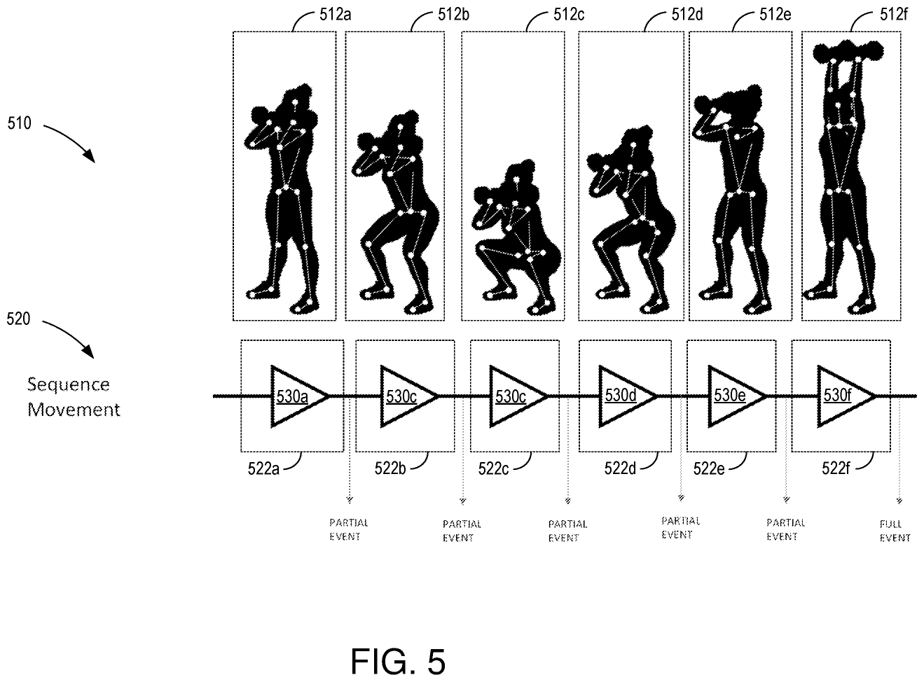

FIG. 5 is a schematic representation of a process for recognizing a technique from an example body object stream 510 in accordance an embodiment. As described above, the technique can be recognized from the body object stream 510 using sequence movements 520 and comparators 530a-530b. FIG. 5 illustrates an example body object stream 510 as a plurality of body object model representations 512a-512f of a human performing a technique (e.g., a dumbbell thruster in this example). Each body object 512 (e.g., shown as a slice or image frame) comprises a collection of body object segments of the human in a posture derived from raw data.

As described above, posture detection engine 204 can translate raw data collected from human movements into body object model representations of segments, and quaternions that define a posture for each pose. Movement recognition engine 206 can obtain the representations 512a-f for each slice, and compare the representation to one or more comparators 530a-f for each key posture 522a-f of the sequence movement 520. In this example, each key frame may be provided as an image frame or key frame. If a match is found, within acceptable tolerances, between a model representation 512 and a key posture 522, then an event flag is reported by movement recognition engine 206 and the body object (or specific image frame) can be tagged accordingly. For example, movement recognition engine 206 searches for a representation that matches first key posture 522a. Responsive to finding a match, movement recognition engine 206 recognizes that the sequence movement is being performed and reports a partial event flag that indicates the technique is partially executed. Movement recognition engine 206 then tracks subsequent representations for a posture that matches the sequentially next key posture 522 (e.g., key posture 522b in this example) for a match. The process continues until a match for the final key posture 522f is found, and movement recognition engine 206 issues a full event flag that indicates the technique has been fully completed. If movement recognition engine 206 is unable to locate a match for a sequentially next key posture 522, then a “not matched” flag is issued and the process for this particular technique is terminated.

In the example shown in FIG. 5, the number of key postures (each provided as an image frame or key frame in this example) is provided as equal to the number of body objects shown (e.g. image frames of the raw data). However, such configurations are not required. For example, one or more intermediate postures or slices may exist between each body object 512. Furthermore, fewer sequence movements may be needed. For example, sequence movement 520 may comprise sequence movement 522a, 522c, and 522f in an illustrative implementation.

Returning to FIG. 2, as alluded to above, technique datastore 212 stores the technique dictionary, which can also comprise nuance movements associated with each technique. The nuance movements can be used by movement recognition engine 206 to gauge performance of a technique relative to an ideal execution. The nuance movements, together with movement recognition through application of a corresponding sequence movement, can describe an ideal execution of the technique. Movement recognition engine 206 can function to recognize nuance movements through comparison of comparators associated with each nuance movement for a specific technique to measure performance of the technique. For example, nuance movements may be provided as one or more nuance postures, which can be known postures of a technique that represent ideal performance of the specific posture of the technique. Each nuance movement (or nuance posture) can comprise one or more comparators that define an ideal standard of performance of the nuance movement (or nuance posture). Nuance movements can be defined as an ordered list of comparators, similar to sequence movements, except that comparators and tolerances may be tuned to provide more stringent criteria for matching a nuance comparator.

Movement recognition engine 206 can function to utilize comparator evaluation engine 216 to match comparators for nuance movements with body object segments of a given slice of the body object stream, similar to the use of comparators in sequence movement recognition described above, to search for nuance movements. For example, movement recognition engine 206 may search for body object segments that match comparators of nuance movements. The presence or absence of nuance movements can be used to measure the performance of the technique. In some examples, the measure may be based on a degree of closeness (or similarity) to perfectly matching (e.g., dot product of 0) the comparator. That is, for example, the closer the dot product is to 0, the higher the measure of performance (e.g., better performance and closer to ideal). In some implementations, movement recognition engine 206 may search for exact matches.

Nuance movements, in some implementations, may include undesirable nuance movements and/or desirable nuance movements. A undesirable nuance movement may represent an error in the performance, deviation from ideal, or improper timing of movements, which can be used by movement recognition engine 206 to characterize errors in a performed posture and/or movement. Such nuance movements may be referred to as negative nuance movements. Desirable nuance movements, which can indicate a greater level of knowledge, performance, and finesse in the technique, can be used to indicate improved or high performance. Such nuance movements may be referred to as positive nuance movements. Movement recognition engine 206 can utilize positive and/or negative nuance movements to provide a measure of performance (e.g., quality and/or correctness) of the technique. For example, movement recognition engine 206 can monitor postures over time to detect nuance movements within a posture. In the case of a desirable nuance, the performance measure can be incremented indicating greater performance. In the case of a undesirable nuance, the performance measure can be decremented indicating lower performance.

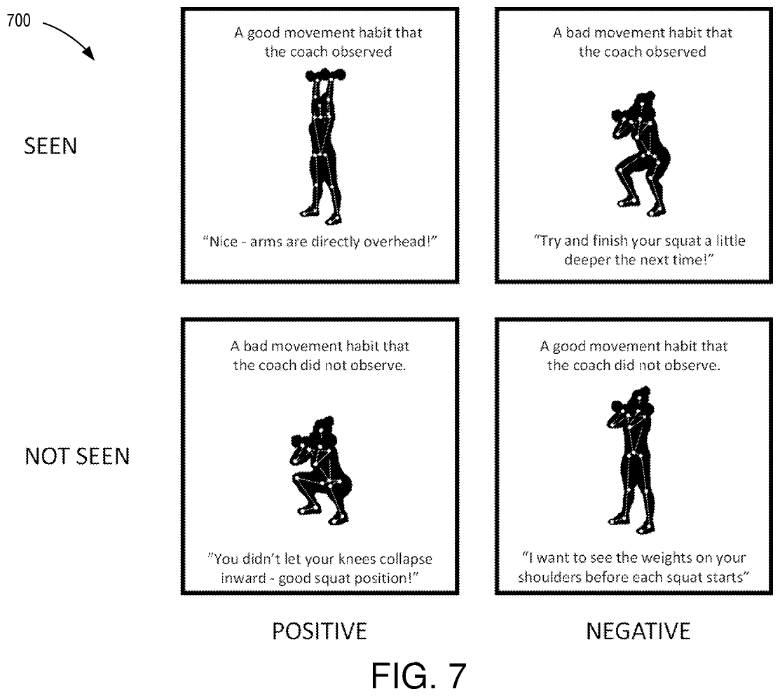

In some implementations, movement data may be tagged according to a nuance trait matrix based on whether or not a nuance movement is detected. For example, movement recognition engine 206 can report a “positive onSeen” flag that can be used to tag a body object stream responsive to recognizing a positive nuance movement in a slice of the body object stream. As another example, movement recognition engine 206 can report a “negative onSeen” flag that can be used to tag a body object stream responsive to recognizing a negative nuance movement in a slice of the body object stream. An example negative nuance movement in a basketball context may be recognizing by movement recognition engine 206 that an elbow of a shooting arm is in a “chicken wing” position (e.g., extending away from the body) during a basketball shot, based on detecting that the shooting arm is not vertical in the y-axis of the reference coordinate frame. Movement recognition engine 206 can report a “positive onNotSeen” flag that can be used to tag a body object stream responsive to an absence of a negative nuance movement in a slice of the body object stream. This scenario can indicate that an individual may have corrected a previously detected negative nuance movement. Referring back to the basketball example, not seeing the elbow “chicken wing” during a shot can be a “Positive onNotSeen”, which is an example of a bad habit that has been corrected. Movement recognition engine 206 can also report a “negative onNotSeen” flag that can be used to tag a body object stream responsive to an absence of a positive nuance movement in a slice of the body object stream. As an example, in a reverse punch in Karate, where a positive nuance movement may be that a non-punching hand retracts to the hip at the same time and speed that the punching hand is extended, the absence of this retraction can be flagged as a “negative onNotSeen.” FIG. 7, described below, provides an example nuance trait matrix.

Movement recognition engine 206 can use trigger events to initiate and/or stop searching an object data stream for one or more nuance movements. For example, when searching for a maximum depth of a squat as a nuance movement, movement recognition engine 206 can be controlled to initiate a search for this nuance movement as the individual has descended into the squat, after recognizing an upright posture (e.g., either as a nuance movement and/or sequence movement). Movement recognition engine 206 can then terminate the search as the individual rises out of the squat and/or after recognizing the maximum depth. Trigger events can be provided as comparator trigger events configured to trigger observations for a nuance movement responsive to recognizing a particular posture as identified by movement recognition engine 206 via a comparator or tree of comparators. Another example trigger event may be an immediate trigger event configured to trigger observation for a nuance movement immediately during an exercise, such as looking for a guard dropping at any point in a boxing drill. In this case, upon recognizing the exercise, movement recognition engine 206 can be triggered to search for this nuance movement. Another example trigger event may be a timed trigger configured to trigger after a set time, which permits movement recognition engine 206 to avoid unnecessary processing during an initial portion of a technique. Yet another example trigger event can be a sequence movement trigger configured to trigger searching for a nuance movement using events fired by recognizing a sequence movement for a technique. For example, movement recognition engine 206 may wait until a particular set of movements has been recognized by movement recognition engine 206 before searching for a specific nuance movement, or waiting until a particular number of reps have been performed, or other variations of the events from a sequence movement. A group trigger event is another example trigger event that is configured to group the above described triggers, for example, by performing logical operations between comparator triggers, immediate triggers, timed triggers, and sequence movement triggers.

Trigger events may be stored in technique datastore 212 associated with nuance movements that are to be searched for responses to the trigger event. When movement recognition engine 206 detects conditions of a respective trigger, movement recognition engine 206 can execute comparator evaluation engine 216 for the comparators of the triggered nuance movement. Nuance movements can be searched for by movement recognition engine 206 according to rules of a state machine comprised in movement recognition engine 206, which can be in one of four states according to an illustrative example. Trigger events are used to move the state machine from one state to another. In an example implementation, four states can be provided as follows: a starting state, recognizing state, waiting state, and terminated state. In the starting state, the state machine of movement recognition engine 206 can function to wait for an appropriate trigger to move into the recognition state and initialize searching for the nuance movement. In the recognition state, the movement recognition engine 206 can function to report on whether or not the nuance movement is observed or not, according to the traits through the comparators. Movement recognition engine 206 can exit recognition when the nuance movement is observed, or movement recognition engine 206 has got to the point where it will not occur. As an example, in an overhead squat a positive nuance movement may be that the arms are sufficiently overhead during the bottom of the squat. Movement recognition engine 206 will either observe this nuance movement or, by the time the individual rises out of the squat, not. In either case movement recognition engine 206 moves onto the waiting state. In the waiting state, the movement recognition engine 206 is waiting to move back into the starting state and start looking again, using an appropriate trigger event. In the terminated state movement recognition engine 206 may no longer be interested in looking for the nuance movement.

In an illustrative example, movement recognition engine 206 can function to collect a configurable set of “metrics” while in each of the above described states, except for terminated state. For example, metrics can comprise “Metric Angles”, which are angles between any 2 arbitrary quaternions, or angles between an arbitrary quaternion and an angle in the reference coordinate frame. Using metric angles, the movement recognition engine 206 can look for maximum angles, minimum angles, mean angles, or median angles and report these angles in real-time. These angles can be used to perform dynamic movement assessments, where specific joint angles of interest can be collected at the appropriate moment in a sequence movement. In another example, metrics may include derived metrics which include, but are not limited to, velocities (linear and angular), acceleration, power, force, joint loads, and other relevant biomechanics. Configurability of the metrics may refer to a functionality whereby a coach or instructor may configure the set of metrics to be collected based on a described exercise routine or program so that movement recognition engine 206 can track and report desired metrics.

The traits and the associated trigger events for nuance movements, human movement recognition system 200 can enable execution of different coaching strategies over and above simple pass/fail or rep counting, for example, as described below in greater detail. Coaching strategies can include, but are not limited to, picking the next most important thing to teach users as they show improvement, congratulating users when they show that they have fixed a bad habit or movement fault, and providing positive coaching by describing or suggesting corrective movements that avoid the fault, rather than describing or notifying of faults all the time. Human movement recognition system 200 can be utilized to recognize movements that can then be presented to the user as acknowledgement of good elements of their practice for motivational purposes.

As described above, movement recognition engine 206 can function to measure the performance of a technique using nuance movements. This measure can be used to inform a number of user experiences. In an example implementation, movement recognition engine 206 can generate a performance score for an individual technique or a set of techniques (e.g., an exercise). The score can be derived from a weighted sum of the presence or absence of nuance movements in performed moves for the technique. In an illustrative example, in performing the left lunge technique of FIG. 4, a certain number of points might be assigned to a score for achieving a specific range of motion of the left knee over the left toes, while the score might be reduced by a certain number of points if other nuance movements, such as allowing the legs to collapse inwards or the chest to fall forwards during the lunge, are detected. In a specific example, a left lunge may be scored numerically, or assigned a grade such as red, yellow, or green depending on thresholds for the score (e.g., numerical point ranges). Scores may be used to gamify a technique (or exercise) by assigning goals and targets based on previous scores (or scores by other users) or to allow competition against other users based on stored scores or in real-time comparison of scores. In some embodiments, scores may be displayed not only in a user system (e.g., user system 130), but on shared user experiences such as dashboards or displays.

In some implementations, movement recognition engine 206 can function to determine that a detected movement qualifies as a rep of a technique based on detecting sequence movements and nuance movements. For example, a sequence movement may indicate that a movement corresponds to a technique and nuance movements may be used to evaluate whether a performed movement can be considered a completed technique (e.g., a repetition or rep). For example, movement recognition engine 206 can function to match key postures of a sequence movement with a technique thereby detecting an attempt to perform the technique, while searching for an occurrence of a specific nuance movement required for the movement to be considered good enough to qualify as a technique. For example, a push up requires that the body dips all the way to the floor to count, or that the arms push up all the way to straight. Movement recognition engine 206 may match key postures such as extension of the arms in order to recognize an attempt at a push up, and if movement recognition engine 206 detects the specific nuance movement (e.g., the body dipped all the way to the floor and/or that the arms pushed up all the way to straight), then movement recognition engine 206 qualifies the movement as a rep of the technique. If, however, movement recognition engine 206 does not detect the specific nuance movement, then the detected movement may not be counted. In another example, movement recognition engine 206 may assign a minimum score attributable to a detected movement to consider the movement a completed technique. In any case, movement recognition engine 206 can function to quantify the performance detected movement. In the case where the movement does not qualify as a technique rep, movement recognition engine 206 can tag the movement in movement datastore 210 as a “no rep” in coaching terms (e.g., flagged as a failed rep) and label the movement with performance measures. A user system (e.g., UI on the user system) can be used to inform the user that the rep does not count, while also providing performance measures. In an example implementation, the occurrence of a no rep (or failure to qualify as a rep) may be visually, audibly, and/or tactilely indicated to the user via content presented by a coaching system (e.g., coaching intelligence system 116 of FIG. 1). Accordingly, movement recognition engine 206 may function as a rep qualifier or rep counter, for example, where value is incremented based on counting completed reps.

Movement recognition engine 206 may be configured to perform exercise recognition, along with movement recognition as described above. As noted above, an exercise can be defined as a collection of one or more techniques, which may be described as being performed in series or in parallel. An exercise can be stored as exercise data in exercise datastore 218. An example of a series exercise is a burpee, which can be described as a sequence of a squat followed by a push up and a jump. An example parallel exercise is free sparring, where users can throw one of several different boxing punches in an order of their choosing. Movement recognition engine 206 can be executed as an exercise recognition engine that can function to obtain an exercise from exercise datastore 218 and locate techniques defined in the technique dictionary in technique datastore 212. Movement recognition engine 206 can then function to track the performance of the multiple techniques contained within an exercise, recognize techniques performed, and report in real-time on the observations. The reporting can include data from the encapsulated techniques, which include reporting on sequence movements and nuance movements, as described above, for each technique. Together, this data can be collected at each slice of the body object stream and reported as an “Exercise Result” for a given exercise, which can be made available to the coaching system (e.g., coaching intelligence system 116) and/or an external system (such as an application developer).

Similarly, movement recognition engine 206 can function to provide exercise results for an exercise routine (e.g., a collection of exercises in parallel and/or in series). An exercise routine or program can be stored as a collection of exercises in exercise datastore 218. Movement recognition engine 206 can be executed as an exercise recognition engine to obtain an exercise program that includes exercises from exercise datastore 218, which can be used to locate techniques defined in the exercises from the technique dictionary in technique datastore 212. Movement recognition engine 206 can then function to track performance of the multiple techniques contained within the exercise routine, recognize techniques performed, and report in real-time on the observations as exercise data.

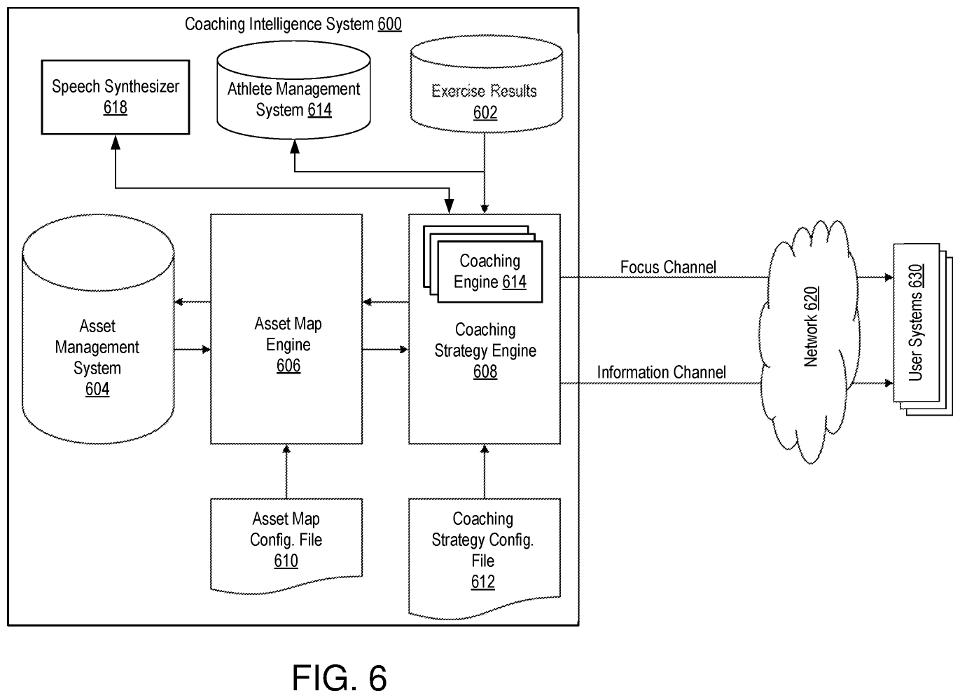

FIG. 6 is a schematic block diagram of an example coaching intelligence system 600 in accordance with embodiments of the present disclosure. FIG. 6 depicts coaching intelligence system 600 communicably coupled to user system(s) 630. In one example, coaching intelligence system 600 may be coupled to sensors via a network 120 (as shown in FIG. 1), while in another example, coaching intelligence system 600 may be executed on a device on which sensors 640 are installed. Coaching intelligence system 600 may be an example implementation of coaching intelligence system 116, described above in connection with FIG. 1. User system(s) 630 may be substantially similar to user system(s) 130. Coaching intelligence system 600 comprises asset map engine 606 that can receive an asset map configuration file 610, and coaching strategy engine 608 that can receive coaching strategy configuration file 612. Coaching intelligence system 600 also comprises an exercise results datastore 602 communicatively coupled to coaching strategy engine 608.

An asset management system 604 may be provided that hosts multimedia content, which can be communicatively coupled to user system 630. Asset management system 604 may be a static content management system, such as one or more databases or datastores, holding multimedia content made available to coaching intelligence system 600. The multimedia content may include audio, video, image, textual, tactile, or any multimedia for presenting instructional information to a user. In one example, user system 630 may be connected to asset management system 604 via network 120. In this example, asset management system 604 may be hosted, for example, on an edge and/or cloud server and comprising a database that stores the multimedia content. In this case, user system 630 may request content based on information received from coaching intelligence system 600, and receive content responsive to the request. In another example, asset management system 604 may be hosted on the user system 630, for example, in a datastore configured to store the multimedia content.

As described above, exercise results contain data for each technique, including sequence movements and nuance movement recognition data sufficient to be analyzed by coaching intelligence system 600 for providing feedback to users to correct or improve their performance. In an example implementation, exercise results collected by movement recognition engine 206 can be held in exercise results datastore 602 for a technique and/or exercise. Coaching intelligence system 600 can function to process the exercise results and provide targeted feedback that is to improve the performance of that technique and/or exercise.

An aspect of a coaching strategy is that good coaching can be achieved by bringing one thing at a time to users' attention so that they are neither frustrated nor overwhelmed, and so that they are given the most useful coaching instruction at any one moment in time. The role of a coach in a real-world coaching environment is to make decisions about where the individual should focus. Further, in real-world situations different coaches will have different points of view on the right strategy for coaching. Thus, coaching intelligence system 600 is an adaptable system that can be modified to reflect different coaching strategies of different coaches through coaching strategy configuration file 612. For example, coaching strategy engine 608 comprises a number of coaching engines, as described above, that can be configured according to coaching strategy configuration file 612. Coaching strategy configuration file 612 may be set, for example, by a coach or instructor defining a particular coaching strategy to be utilized.

Coaching strategy engine 608 is a modular system, which allows execution of a configurable number of specialized movement coach engines 614. Each coach engine 614 can be responsible for observing a specific aspect about the performance of the recognized technique. Examples of coach engines 614 include, but are not limited to, a counter engine, guided practice engine, movement assessment engine, stuck engine, trait spotting engine, and cadence engine, to name a few.

A counter engine can function to count movements that are recognized. For example a counter engine can be utilized for counting completed reps of a technique and/or exercise. As another example, counter engine may count a frequency of nuance movements, such as how often an individual gets stuck performing a technique, or an egregious movement.

A guided practice engine can function to execute a guided exercise or technique. A guided practice (also referred to as a “follow the leader”) is conventionally, where an in-person personal trainer can be used to control intensity of effort by having the coach perform exercises while the athlete watches, and then giving the athlete a turn to perform the exercises while the coach watches. These types of routines can be a way to learn an exercise or technique, by breaking an exercise into parts before slowly putting the parts together into the full sequence as a way to learn complex exercise. The guided practice engine can function to present instructional content (e.g., audio or video) of an exercise, or parts of an exercise, that a user can follow. The guided practice engine functions to recognize the performed techniques while the user is following along.

A movement assessment engine can function to track athletes as they perform an exercise or exercises. For example, a movement assessment engine can be used for a warmup, or perhaps presented as a clinical movement assessment such as a functional movement screen. At key moments in exercises, a movement assessment engine may be configured to measure functional aspects, such as joint angles and ranges of motion for the purpose of movement assessments and movement screens.

A stuck engine can function to monitor athletes for instance where they are stuck in the recall of a sequence of movements, or missing some key aspect of the performance of a movement. For example, in a yoga flow, a stuck engine can be configured to identify when someone cannot remember what pose comes next in a sequence of poses. In a more granular movement, like a rowing stroke, a stuck engine can be configured to highlight that the athlete forgot to push their legs until they were fully flat, before pulling their arms towards their chest.

A trait spotting engine can function to detect a presence or absence of nuance movements for tracking of a good performance, or bad habits that should be coached out. The trait spotting engine can be configured to look for the absence or existence of both good and bad nuance movements.

A cadence engine can function to provide information about the tempo and timing of an exercise, or the movements comprising an exercise. This can include, for example, how long it took to perform an exercise. As another example, in an exercise like a squat the relative time of the descent into the squat versus the rise out of the squat (“3 seconds down, 1 second up”). In another example, a cadence engine may measure the time between reps to gauge the onset of fatigue, or to time the speed of an exercise, such as a punch, as a way discerning other metrics, such as power and/or force.

According to various embodiments, when any coaching engine 614 observes the features for which they are initialized to monitor movements, the coach engine 614 can function to emit a coaching result that tags the movement with the observer feature. As an illustrative example, a stuck engine can observe that the individual is stuck in the middle of executing a sequence of movements and needs to be reminded of the next movement. Stuck engine in this case can issue a flag that triggers content to remind the user of the next movement.

Each coach engine 614 can function to maintain a context while executing a particular coaching strategy. For example, coach engines 614 can maintain a history of interventions (e.g., presentation of content to correct performance) that have been made. This context can include data such as the number of times a coach engine has observed what it is looking for, the number of times it has intervened, the number of times the individual has responded to the content triggered by the coach engine and was congratulated. The context can contain arbitrary information related to the nature of the coach engine. In an illustrative example, a cadence engine may retain a time between reps of an exercise as an indicator of the individual slowing down due to fatigue. This indicator may be used to trigger content, presented to users to notify them of fatigue. In some examples, a recommendation may be presented, such as “take a rest” or “have a drink of water.”

According to various embodiments, each coach engine 614 can exist in one of a number of states. Example states include, but are not limited to, intervening or congratulating. An intervening state is one where the coach engine triggers a recommendation to the coaching intelligence system 600 so that the athlete will be presented to do something to correct performance of an exercise. For example, a stuck engine may issue a flag that triggers content recommending users “to drop lower in their squat.” Each coach engine can be configured to emit recommendations in real-time. In some examples, multiple coach engines may issue recommendations simultaneously, and coaching intelligence system 600 executes a coaching strategy based on coaching strategy configuration file 612 to arbitrate between the different recommendations being offered by the individual coach engines 614. A congratulating state is one where a coach engine 614 issues a flag that triggers coaching intelligence system 600 to recommend that the athlete be positively acknowledged for something the coach engine 614 observed. In an illustrative example of the stuck engine, a congratulating state might be issued where the athlete resumes a sequence of movements correctly. In another example of a trait spotting engine, the athlete may have dropped their guard while boxing, and corrected their guard when told by the coaching intelligence system 600, thereby recommending a congratulations for doing so.

The coaching strategy engine 608 can function as an interface between coaching intelligence system 600 and user systems 630. The decisions made by coaching intelligence system 600 will be communicated to the user system(s) 630 as content presented via user system(s) 630, such as, but not limited to, audio coaching, video feedback, or updating a GUI that may include text, images, animations, projections, or other methods of interaction. Coaching strategy engine 608 can utilize a plurality of channels to communicate with user system(s) 630 (and particularly applications running thereon).

In an illustrative example, as shown in FIG. 6, coaching strategy engine 608 can use a focus channel and an information channel for communicating content. The focus channel may be a serial channel, similar to a message queue, that holds an ordered stream of notifications to the user system(s) 630 containing only coaching information to be provided to the user. The order of the content may be a ranked list of priority, where the highest ranked content is the most pertinent to correcting user performance. The highest ranked content would be provided first to the user system(s) 630, with subsequently ranked content provided next. The ranking may be based on real-time recognition of movements and understanding of the performance, for example, based on processing nuance movements.

In an illustrative example, an individual may be performing a squat and making three simultaneous mistakes as observed through analysis nuance movements (e.g., by movement recognition engine 206 and stored in exercise results data). One of these mistakes, knee valgus under load, may be considered sufficiently egregious that individuals should be advised to stop performing the exercise, irrespective of what other mistakes they are making. In this instance, the coaching intelligence system 600 may issue content instructing the user to end the set and put down the barbell, which would be pushed to the front of focus channel queue.

In another example, coaching intelligence system 600 may present content in the form of an audible count as the individual completes reps of an exercise. During this set of reps, if the individual makes a particular movement fault that is recognized by, for example, human movement recognition system 200, then the coaching intelligence system 600 would deem that the user should be notified about the fault in real-time with a reminder cue. The focus channel could be utilized to interrupt the count and provide the reminder cue instead (e.g., rank the count lower than the reminder cue), before returning to the count. A few reps later, the individual may correct the movement mistake, as recognized by human movement recognition system 200, and the coaching intelligence system 600 can function to add a congratulation cue to the focus channel at a higher ranking than the count. The coaching intelligence system 600 causes user system(s) 630 to present content that interrupts the count with a congratulations and observation of the correction, before resuming the count. In this example the focus channel could be used to cause the user system(s) 630 to emit data such as “1 . . . 2 . . . 3 . . . remember lift your chest . . . 5 . . . 6 . . . great correction . . . 8 . . . one more . . . and 10.” In another example, the instruction to lift your chest could be accompanied by video content showing the mistake and how to correct it. In one implementation, one video (e.g., corrective video) may be overlaid on another video (e.g., error video). In another implementation, the corrective video may be displayed as a picture-in-picture correction with the error video.

Unlike the focus channel, which is filtered, the information channel may be a stream of different information that can update elements of the UI, or be stored in a data system for later processing and presented to the user via user system(s) 630. In an illustrative example, a UI on user system(s) 630 may contain design elements which indicate the number of reps to be completed, the number of reps actually completed, a color-coding that indicates the quality of the previously completed reps, a score derived from the sum of reps, a leaderboard showing the individual's performance against a number of other previous performances, etc. The information channel may be used by coaching intelligence system 600 to forward data necessary to update these counts, displays, and leaderboards in real-time based on exercise results from movement recognition.

In another example, a UI may not be showing information in real-time, but instead storing data to be presented in a report at the end of a session. The information channel can be used by coaching intelligence system 600 to forward data about the session to user system(s) 630, so that the report can be compiled and displayed to the user post-session.

In yet another example, such as a “virtual class” where participants are in a video workout with a remotely available instructor, the focus channel may present real-time feedback to individuals, whereas the information channel may route information to the coach so that the coach can intervene. As an example, individuals may beat their personal best in an exercise and this information on the information channel could drive an autocue-like experience for the remote coach to know to congratulate the individual verbally.

The coaching strategy configuration file 612 can be set to provide coaching strategy engine 608 with trigger criteria of when to stop an exercise. For example, criteria can be defined in coaching strategy configuration file 612 according to a coaching strategy that can instruct coaching strategy engine 608 when to stop monitoring an exercise. Criteria can be associated with an exercise, technique, and/or exercise routine depending on the implementation. In various embodiments, coaching strategy engine 608 may need to know when to stop monitoring the exercise, otherwise it would run indefinitely, and the trigger criteria provides one approach for doing so. In various embodiments, coaching strategy configuration file 612 utilized in this way gives the coaching intelligence system 600 functionality to issue instructional content in a number of techniques. In an illustrative example, there may be two types of criteria for triggering stoppage of monitoring an exercise: a success stop criteria and a fail stop criteria. In some implementations, coaching strategy engine 608 may be configured with multiple criteria associated with one exercise, technique, and/or exercise routine (e.g., for both success and failure outcomes, for multiple success outcomes, for multiple failure outcomes, and combinations thereof). The information that the athlete succeeded or failed to complete the exercise and why can be used to determine future exercises and targets for those exercises.

A success stop criteria may be when an individual completes an exercise (or technique) successfully. For example, this may correspond to when individuals have reached a target number of reps or a target time, they have completed a movement assessment, or they have managed to perform a set number of exercises consecutively without error. Responsive to recognition of the criteria, coaching intelligence system 600 can function to issue a “successfully stop” command to stop tracking an exercise. Success stop criteria can be configurable in coaching strategy configuration file 612, for example, based on the observation and composition of nuance movements (e.g., “stop when you have counted 3 reps, where the individual achieved a particular squat depth each time without dropping their torso”). The coaching strategy configuration file 612 can be set with specific goals for the coaching strategy that define the success stop criteria.

A fail stop criteria may be when a coach decides that the individual should no longer proceed with the exercise. For example, the coach may decide an individual is performing a technique that could be injurious; an individual appears to be overwhelmed, confused, and keeps getting stuck; an individual is showing indications of tiredness through observation of slowing in cadence, etc. Responsive to recognition of the criteria, coaching intelligence system 600 may trigger a fail stop and bring the exercise to an end. Like success stop criteria, the fail stop criteria can be configurable based on the observation and composition of nuance movements. The coaching strategy configuration file 612 can be set with specific criteria for the coaching strategy that define the fail stop criteria.

In various implementations, coaching strategy engine 608 can be implemented as a dynamic run-time interpreter of the coaching strategy configuration file 612. As described above, coaching strategy configuration file 612 may be set by a coach and used to define various coaching strategies that can be executed by coaching intelligence system 600. Coaching strategy engine 608 can ingest coaching strategy configuration file 612, interpret the contents therein, and initialize one or more coaching engines 614 based on the coaching strategy configuration file 612. Additionally, coaching strategy configuration file 612 may contain stop criteria, as described above. Coaching strategy configuration file 612 provides for a separation between coaching strategies from application code, so that a coach or other movement practitioner can control how the coaching intelligence system 600 executes a specific curriculum and repertoire of exercises, according to a particular pedagogy and coaching style as defined in coaching strategy configuration file 612. The coaching style is thus not left to an application coder or application designer, who may not have proper knowledge of coaching strategy specifics. Conventionally, fitness applications have relied on hard coding of strategies into the application, which minimized configurability and flexibility for effectuating specific coaching strategies. By moving coaching strategies into coaching strategy configuration file 612, the coaching intelligence system 600 can also support user-friendly tooling that enables easy construction of coaching strategies without any coding knowledge, and without having to redeploy applications.

The knowledge of which content to present to the user based on exercise results can be obtained by an asset map engine 606 that references an asset map for locating information that user system 630 can use to fetch content from asset management system 604. The asset map engine 606 may function as mediator between asset management system 604 and coaching strategy engine 608 by informing the coaching strategy engine 608 on which content is relevant to decisions made by the coaching strategy engine 608, which coaching strategy engine 608 can then provide to user system 630 for requesting content from asset management system 604. In an illustrative example, coaching strategy engine 608 communicates the information indicating which content to request to user system 630 over the information channel or focus channel, depending on the urgency of the content. Coaching strategy engine 608 can function to make decisions on which content to communicate to user system(s) 630, via a channel, based on human movement recognition driven by a coaching strategy executed by coaching strategy engine 608 (e.g., according to coaching strategy configuration file 612). That is, for example, human movement recognition system 200 may function to recognize movements and generate exercise data as described above, which coaching strategy engine 608 receives and uses to make decisions on coaching strategies according to coaching strategy configuration file 612. Asset map engine 606 functions to receive commands from coaching strategy engine 608 defining recommendations, which asset map engine 606 uses to select the content, according to the asset map, to be displayed to the user according to the recognized movement and coaching strategy. Asset map engine 606 can then provide information identifying the content to coaching strategy engine 608, which slots the information on the appropriate channel for instruction user system 630. User system 630 can then use the information to retrieve the content from asset management system 604. Thus, real-time personalization and dynamic presentation of content can be provided by coaching intelligence system 600 powered by results obtained by human movement recognition system 200.

In an example implementation, human movement recognition system 200 may function to recognize that an individual performing a squat is bending their back, which could result in injury. Coaching strategy engine 608 may receive this result, execute a coach engine 614 to interpret the result, and flag a recommendation that the individual needs to straighten their back. Coaching strategy engine 608 may instruct asset map engine 606 to select content for presenting a recommendation to the user to “straighten your back”. In an example, asset map engine 606 may reference the asset map to locate which content is mapped to the recommendation from coaching strategy engine 608, for example, “StraightenBack.mp4”. Asset map engine 606 provides information to coaching strategy engine 608 that identifies the selected content, such as a title of the content, URL, or other identifying information. Coaching strategy engine 608 generates instructions using the information from asset map engine 606 and slots the information into the appropriate channel. For example, in this case, coaching strategy engine 608 may generate instructions “Show video StraightenBack.mp4” and queue the instructions on the focus channel. Based on a coaching strategy, coaching strategy engine 608 may prioritize this recommendation such that the focus channel moves “Show video StraightenBack.mp4” to the highest rank in the queue. Then, user system 630 can function to fetch the content according to the identifier from asset management system 604 and present it on asset management system 604 accordingly. In another example, coaching cues may be obtained as text, which can be fed into a text-to-speech engine for presenting the recommendation to the user. In yet another implementation, content may be provided as a video file to be shown to the individual in the moment illustrating the mistake and correction, which may be shown as b-roll or as picture-in-picture.

The asset map may comprise conditions associated with content that asset map engine 606 can reference for selecting content. For example, recognized movements, such as errors, can be associated with content for correcting the error. Additional conditions may be associated with a type of content. For example, different numbers of instances that a specific fault or error is observed can be assigned to different content. In an illustrative example, a first instance of an error may be associated with a text file, which asset map engine 606 can locate content to cause a textual reminder to be displayed at the user system 630. If the error is repeated a number of times, the urgency of the recommendation may be increased and associated with a video file, which can be displayed on the user system 630. If the error is continued, the increased number of occurrences may be associated with an audio file (alone or with a video) that can be presented via user system 630. In another example, a condition may be set in coaching strategy engine 608 that content can be fetched and presented to the user after a prescribed number of recognized errors (e.g., present content after an error is seen 3 times, either consecutively or over a set time period).

In another example, asset map engine 606 may be configured to select certain content on condition that other content was previously delivered to the user system 630. For example, responsive to recognizing an error, asset map engine 606 can select second content for delivery to user system(s) 630, only if the first content was presented to the user at some point prior to recognizing the error. The configuration can be useful where a user has received content explaining an error as first content, and the error is subsequently recognized. For example, an athlete may have been taught what “shooting your slide” means in rowing via first content, and has previously been taught “block your hips” as a corrective cue for this error, either via first content or other content. If an athlete is observed making the shooting the slide error subsequent to being taught the corrective cue (referred to herein as “consciously competent” of the technique error), asset map engine 606 can select content containing the cue “block your hips” for delivery to 630 and present this to the user. Another athlete who is unaware of what shooting the slide means (e.g., the user is “unconsciously incompetent”) will not be presented the real-time cue (e.g., coaching intelligence system 600 will not communicate second content). Instead, the error can be flagged by coaching intelligence system 600 as needing the “shooting the slide” content that explains the error and corrective cue (e.g., first and/or other content). Asset map engine 606 can then select content and deliver the locating information for the content as needed for the other athlete.

The intelligence of the asset map engine 606 can be defined in asset map configuration file 610 rather than in code, similar to coaching strategy configuration file 612, so that the decisions on which content to select and when can be made by coaching and content teams, without coding knowledge. For example, the intelligence of the asset map engine 606 may be provided as an asset map defined in asset map configuration file 610. In one example, the asset map may be provided as a look up table of results from coaching strategy engine 608 mapped to content. In some implementations, the asset map comprises references to results of recognizing nuance movements, sequence movements, measures of performance, and/or coaching strategies associated with algorithms for performing calculations to locate associated multimedia content. In an example implementation, the asset map comprises programming language to calculate an output (e.g., content) from a given input (e.g., results from human movement recognition system 200 and/or coaching intelligence system 600). For example, the asset map can comprise descriptive language that can function to convert input JavaScript Object Notation (JSON) objects into output JSON objects. Further, the use of configuration files 612 and 610 allows development teams to render a dynamic personalized real-time experience without any need to understand the underlying coaching strategies or content to deliver them. Whereas, in conventional systems that provide for audio or video movement coaching, a content management system may exist that includes video, audio, images, text and other media assets that may be fetched and presented to the user through a user interface according to a coded algorithm.

As alluded to above, knowledge of which content to present to the user based on exercise results can be obtained by asset map engine 606. Movement recognition provided by, for example, human movement recognition system 200, can facilitate the ability of coaching intelligence system 600 to select and deliver content to users in real-time so as to present a real-time cue to a user that is relevant and pertinent to techniques the user is currently performing (or delivery immediately after completion). Conventional coaching systems will simply utter every possible mistake they see whenever they see it, with none of the filtering or choice of language a real world coach would have. As noted above, coaching intelligence system 600 provides an intelligence (sometimes referred to as “Coaching IQ”) through asset map engine 606 and coaching strategy engine 608, using the config files 610 and 612, configured to discern a type of multimedia content, a cue to be presented using the content, when and how to present the cue to an individual based on knowledge and expertise, and based on knowledge and expertise of how real world coaches would coach a particular modality or technique—all of which can be defined in asset map configuration file 610.

As described above, coaching intelligence system 600 fetches and delivers multimedia content to user system(s) 630. The multimedia content contains a cue (e.g., instructional information, recommendations for movements, congratulatory information, etc.) that is communicated to the user through the multimedia content executed by the user system(s) 630. As used herein, “real-time” refers to two things occurring at the same or substantially close in time. For example, a real-time cue may be presented to the user in the moment, while the person is still performing the technique or exercise for which the coaching is being provided. In some implementations, a cue may be provided immediately after the technique or exercise has been completed (e.g., within 5 seconds, 10 seconds, 30 seconds, etc. of completing the movement).

In an example implementation, upon recognizing a single technique fault (e.g., through application of nuance movements), Coaching intelligence system 600 can be configured to fetch content from asset management system 604 that contains a correction for the recognized fault. Coaching intelligence system 600 can deliver the content to user system(s) 630 on the focus channel, and user system(s) 630 can execute the content to communicate the cue, in real-time, to the user. The user can then correct the fault responsive to the cue, for example, on the next rep. In the case of multiple faults, coaching intelligence system 600 can prioritize the delivery of content on the focus channel, as described above.

In another example of real-time cues, asset map engine 606 can be configured, via asset map configuration file 610, to fetch content containing positive coaching cues and/or positive reinforcement cues to be presented in real-time. An example of a positive coaching cue may be where, in performing a squat, an athlete may execute a particularly good rep by lifting their chest and hinging at the hip. On recognizing these nuance movements, asset map engine 606 can be configured to fetch content that contains a cue “way to hinge at the hip” and/or “great torso position . . . I can see the logo on your shirt!”. The content can be provided to user system(s) 630 and executed to acknowledge and anchor the good rep rather than just calling out an error. An example of a positive reinforcement cue may be where, when observing an error, rather than cue on the error, asset map engine 606 may be configured to fetch content describing or suggesting movements to improve performance. For example, in the squat example above, an error of bending too far forward and dropping the chest horizontally may be recognized via nuance movements, and asset map engine 606 can be configured to fetch content containing a cue “show me the logo on your chest”. If corrective movements are also recognized, a congratulatory cue can also be retrieved (e.g., “there you go, that's the position I'm talking about”). Using the focus channel, while counting reps, the content can be presented as “one . . . two . . . three . . . show me the logo on your chest . . . five . . . there you go, that's the position I'm talking about”. In this way, coaching intelligence system 600 is asking for a good posture and rewarding the observation of it, rather than calling out faults and anchoring negative movement patterns.

Asset map engine 606 can also be configured to present intentional practice real-time cues. For example, coaching strategy engine 608, configured with a coaching strategy via coaching strategy configuration file 612, can decide a next technique that a user should be mindful of (e.g., an intention) for a next rep or series of exercises. The intention can be calculated based on coaching strategy configuration file 612, informed by movement recognition of previously executed techniques, which can be used to determine an intention for the next technique or exercise. For example, a user may be performing squats and an intention may be calculated for a next set of reps of the exercise. An error of failing to lift the chest may be observed in a preceding one or more reps, which coaching strategy engine 608 can use to calculate an intention of “let's do 10 more squats, focus on lifting your chest.” Asset map engine 606 can then fetch content including the cue “let's do 10 more squats, but this time I want you to focus on lifting your chest” which can be communicated to the user in real-time. In some implementations, once an intention has been set and communicated, future cues may be restricted to those relevant to the intention and may be communicated to assist the user in accomplishing the intention.

Real-time cues may include a coaching feeling with presumptive questions. For example, by hitting a correct biomechanics posture, there is often a feeling that can be presumed in the athlete's body that can be provided as content presented to the user. For instance, with a correct hip hinge in an overhead squat, a real-time cue may be presented to ask athletes if they're experiencing the feeling. In an illustrative example, a proper bottom depth posture of a squat may be observed by movement recognition, which may trigger coaching strategy engine 608 to cause asset map engine 606 to fetch content containing a cue “are you feeling those heavy heels stuck to the floor?.” Coaching strategy engine 608 can then communicate the content to the user while the user is in the bottom posture position. Thus, presumptive questions and coaching cues that can be issued when human movement recognition system 200 has observed the correct biomechanics that set up that feeling.

In another example implementation, real-time cues may be presented based on a nuance trait matrix defined by asset map configuration file 610. As described above, there may be four types (or categories) of recognition that may be made related to nuance movements of a technique. The various types of recognition can be used by coaching strategy engine 608 to drive real-time coaching intervention cues. Traits of nuanced movements may be positive or negative, both which can be seen (e.g., recognized by, for example, human movement recognition system 200) or not seen (e.g., not detected by human movement recognition system 200). As outlined above in connection with FIG. 2, coaching intelligence system 600 may be configured to deliver content containing intervening cues based on whether a positive or negative trait is either seen or not seen. The determination of whether to intervene or not may be configured by coaching strategy configuration file 612 and dependent on the nuance movement and/or technique performed.

FIG. 7 illustrates an example nuance trait matrix 700 in accordance with an illustrative example. Nuance trait matrix 700 comprises a two by two matrix, each entry corresponding to a nuance movement of a specific technique. In this illustrative example, nuance trait matrix 700 corresponds to a thruster, similar to that shown in FIG. 5. In an example operation, human movement recognition system 200 may function to monitor a user performing the technique of nuance trait matrix 700. In one case, human movement recognition system 200 may recognize a positive nuance movement (e.g., arms overhead of body) from the body object stream. This recognition, can be provided to coaching intelligence system 600, which triggers coaching strategy engine 608 to use the asset map engine 606 for fetching content containing intervention “Nice—arms are directly overhead.” Coaching strategy engine 608 can then deliver the content to user system(s) 630 so that the cue can be presented to the user in real-time. As another example, human movement recognition system 200 may not recognize that that user performed an expected positive nuance movement (e.g., “weights on shoulders before squat starts”). Once the squat is started, since the positive nuance movement was not recognized, coaching strategy engine 608 can deliver the content to user system(s) 630 so that the cue (e.g., “I want to see weights on your shoulders before each squat starts”) can be presented to the user in real-time.

While nuance trait matrix 700 is shown as a two-by-two matrix, nuance trait matrices according to the embodiments disclosed herein are not limited to this implementation. A nuance trait matrix may include more than the four example entries based on a number of nuance movements for a given technique. Each nuance movement may be positive or negative and can be seen or not seen. Thus, a matrix may contain any number of entries as configured by the asset map configuration file 610.

The combination of whether a trait was seen or not seen, and whether it is considered a negative trait or a positive trait offers different combinations and nuance movements of real-time coaching cues and congratulatory cues to be delivered.

Another example of a real-time cue that can be configured in asset map engine 606 via asset map configuration file 610 may be progressive intervention cues. For example, it can be both a frustrating experience and poor coaching to announce a mistake every time the mistake is seen, or worse, to announce every mistake, every time the mistake is seen. To reduce the frustration of the user, coaching intelligence system 600 can be configured to gradually bring something (positive or negative) to the user's attention and more so to the user's conscious attention, and, in the case of a mistake in the movement, give the user the opportunity to correct the mistake with minimum intervention. For example, if a mistake is repeatedly recognized, asset map engine 606 may be configured to fetch the content to notify the user of the mistake, which coaching strategy engine 608 may deliver to user system(s) 630 after a number of allowable mistakes are recognized, either consecutively or non-consecutively according to the coaching strategy engine 608. Then after a number of n more recognized mistakes, coaching strategy engine 608 may present content selected to correct the mistake. Then, after a number of m more recognized mistakes, coaching strategy engine 608 may present additional content selected to correct the mistake. The numbers of allowances, n mistakes, and m mistakes can each be configurable, for example, in asset map configuration file 610 and/or coaching strategy configuration file 612. Content presented after each number of mistakes may be the same, similar, or different in type and/or information contained therein. At any point, if the specific correction requested is recognized, the coaching intelligence system 600 may deliver congratulatory content that can be presented to the user.

In an illustrative example, an athlete may be performing a squat technique. The number of allowances may be set at three and the mistake being monitored may be for the knees collapsing inwards at the bottom of a squat (“knee valgus”). In this example, coaching strategy configuration file 612 may configure coaching strategy engine 608 to intervene only after recognizing three mistakes. Responsive to recognizing a third mistake, coaching intelligence system 600 may deliver a first content containing a first intervention cue, for example, an audible and understandable beep (or other subtle visual cue, such as a blinking light) that signals for the attention of a user to a coaching point. After n more mistakes coaching intelligence system 600 may deliver a second content containing a second intervention cue, for example, a text label to be displayed, an audio cue to be played, etc. that instructs the user to “focus on your knee position”. This second content may be selected to bring awareness to the mistake but allows users to correct themselves, thereby reinforcing their conscious competence. After a total of m mistakes, coaching intelligence system 600 may deliver third content containing a third intervention cue that includes detailed coaching instructions, for example, an on-screen video or descriptive audio explaining the mistake and the correction to be made.

Accordingly, coaching intelligence system 600 can be dynamically configurable to provide “progressive intervention”. This progressive intervention can provide for the delivery of a coaching experience that balances learning and experimentation, with the corrective feedback and coaching cues necessary to prevent injury and improve technique, all in real-time while the user is performing the exercise as though a real world coach was observing and providing instruction.

Conventional fitness systems require a user to simply follow along to an on-screen coach, for a determined period of time according to an audio or video track. For instance, users may be told to “follow along with me for the next 45 seconds” with no accountability as to how much effort or how many reps they should accomplish in that time. In contrast, coaching intelligence system 600 can function to provide any number of configurable exercise programs or routines, each of which can be delivered digitally in a way that is not feasible using pre-stored tracks. Coaching intelligence system 600 can leverage personalize and configurable coaching strategy configuration file 612 to define exercise programs within coaching strategy engine 608, which can leverage asset map engine 606 for presenting content. An exercise program may consist of a number of exercises, each of which consists of techniques. Coaching intelligence system 600 may utilize human movement recognition (e.g., human movement recognition system 200) for recognizing movements performed as part of the exercise program or routine. For example, as shown in FIG. 4, an exercise program can encapsulate one or more exercises.

Coaching strategy configuration file 612 may define an exercise program that can be initialized by coaching intelligence system 600. The exercises include one or more techniques to be performed, which coaching intelligence system 600 can report to human movement recognition system 200 as exercise data. Human movement recognition system 200 can use exercise data to locate techniques from the technique dictionary in technique datastore 212. Human movement recognition system 200 can track performance of the multiple techniques contained within the exercise routine, recognize techniques performed, gauge performance, and report in real-time on the observations as exercise data that can be provided to datastore 602.

An example exercise program may be set in coaching strategy configuration file 612 can be an “As Many Reps as Possible” (or “AMRAP”) program, in which users will be told to push themselves to perform as many repetitions of a technique (or exercise) as possible in a given time period. In this scenario, detected movements that qualify as a completed technique, through detection of nuance movements (such as the “no reps” functionality described above), can be included to inform counting of reps by a coach engine 614. For example, each completed technique may be a rep and a counter engine can function to count a number of detected movements that qualify as the technique (e.g., meet threshold performance measured by occurrence and/or absence of nuance movements). Where a detected movement does not meet the assigned threshold performance measure according to human movement recognition system 200, coaching intelligence system 600 may identify it as a no rep and not count that specific movement.

In another example, a user may be given a target number of reps to achieve. In this case, the target number can be calculated according to an expected outcome from an algorithm, or from targets achieved by a similar cohort of users, or from a personal best that the user accomplished in a previous workout. In the target number implementation, a user might be encouraged to reach or beat the target with motivational cues, such as “3 more”, “2 more”, “1 more”, generated by coaching intelligence system 600 and triggered according to a rep count via coach engine 614 powered by human movement recognition system 200. The motivational cues may be provided over the focus channel. In some examples, a user can be rewarded with motivational cues, such as “A new personal best!”, delivered using audio, video, and/or with acknowledgements and graphics presented on a user system 630 via coaching intelligence system 600, according to asset map engine 606.

In another example implementation, an exercise program can be a “Every Minute on the Minute (“EMOM”), sets a clock to 60 seconds, during which a user is given a target number of reps to achieve. As soon as an individual achieves that number of reps, the remaining time on the clock is provided for resting. Similar to the AMRAP program above, coach engine 614 can function to count movements qualifying as reps according to human movement recognition system 200 and trigger a coaching intelligence system 600 to present cues to the user. For example, cues may be presented in video, audio, and/or textual formats according to asset map engine 606 to inform users if they are on-track or not to reach the target number of reps. In an example implementation, content presented to the user can be varied between an active phase (e.g., performing movements) and a rest phase. For example, while performing movements towards the target, content can be presented that, for example, counts reps performed, provides motivational music, displays on-screen example movements, among others. Once coaching intelligence system 600 recognizes the target number of movements have been performed, content presented to the user can be transitioned according to coaching strategy engine 608 without any additional interaction from the user. The content at this point may indicate that the user is now in a rest phase, and may, for example, reduce music volume, show the remaining time for rest period, etc. While the term EMOM may be used for one-minute bursts of movement and rest, EMOM programs of the embodiments disclosed herein can refer to longer or short periods of time, for example, a 30-second EMOM (e.g., 30 seconds of time to reach the target reps before using the remaining time as rest period), a 2-minute EMOM, etc.

Another example exercise program may provide for a super-set, which represents a series of exercise to be performed, often multiple times with rests in between. An example super set can include, but is not limited to, “A single set is 10 push-ups, followed immediately by 10 sit ups and then immediately by 5 squats. Do 3 sets, with 30 seconds of rest between each set”. Super-sets can be difficult to execute in conventional systems that rely on prestored audio or video tracks, because there is uncertainty where the user is in performing the exercises and the user may not be at the same pace as the video or audio track. In contrast, coaching strategy engine 608 can be configured to count reps of each exercise performed as detected by human movement recognition system 200, and progress (e.g., through audio, visual, or tactile feedback) the user from one exercise to the next. For example, movement recognition engine 206 can recognize movements and coaching strategy engine 608 can use the program to count techniques and exercises, while asset map engine 606 fetches content according to triggers from coaching strategy engine 608 based on reaching a programmed number of sufficiently performed techniques/exercises. Content provided by coaching intelligence system 600 can then progress the user to a next technique and/or exercise. Movement recognition engine 206 can also function to recognize when a super set is complete, and trigger coaching intelligence system 600 to fetch content to begin a rest phase. Thus, coaching intelligence system 600, powered by human movement recognition system 200, can be utilized to facilitate execution of the superset from beginning to end, with minimal (or no) interaction required between the user and user system to present content according to the coaching system. Coaching intelligence system 600 allows the user to proceed at a user's own pace, to complete the super-set.

Yet another example program is a guided learning program (or follow the leader program), in which in-person personal training can be used to control intensity of effort by having the coach perform exercises while the athlete watches, and then give the athlete a turn to perform their exercises while the coach watches. Conventional systems are unable to deliver this type of program without direct observation of the athlete's performance by a coach or instructor. Traditionally, digital coaching systems provided a “sage on the stage” approach (e.g., watch someone do something and explain it before it's your turn), where learning is dependent on the athlete trying to keep up with what's happening on screen. For example, in guided learning (or “follow the leader”), an instructor performs parts of the exercise while athletes attempt to follow along and keep up. Conventional systems of digital coaching failed to provide a method to slow down or wait for a user to catch up with the digital coach as the coaching was either remote—and the coach was unable to observe the performance of the athlete—or via a prerecorded track.

Whereas coaching intelligence system 600 can leverage human movement recognition system 200 to provide for a guided learning program. Coaching strategy engine 608 can be configured with a guided learning program defined in coaching strategy configuration file 612. In an illustrative example, teaching the rowing stroke can be first presented to a user in whole through content delivered to user system(s) 630. The user may be permitted time to practice the entire stroke. The stroke can then be broken into constituent parts, for example, an initial drive phase and a recovery phase, each of which can consist of one or more techniques. The drive phase can be broken down into further techniques, for example, using a drill called a “pick drill” which teaches how to first use the legs, then use the legs and body in coordination, and then use legs, body and arms. During this phase, each drill may be presented via content on user system(s) 630, after which the athlete can perform the drill. Once the athlete demonstrates the drill via movement recognition, coaching strategy engine 608 can transition the athlete to the next drill. Upon successful demonstration of the entire drive phase through movement recognition, the athlete can be transitioned into the recovery phase. The recovery phase can also be broken down and taught using a “pause from finish drill”, and the athlete transitioned throughout the phase similar to the drive phase above. For example, coaching intelligence system 600 may present content to the user instructing the user to get into a finish position. Once human movement recognition system 200 recognizes that the user is in the finish position, coaching intelligence system 600 may present a next instruction of “Arms away”. When the athlete correctly positions their “arms away”, coaching intelligence system 600 can then instruct “body over”. And finally, when they correctly lean their body over, coaching intelligence system 600 can instruct the user to “and row”, thereby completing the stroke back to the finish position.

In another example, some techniques may consist of a complex sequence of movements, that can be hard to remember individually. For example, in a squat-to-press, an athlete can be taught the first part (e.g., the squat) and after successful performance of the technique to a configurable quality (e.g., based on nuance movements), coaching intelligence system 600 can instruct the user to then add the press to the end of the technique. The content provided may be, according to this illustrative example, provided as “start with your hands at your shoulders”. “Good, ok squat down holding the squat at the bottom”. “Just like that, next, I want you to keep your hands where they are standing straight up”. “Good squat. Let's add in the press. Push your hands straight up so your arms are next to your ears.” “Great press, Bring the weights back to your shoulders”. “Just like that. And now let's start again. Squat down.”

The ability to configure coaching intelligence system 600 for guided learning can be beneficial for onboarding new users. For example, through the guide learning programs, it can be possible to provide a “learning library” of techniques that can be learned at a user's own pace, before joining in classes. In an example implementation, customers may be taught the basic rowing stroke before rowing classes. In a yoga example, a new user might be taught “10 poses you need to know to join your first class with confidence”. For a strength training example, fundamental postures like a squat can be taught prior to performing a thruster or squat-to-press. In a kickboxing example, a new user may be taught “the 6 basic punches and kicks you need to know.” These are only a few examples of the applications of guided learning programs for onboarding new users.

The ability to configure coaching intelligence system 600 for guided learning can be beneficial for omnichannel fitness classes, for example, by providing a means for addressing barriers for new members to join a class because they are intimidated that they don't know what to do (referred to as “gymtimidation”). Similar to the above examples for onboarding new users, a fitness studio can offer a companion application that can be installed on user system(s) 630 that uses coaching intelligence system 600 and human movement recognition system 200 to teach basics and fundamentals in the psychological safety of an at-home and at-your-own pace environment, before users attend a class.

In another example implementation, an instructor of a class may receive a report of techniques that class members are having difficulty performing. In the case of a new member to the class, an instructor may use this report to further welcome a user and provide instruction on techniques the new member was struggling with.

In another example implementation of a guided learning program, coaching intelligence system 600 can be configured to progress through different modes of instructional teaching. For example, coaching intelligence system 600 can be configured to deliver content that includes a cue of “watch the instructor.” In this mode, an athlete watches a short instruction of a technique from a real-world coach, remote coach, or video content provided by coaching intelligence system 600. Coaching intelligence system 600 can transition the athlete into performing the techniques through presented content. In one example, a cue may be provided that instructs the user to perform one rep of the technique and then watch the coach perform one (e.g., a “one for one” strategy). As another example, a cue may instruct the user to watch the instructor perform a number of reps and then follow with the user performing the number of reps (e.g., “I'll do x, you do x” repetitions). When the coach finishes their reps, the user can be observed (e.g., by human movement recognition system 200) in performing their set of reps. During this performance, real-time coaching cues, rep-counting, etc. may be provided by coaching intelligence system 600 to user system(s) 630, in order to optimize the users' learning. When the system observes the athlete complete their requisite number of reps, the coach can perform another set of reps for the athlete to watch, and so on. The coaching strategy may be configurable such that the coach can perform the same number of reps as the user, or fewer as defined by coaching strategy configuration file 612.

In some implementations, a user can be transitioned from learning through imitation to learning by recall. For example, coaching strategy engine 608 may be configured to initiate a guided learning program by demonstrating videos of a coach performing techniques, which the user then imitates with the system observing the movements. As the user progresses, for example, by demonstrating a target performance based on analysis of nuance movements, coaching strategy engine 608 can transition from videos of the techniques to audio cues of techniques that serve to remind the user of the current or next technique to be executed. In some examples, as the user further progresses in performance, audio reminder cues may be removed and motivational instructions to keep going may be presented instead to provide positive coaching cues.

As another example, human movement recognition system 200 can function to recognize one or more techniques (e.g., sequence movements and nuance movements) or one or more exercises performed by a coach demonstrating the movements while the athlete rests and observes. The coach may pre-record or perform the movements in real time, but in either case sensors 240 can be used to collect raw data from which techniques and exercises can be recognized. Coaching intelligence system 600 can function to count a number of reps of each technique (e.g., using coach engine(s) 614) and/or exercise performed, along with an order in which the technique and/or exercises are executed. The coaching intelligence system 600 can then set a target number of reps using the counts, or use a preset target if desired according to coaching strategy configuration file 612. Once the coach is finished with the demonstration, coaching intelligence system 600 can switch to the user and use human movement recognition system 200 to recognize techniques and/or exercises, while coaching strategy engine 608 counts a number of reps (as described above) until the user performs the target number of reps (which can optionally include the concept of no reps). In another example, the coach may count the reps audibly as the athlete performs them, in response to a correct rep being performed. In some implementations, once the user completes their target number of reps, the coach can perform another one or more reps towards a target. In one example, the coach and user can have a target number of reps to perform together, which coaching intelligence system 600 can count until they reach that target number of reps. Similar to the AMRAP program, the user and/or coach may be given a target number of reps based on a personal best, or a cohort of other users, or any gamification configured to set target and challenge. Another example of gamification may include “streaks”, in which a number of reps can be set as a streak and when a user sufficiently executes the number of reps coaching intelligence system 600 can flag the movements as a streak. In an example, a multiplier may be a applied to a score responsive to a streak, where the value of the multiplier may be based on the number of rep in the streak (e.g., longer streaks can be awarded larger multipliers).

In another example exercise program, a user can be asked to keep time with a coach (who may be on-screen or in a capture volume with a user) so as to perform movements in synchronization with the coach. In some implementations, the coach may be represented as an avatar presented on a display of the user system. In executing this program, human movement recognition system 200 can function to compare real-time analysis not only of completed reps of techniques and/or exercise, but also the individual postures indicative of a complete movement. This approach can provide for increased measures of synchronization between a coach and a user. For example, in a boxing exercise, a coach may ask the user to perform a 3-punch combination consisting of a jab, followed by a cross, followed by an upper-cut. The user can perform movements that keep time with the coach performing not only the same combination of punches, but also throwing each individual punch in the combination at the same time as the coach. In an example implementation, coaching intelligence system 600 can function to generate a score for the user according to how many reps recognized (e.g., performed sufficiently to constitute a rep) in synchronization with the coach. Synchronization can be defined as within a threshold time period of the movement performed by the coach. The threshold time period may be set dynamically to offer varying levels of difficulty and challenge. In another implementation, coaching intelligence system 600 can function to score the user according to how many consecutive reps were recognized in synchronization with the coach, until the movements by the user are no longer within the threshold time period of the coach (e.g., failed). In another example, such as rowing with an instructor, coaching intelligence system 600 can generate a score calculated over a duration of an entire exercise, based on how well the user rowed in sync with the instructor. In yet another example, a multiplier can be applied to the score depending on the degree of synchronization. For example, larger multipliers may be applied to short differences in time between the user's movements and the coach's.

In another example exercise program, rather than recognize a prescribed sequence of exercises, the user may be offered a free style type program. An illustrative example of a free style program can be defined in coaching strategy configuration file 612 as “throw as many punches and kicks as you can in 30 seconds of free sparring”. Exercises can be extracted from coaching strategy configuration file 612, which can be stored for use by human movement recognition system 200. As described above, human movement recognition system 200 may recognize a first technique performed by the user, which starts the program and triggers the clock. Human movement recognition system 200 can then function to recognize one of the sets of exercises performed at random. For example, human movement recognition system 200 may recognize punch and kicks techniques performed in random order by the user. Human movement recognition system 200 functions to distinguish between each technique and provide a count for each technique performed In an example, coaching intelligence system 600 can function to initialize coach engines 614 to count and track the different exercises in real time, visually and/or audibly displaying the counts during the exercise or upon completion. In another example, different scores (e.g., different number of points) may be assigned to different exercises; throwing a jab at a boxing bag may score one point, while throwing a hook kick at head-height on the boxing bag may score five points. In yet another implementation, special combinations of techniques may be recognized and given a special score, such as “throwing two consecutive roundhouse kicks with the same leg, one at body height and one at head height” may be awarded 10 points.

Recognizing a set of different techniques in parallel can be a challenging task, which human movement recognition system 200 can address through the recognition approaches described above. One challenge is recognizing a portion of an exercise as an distinct exercise in its own right. For example, a burpee may involve performing a squat, then kicking the legs back into a push up position, performing a push up, and then jumping up with the arms above the head. Each component of the burpee—the squat, the pushup and the jump with arms above head—can be considered an individual exercise in their own right. In this case, human movement recognition system 200 can function to recognize each technique, and coaching intelligence system 600 can function to count the performance of each component as a single burpee, and not individual exercises. In this case, each component may be considered a technique, which collectively make up the exercise “burpee”. For example, the exercise program can be used by coaching intelligence system 600 to delineate between techniques that make up an exercise and those techniques that constitute an exercise in their own right. Thus, this delineation can be stored as exercise data that human movement recognition system 200 can utilize to define exercises and techniques for recognition of performed movements.

Another example program may be a free practice mode, in which a pre-set exercise program is not used and the user performs any technique or exercise desired. In this example, human movement recognition system 200 may detect a minimum number of reps (referred to as training reps), which can be set in coaching strategy configuration file 612, to recognize techniques and/or exercise routines the user is performing by referencing sequence movements stored in technique datastore 212. For example, key postures of sequence movements can be matched to detected postures to identify possible sequence movements. If all key postures of a given sequence movement are detected in the correct order, movement recognition engine 206 can select the technique including the recognized sequence movement as the one being performed by the user. If a number of moves are performed, movement recognition engine 206 can repeat the process for each move until an exercise is recognized (e.g., recognition of all techniques performed). Once recognized, movement recognition engine 206 can generate a free practice mode program that contains the exercise performed by the user, and then functions as described above based on the generated program. The generated program can then be provided to coaching intelligence system 600 for configuring coaching strategy engine 608. Thus, human movement recognition system 200 can utilize a number of training reps to recognize exercises performed by a user from a dictionary of sequence movements, with no a priori knowledge of what exercise the user is performing.

Coaching intelligence system 600 can function to provide a no-touch user experience. For example, by utilizing coaching intelligence system 600 and human movement recognition system 200, there may be no need for a user to interact with a user system to start/stop sets of exercises. Similarly, if the user is not ready (e.g., human movement recognition system 200 observes the user taking a drink of water or sitting down, or sensors 240 detects a user leaving the capture volume momentarily), human movement recognition system 200 can be controlled to wait for the user to initiate a technique. In an example implementation, a set of exercises may be started when the user performs a first technique. In another example, coaching intelligence system 600 may provide content to instruct the user to “perform as many reps as possible in 30 seconds. Ready when you are”. In this case, a countdown may not begin until the user performs a first technique, which triggers the program and starts the timer. In some implementations, human movement recognition system 200 can function to detect that the user has stopped performing techniques (e.g., because they are fatigued), which can cause coaching intelligence system 600 to trigger content that asks the user if the user wishes to rest or move on. The user may control the coaching intelligence system 600 either through voice instruction or through gestures such as a thumbs up, or nodding, which can be identified by the movement recognition engine 206.

In another example, a program set by coaching strategy configuration file 612 may be a set quality strategy, in which a target performance measurement can be set in coaching strategy configuration file 612. For example, an exercise routine may be at the end of a set of exercises, such as “do 10 reps of a TRX Squat Row,” the user is given an overall objective measurement of how well the set was performed. The measure may be performed by human movement recognition system 200 as described above, and communicated to coaching intelligence system 600. The measured performance can be compared against a target, which can be an ideal or perfect performance or against a previous “lower” performance.

As alluded to above, coaching intelligence system 600 can be configured to recognize and report an onset of fatigue in a user. Human movement recognition system 200 can function to recognize certain biomechanics that coaching intelligence system 600 can use to detect when someone is getting tired. For example, fatigue may be recognized from a gradual deterioration in performance of a technique, an inability to correct an error based on real-time cues, or explicit postures that indicate tiredness (e.g., resting hands on knees, bending over, laying on the ground with arms spread after a push up, etc.), among others. Human movement recognition system 200 can be used to recognize the movements, which coaching intelligence system 600 can then use to present content to the user. For example, by recognizing fatigue coaching intelligence system 600 can generate content containing engaging cues such as, but not limited to, “let's just finish on one more good one” or suggestions to stop a set early so as not to cause frustration (“you know what, let's take a rest before the next set”), as well as adjusting difficulty of the exercise in this workout (or in a future workout/target performance).

In some implementations, human movement recognition system 200 can be used to recognize movements of a plurality of persons in a capture volume that join a shared workout. These shared workouts may be referred to as group workouts. Coaching intelligence system 600 can be configured to drive the workout based on recognizing movements of each individual of the plurality simultaneously, such that each individual person can drive the workout. For example, Anna and Bob may both be performing squats, and coaching intelligence system 600 can be configured to combine counts of reps together into a cumulative score (e.g., during a group AMRAP workout). As another example, coaching intelligence system 600 can be configured for competitive scoring. In this case, Anna and Bob may be evenly matched in a workout, and coaching intelligence system 600 can be configured to compare counts of reps (e.g., an AMRAP) to drive competition against each other (e.g., see who can do the most reps in one minute).

In another example, coaching intelligence system 600 can be configured for a partner program, in which each individual takes turns performing exercises while the other rests. For example, the program may ask Anna to perform 10 reps while Bob rests. When Anna completes her 10 reps, Bob is then counted in for his reps, while Anna rests. Coaching intelligence system 600 can be configured to count each person's reps and trigger content instructing the next person to perform their reps.

In another example, coaching intelligence system 600 can be configured for a team program, in which exercise performances can be compared among a number of sets of individuals (e.g., teams). This program may be similar to running cumulative scoring and competitive scoring simultaneously. For example, Anna and Bob may be a team paired against Claire and Doug as a team. Coaching intelligence system 600 can be configured to combine Anna and Bob's scores to provide a cumulative score that can be compared against Claire and Doug's cumulative score. In another example, coaching intelligence system 600 may be configured to combine the partner program above (e.g., only one person doing the exercise at a time while the other rests) with the team program. In this case, a goal of doing more reps than the other team may be set by coaching strategy configuration file 612, and cumulative scores can be counted toward target reps before switching roles (e.g., between rest and active), or partners may be allowed to “tag the other person in” at any time to accumulate more reps than the other team. In another implementation of a team program, coaching intelligence system 600 can be configured to cumulate a scores based on synchronization between movements of team members, as recognized by human movement recognition system 200. For example, rowing teams (e.g., in real-world rowing or indoor rowing machines or ergometers) may be tracked using human movement recognition system 200 to recognize synchronization of movements, and coaching intelligence system 600 can be configured to apply multipliers to a cumulative score and/or speed based on a degree of synchronization between the team members (e.g., the more in sync they are rowing, the more points awarded or the faster the boat is moving”), which can be compared to other teams (e.g., via a dashboard or at the end of the workout to present a winner). In a similar implementation, coaching intelligence system 600 may apply multipliers based on the degree of synchronization with a coach or instructor.

In the group programs described above, coaching intelligence system 600 can communicate content to user systems 630 to populate real-time leaderboards (e.g., via the information channel). The scores can be driven according to coaching strategy configuration file 612 and based on recognition by human movement recognition system 200 of form-based criteria, such as, but not limited to, quality, correctness, consistency, and synchronization. User system(s) 630 may display a distributed leaderboard. In one example, the leaderboard may be displayed by a user system(s) 630 associated with each individual (e.g., connected fitness equipment, such as connected spin bikes or the smartphone of each user, etc.). Distributed leaderboards can allow individuals to monitor their performances against each other or against past performances, in real-time in an at-home environment or other remote environment. In another implementation, leaderboards may be displayed on one or more screens in physical facilities, such as rowing studios, spin studios, or bootcamp classes. In this case, participants within the facility may view the leaderboard, while members who wish to remain remote from the facility can still take part remotely on a shared omnichannel leaderboard.

For any individual technique, there may be a series of progressions and regressions for that technique. As described above in connection with FIG. 2, embodiments disclosed herein can discern the performance of a user for that technique through observation of nuance movements, which can be used by coaching strategy engine 608 to discern how competent someone is. In the case of low competence, coaching strategy engine 608 can be configured to revert the user to an easier variation or simpler alternative, through instructional content presented to a user. Whereas, in the case of improved performance (or meeting a target performance), coaching intelligence system 600/can be configured to graduate a user to a more nuanced level of quality, a more difficult variation, or a different exercise that can be substituted, for example, through content presented to the user. In an illustrative example implementation, human movement recognition system 200 may observe that a user is unable to keep a straight spine during push-ups, and coaching intelligence system 600 may regress them to doing push-ups on their knees. In another implementation, human movement recognition system 200 may observe someone performing a TRX Squat Row correctly, and coaching intelligence system 600 may set a higher standard and issue real-time cues for this standard (e.g., “do not initiate the squat until the arms are fully extended with a straight line from heels to hips to head”; “rotate the palms through 90 degrees on the row, keeping your shoulders away from your ears and demonstrating good scapular retraction”, etc.). In yet another example, human movement recognition system 200 may observe a user performing basic squats without difficulty, and coaching intelligence system 600 may progress the user to a “single leg (pistol) squat”.

In another implementation, coaching intelligence system 600 may be configured to lock certain exercises or techniques such that the exercise or techniques are unavailable to an athlete initially. These techniques or exercise can be “unlocked” responsive to the user showing consistent competence in performance of an available technique. For example, the “single leg (pistol) squat” may be locked by coaching strategy engine 608 until human movement recognition system 200 observers a user performing a basic squat at a set target performance for a number of instances, which may be a number of reps, a number of exercise sessions, etc. In another example, a technique (e.g., basic squat) may be a basis for unlocking an exercise (e.g., a thruster and/or burpee). Availability of techniques and/or exercises may be configured by coaching strategy configuration file 612, as can the requirements for unlocking techniques and/or exercises. This “crawl, walk, run” approach can be used to instill good coaching practices as well as improving user engagement and retention by encouraging and rewarding improvement and progress with new, more advanced, teaching, techniques, and/or exercises.

Coaching intelligence system 600 can be configured with an understanding of performance competence for exercises through definitions within coaching strategy configuration file 612. For example, performance competence for an exercise can be provided grades or levels of competence, where each grade or level is associated with threshold measures of performance for each technique of the exercise. The required performance may be configurable depending on the coaching strategy. Thus, each grade or level may have a certain milestone (e.g., threshold performance) that must be observed in the user's execution of the exercise in order to move the user to the next level or grade. Performance thresholds maybe be provided on a technique basis (e.g., each technique has a threshold that must be achieved), exercise as a whole basis (e.g., a threshold for a cumulative performance of all techniques for that exercise), or a combination thereof. The grade and/or level approach of user progression can be used to provide structured programs of content, for example, where there is continuous progression from beginner to expert performance levels based on acquisition of skills and demonstration of proper technique, as opposed to a number of classes attended or minutes logged.

In an example implementation, coaching intelligence system 600 can be configured to modify a pre-recorded, on demand video of a class with modifications in real-time, that are based on recognized movements of an individual athlete. For example, in a kickboxing video, an instructor might ask for front kicks to the head. However, coaching intelligence system 600 may know that an individual has not demonstrated a required performance level for this technique. Thus, coaching intelligence system 600 may modify the video by fetching other content (e.g., “I want you to keep the front kicks to the body, but really focus on lifting your knee before snapping the kick”), and inserting the fetched content into the previous content for presentation to the user recommending an adjustment of the class. In another example, a challenge may be moderated in the other direction so as to increase engagement by alleviating boredom. For example, the on demand, pre-recorded video may ask for “front kicks to the body”. However, a more advanced user can be presented content containing a cue of “I want you to throw every third kick to head height” with form-tracking discerning whether they follow the modification to the class correctly. The above examples illustrate how libraries of existing digital content can be personalized and enhanced with knowledge of a user's prior performance and progression or regression of the techniques to balance the challenge of the technique with the user's skill level.

In another example implementation, coaching intelligence system 600 can be configured to offer a video game like experience for controlling an avatar generated on user system 630. Unlike conventional video games in which the avatar is controlled by a controller, coaching intelligence system 600 can be configured to ingest movement recognition from human movement recognition system 200 and control the avatar according to the recognized movements performed by a user. As described above, human movement recognition system 200 can measure quality of technique, timing of technique, synchronization, speed, power, reaction time, which can be translated to an on-screen avatar or audio cue (e.g., sound effects). For example, spatial audio may place an audio cue in space around the user. The user can be instructed to perform techniques based on the direction from which the sound is emitted. For example, if the audio comes from the left, the user should kick to the left side.

Conventionally, a real-world coach or instructor may make observations about athletes' capabilities and challenges while they are warming up, or attempting to perform techniques. By noticing challenges within range of motion, balance, or particular movements, a real-world coach may focus the instruction, adjust the coaching cues, substitute techniques or adjust a lesson plan, or otherwise accommodate the student. Further, a coach may recommend particular drills, exercises, or stretches to address movement deficiencies that have been observed. Conventional fitness systems may provide movement screens to provide the above services, but these are an almost clinical experience in which someone is asked to move into a particular position, hold that position, and perhaps have attributes such as range of motion or difficulty subjectively or objectively measured for assessment. For example, for a conventional movement screen, an athlete may be asked to “drop to the bottom of an overhead squat” and hold that position. While the athlete is assumed to be in that position, joint angles may be measured, such as ankle, hip, or shoulder flexion. These measurements may be made by observation (qualitative) or by using a motion capture system such as a digital goniometer, motion capture suit, or computer vision techniques. The athlete will typically be asked to hold these positions for short periods of time to average measurements, and the athlete may be asked to hold the positions in several different exercises. This is typically a time-intensive process that feels clinical to a user, and is not best suited for a consumer or self-guided experience.

The embodiment disclosed herein can provide for an enhanced delivery of a functional movement screen powered by real-time movement recognition offered by human movement recognition system 200. For example, coaching intelligence system 600 may be configured for an assessment program that defines a functionality assessment to be performed on user movements. Human movement recognition system 200 can function to recognize an exercise being performed, and identify moments of interest at which measurements for functional assessment can be recorded. These moments may be referred to as assessment postures in the body object stream, which may be treated in a manner similar to key postures described above. The moments during the exercise to be used as assessment postures may be configured by coaching strategy configuration file 612 and provided to exercise datastore 218. At the recognition of a given assessment posture during an exercise, human movement recognition system 200 can be configured to take a snapshot of functionality measurements during a slice for an assessment posture using sensors 240. Over a set of exercises, human movement recognition system 200 can be configured to collect and report on results of individual assessment postures, averages/means of joint angles of interest, etc.

For example, a user may be instructed during what human movement recognition system 200 recognizes as a warm up to: “Let's warm up, starting with some gentle squats. Slowly and steadily, make sure each squat goes as deep as you can without your knees pushing in front of your toes”. During the warm up, human movement recognition system 200 can recognize a squat being performed and identify the assessment posture at the bottom of the squat (e.g., before knees pass toes) that constitutes a moment of measurement. Human movement recognition system 200 may silently snapshot measurements, such as but not limited to, ankle, hip, and shoulder flexion in any plane of movement, which can be provided as an exercise report to datastore 602.

Accordingly, coaching intelligence system 600 can be configured to provide benefits of a functional movement screen using human movement recognition system 200. By using the embodiments disclosed herein, the functional movement screen can be performed in reduced time in a more enjoyable and non-clinical, non-obtrusive environment. Furthermore, unlike conventional systems that assume but do not verify that the athlete is in the correct position, embodiments disclosed herein can disqualify measurements from repetitions that do not qualify as a performed technique, and report only the measurements from a good rep.

In another example implementation, coaching intelligence system 600 can be configured to instruct human movement recognition system 200 to collect measurements in situ while the athlete is working out, rather than as a standalone movement assessment program. For example, in a rowing class, ankle mobility can be movement screened by identifying the assessment postures in which the ankle is at maximum flexion for the front of the rowing stroke (“the catch”). At this moment, the maximum flexion angle may be measured. Similarly, hip flexion can be measured by identifying the interim moment in a good rowing stroke, where the legs remain flat, the arms are reaching for the rowing machine, and the athlete hinges at the hips. Human movement recognition system 200 can be configured to measure hip flexion when the user postures matches the assessment posture for this moment to snapshot, and coaching intelligence system 600 can use the measures to inform coaching and programming.

In an example application of a functional movement screen, coaching intelligence system 600 can be configured to provide for smart cooldowns or mobility programs. For example, based on observations collected during movement screens described above, specific exercises may be identified by human movement recognition system 200 that can address movement deficiencies and improve technique. As an illustrative example, if human movement recognition system 200 observes poor ankle flexion on a rowing machine, coaching intelligence system 600 may deliver a suggestion of particular calf stretches to be performed. Coaching intelligence system 600 can be configured with a collection of exercises (referred to herein as “Smart Stretches”) that the athlete may perform periodically to address a recognized mobility deficiency. The Smart Stretches may be recommended during a workout as active rests (e.g., “let's get off the rower for a few minutes rest, and work on some stretches that will help us”) or as a smart cooldown to be performed at the end of a workout (e.g., “while you were working out, coaching intelligence system 600 put together a cooldown that is designed just for you to improve your movement and technique”). In another example, the smart cooldown may be offered as a recommended workout for a following day, to drive engagement and habit.

In another example application of functional movement screen, the movement screening may have occurred in a physical class (such as in a boutique rowing studio) and the movement recommendations can be offered as an at-home mobility workout to be taken before the next class. This creates an experience that meets the customer in studio, then drives them to an at-home experience, which is designed to then drive them to a next in-studio experience. This is a particular use-case that can improve metrics such as attendance and retention for omnichannel fitness experiences.

In another example application of the functional movement screen, coaching intelligence system 600 can be configured to measure adherence to mobility programs as a means of driving engagement. For example, coaching intelligence system 600 can be configured to track whether the user executes the mobility program and tracks the number of times the user performs the program.

Coaching intelligence system 600 can be configured to track improvements by using human movement recognition system 200 to observe improvements in mobility, and correlate improvements in technique. In this way, coaching intelligence system 600 can draw a user's attention to the improvements and execution of the mobility program, thereby making the connection for the athlete which can drive further engagement and retention. For example, based on observing improvements that correlate to execution of the mobility plan, coaching intelligence system 600 can generate a cue stating: “You're getting more watts per stroke off the drive, because you're getting more compressed at the catch. That's testament to the calf stretches you've done 7 times in the last 3 weeks . . . way to work on your weaknesses and improve your scores!”

Coaching intelligence system 600 can be configured to facilitate customer acquisition and retention through use of mobility assessment programs. For example, a common myth when failing to start a desired fitness habit, is that the prospective athlete is not flexible enough. In an example implementation, mobility assessment programs can be configured in coaching strategy engine 608 and used as a customer acquisition strategy, as an explicit onboarding experience or disguised as an training experience. For example, coaching intelligence system 600 may instruct a user to “learn 3 basic yoga poses before your first class”, and while the user is performing movements to learn the poses, coaching intelligence system 600 executes a mobility assessment program. Based on the results, coaching intelligence system 600 can then introduce corrective exercises and assure the customer that the customer has the mobility or flexibility needed for class through execution of relevant movements.

In another example, mobility programs can be used in an at-home or in-studio environment of a connected omni-channel experience, for example, during a dynamic warm-up. In an illustrative example, an individual may be participating in a rowing class, either at-home via a connected device or in-studio, and human movement recognition system 200 observes that the individual has poor ankle mobility at the catch of a stroke. While the information can be communicated to the individual as explained above, the information about the ankle mobility can be communicated to a coach leading the class, along with a recommended intervention. The coach can address the individual recommending that “if she lowers her foot position one notch in the foot stretcher, she'll achieve the catch position more easily . . . and I'll give you a stretch at the end of the class to improve your ankle flexibility, which you'll also find in your recommended smart cooldown in your app”. This is an example implementation of a “SuperCoach” use-case where human movement recognition system 200 can be used to make observations about an athletes performance, and coaching intelligence system 600 can issue cues or recommendations, which can be delivered to a live coach (and/or the individual), who can deliver and explain the intervention.

In some implementations, content provided by coaching intelligence system 600 may be based on a specific mobility challenge of a user. For example, a good coach may select a different cue for different persons exhibiting different mobility challenges. As an illustrative example, an individual may exhibit poor shoulder mobility in a yoga class. Human movement recognition system 200 may have been used to recognize this mobility challenge and/or the mobility challenge may be configured via coaching strategy configuration file 612. Due to the challenge, the individual finds downward dog pose in yoga challenging and has difficult getting the ears between the arms. Knowing the above, for example, from a movement screen program, coaching intelligence system 600 can fetch content containing an appropriate cue for the individual, such as, “Moving into downward dog, rotate your hands on the mat so that the thumbs are forward, spreading your fingers apart”. This adjustment to hand position, is specific to helping the individual accommodate the shoulder immobility and the cue may be digitally delivered to the individual through a device associated with the user, or delivered as a “supercoach” experience in an omni-channel experience.

In an example implementation, mobility measurements may be stored in an athlete management system or datastore 616 associated with individual users. Coaching intelligence system 600 may access the coach engine 614 to retrieve relevant mobility restrictions for a given user, which coaching strategy engine 608 can use to instruct asset map engine 606 to fetch relevant data, as described above. In various embodiments, mobility measurements from human movement recognition system 200 can be converted into a domain specific format. For example, human movement recognition system 200 may provide mobility measurements in terms of a first system domain of joint angles, which coaching intelligence system 600 can be configured to convert the joint angles in the reference coordinate system into a second domain understandable by practitioners, such as flexion, extension, abduction, and adduction in particular planes of motion such as sagittal, frontal, and traverse planes. Conversely, datastore 616 may store mobility measurements in the second domain and coaching intelligence system 600 may convert the mobility measurements into the first domain for use by coaching intelligence system 600 and/or human movement recognition system 200. In another implementation, mobility measurements can be translated into insights. For example, rather than reporting knee flexion as raw numbers, human movement recognition system 200 can determine and coaching intelligence system 600 can report that “there is knee valgus at the bottom of the squat, as hip flexion exceeds x degrees in the sagittal plane”, or that “there is observed immobility in the t-spine during side windmill movement”.

Embodiments disclosed herein can provide for storing information on a user's performance as a training journal. In some embodiments, the training journal may be stored, for example, in asset management system 604 or datastore 616. Coaching intelligence system 600 can be configured to populate the training journal with information obtained during one or more movements performed by the user. The information may include, but is not limited to, improvements in user performance recognized by human movement recognition system 200, accomplishments achieved by the user as recognized by human movement recognition system 200, areas for future improvements identified by coaching intelligence system 600 based on observations by human movement recognition system 200, and recommendations of lessons, skills, drills, etc. that coaching intelligence system 600 could fetch from asset management system 604 based on movement recognition. The training journal may be analogous to a notebook of feedback that an athlete might receive from a coach.

Coaching intelligence system 600 can be configured to construct information necessary to populate the training journal, without distracting the user or requiring the user to manually enter the information. In an example implementation, the training journal information can be fetched and presented to a user during a workout, for example, during a rest between sets, in a transition from one part of a class to another, etc. The information contained in the training journal may be utilized in a manner similar to real-time cues for providing feedback to the user. In another implementation, the training journal information is fetched and presented (audio or video) at the end of a workout as a summary of the lesson with some key coaching points and areas of future focus. In another example, information from the training journal information can be delivered to a user post-class, for example, such as in an email, text, or on a companion website or application. The delivered information may function as an opportunity to engage the athlete from one session to the next. In another example, information from the training journal can be displayed at the start of a workout, before an athlete has selected a workout. In this example, rather than choosing a workout from a library based on instructor, duration, modality, or music style, observations from past performance can be leveraged by coaching intelligence system 600 to assist in selecting content for presentation. For example, coaching intelligence system 600 may ingest user progress and opportunities for improvement from the training journal, and obtain a limited set of workouts that the user can select from that are targeted to the prior observations. Thus, coaching intelligence system 600 can facilitate a “choose your own adventure” list with a fewer number of workouts to choose from, which can allow opportunity to build on the observations from the previous class.

Coaching intelligence system 600 can utilize the training journal to provide information that supports a positive approach to sports coaching. For example, coaching intelligence system 600 can be configured to present longitudinal improvement in a skill or technique over time, that has been previously recorded in a training journal. As an illustrative example, coaching intelligence system 600 can communicate content containing information, such as, “I can see your ankle mobility has improved over the last 3 weeks, and you're now organizing yourself excellently at the catch, composed and ready for your next stroke—great work”. As another example, coaching intelligence system 600 can be configured to discern the next most important thing for an athlete to focus on in future training sessions according to a configured coaching strategy. As an illustrative example, coaching intelligence system 600 may communicate content containing information such as, “Now, I really want to make sure you're conserving as much energy as possible in the recovery, by letting the erg do the work. We're really going to work on that arms, body, and legs sequence.” In yet another example, coaching intelligence system 600 can be configured to recommend content that can include classes, lessons, drills, or technique tips to address a focus task. As an illustrative example, coaching intelligence system 600 may communicate content containing information such as, “The Pause at Finish Drill is an excellent drill for breaking the stroke down, and working on that recovery sequence.”

In another example, coaching intelligence system 600 can be configured to facilitate post class feedback in omnichannel fitness environments. For example, a user may attend a group boxing class. While the user may not have received feedback directly from coaching intelligence system 600 during class, or they received feedback indirectly through a “SuperCoach”, observations of the user's form and practice during class can inform a post-class experience. For example, coaching intelligence system 600 can communicate congratulatory communications (e.g., email, SMS/MMS, etc.) that may acknowledge class attendance. The communication may also provide summarized information of performance such as, but not limited to, calories burned, heart rate zones, leaderboard scores, recommendations from a training journal, etc. In another example, congratulatory communications and/or summary information may be pushed as notifications to a companion mobile app for at-home practice.

Embodiments disclosed herein of the training journal experience may be well suited to the delivery of performance measures powered by motion recognition according to embodiments disclosed herein, without changes to existing libraries of digital content. For example, a mobile smartphone or similarly enabled sensor device may run a companion application (e.g., client application 132) that can be used to tracks posture and form as raw data, and deliver this information to coaching intelligence system 600 for the formulation of a training journal. Furthermore, in the case of connected fitness equipment, a companion application running on a smartphone or similar device may pair with the Connected Fitness equipment, such that there is 2-way communication or synchronization of the capture and the content. Pairing may be achieved through known wireless communication protocols such as, but not limited to, Bluetooth® or Wi-fi. In another example, paring may be achieved through dual authentication of a user on each device with a common login/password combination, or using techniques such as a shared pairing code between the two devices.

In an example implementation, training journals according to the embodiments disclosed herein can be used to facilitate cross-sell recommendations. For example, a company may sell a connected mirror, connected rower, and a connected kettlebell. Coaching intelligence system 600 may recognize that a user is using one piece of connected equipment, for example the connected rower, and utilize the training journal to recommend exercises targeted at improving rowing performance and technique, but that require the user to use the connected kettlebell. In another example, a fitness or gym operator may own sub studios such as a yoga studio, a Pilates studio, a boxing studio, a stretching studio, etc. The training journal may be leveraged by coaching intelligence system 600 to recommend a free stretching class to encourage the consumer to discover a new modality, based on observations from a yoga class the user participated in. This implementation may then provide for an increase in membership tiers. In another implementation, the training journal may be used by coaching intelligence system 600 to reward a personal best or partner challenge in a first type of class (e.g., group boxing class as an example), with a complementary second type of class (e.g., a yoga class for example), by recommending and unlocking a companion onboarding experience as an on-ramp to the recommended second class.

Embodiments disclosed herein can provide for a student and teacher interaction that minimizes the need for direct interaction with physical controllers through application of coaching intelligence system 600 powered by human movement recognition system 200. The interaction can be enhanced with natural interleaving of voice with the movement recognition disclosed herein. Coaching intelligence system 600 can be configured to use real-time natural speech generation algorithm to allow for personalized instruction, which can be generated and communicated to the user in real-time. In an example implementation, text-to-speech can comprise pre-written text reflecting language and terminology that a specific coach is known to use or favor, such as preferred coaching cues or descriptions of how to perform a technique. Such cues can be stored in asset management system 604 for fetching by asset map engine 606. Coaching intelligence system 600 engine passes this text through a text to speech synthesizer 618 in real-time to generate human-like speech using a synthetic voice, which can be presented via user system(s) 630.

In another example, coaching intelligence system 600 can be configured to pass the text to speech synthesizer 618, which can be trained to enunciate and sound like the specific coach, for example, by training a speech model on recordings of the specific coach's voice. In one example, an athlete may be following a soccer training program by Scottish football coaching legend Sir Alex Ferguson. When the athlete makes an innocent mistake, coaching intelligence system 600 may fetch textual content corresponding language and verbiage preferential to Sir Alex Ferguson (e.g., yelling at the athlete by name). The speech synthesizer 618 may enunciate the text so as to sounds as though indistinguishable from Sir Alex Ferguson's voice. Thus, the athlete can experience what it would be like to be coached by Sir Alex Ferguson.

In yet another example implementation, coaching intelligence system 600 can be configured to fetch text that is generated using a language model trained on a large data set of coaching instructions from a specific coach and pass the text to speech synthesizer 618. For example, coaching intelligence system 600 may hold hundreds of hours of instructions, questions, and answer sessions on rowing training and rowing technique with former Olympian Eric Murray. A language model can be trained on the transcripts of this data set, which creates a knowledge base of rowing coaching based on Eric Murray's insights. When the human movement recognition system 200 recognizes an athlete performing a mistake, this mistake can be formulated by coaching intelligence system 600 as a query to the language model, and the response can be passed through the text-to-speech engine to generate personalized coaching feedback that is conversational in nature.

In another example implementation, coaching intelligence system 600 can be configured to initiate conversations with an athlete and ask questions for a personalized experience. Such implementations may be useful when a user wishes to know something about the equipment they are using or to tailor and adjust the coaching being offered. For example, a user may wish to know what weight an athlete is using for an exercise. Coaching intelligence system 600 can initiate a speech conversation with the user, and drive a conversation based on the answer. In this case, coaching intelligence system 600 may fetch data from asset management system 604 and apply speech synthesizer 618 to ask a user, “What weight are you using?”. The user may respond, “It's a 20 lb. kettlebell”, and coaching intelligence system 600 may inquire, “Do you have anything a little lighter?”. If the answer to that question is no, coaching intelligence system 600 may then communicate, “Ok, then let's aim for 8 reps instead of 12, focusing on hinging at the hips.” Coaching intelligence system 600 can log the weight used based on the voice interaction for each rep performed in the training journal.

In another example, users may initiate conversations about the performance of their technique. For example, the user may ask, “Am I doing this right?”, and coaching intelligence system 600 may respond with, “Let me see you do 5, and we'll give you something to focus on”. As another example, the user may ask, “Can you teach this to me again,” to which coaching intelligence system 600 may initiate a guided learning program.

In another implementation, a coach can initiate a conversation where movement recognition is failing. Often, movement recognition can fail because the athlete stops or is tired and exhibiting lackluster form that doesn't meet the lowest common denominator. This can cause the coach to initiate a voice conversation/intervention that can reinforce the movement recognition with contextual voice interaction and instructions

In another example implementation, human movement recognition system 200 can recognize when someone gets stuck on what they should do next, as described above. Recognizing when someone is stuck for a determined amount of time between postures in a technique or exercise, coaching intelligence system 600 can interject using the speech synthesizer 618 to provide a cue that unsticks the athlete.

In another example, human movement recognition system 200 can recognize when someone is no longer attempting the exercise, for example when the user is interrupted to answer the phone or take a drink of water. Coaching intelligence system 600 can use speech synthesizer 618 in this example to initiate a conversation to note the change of context, without a need for the user to use a pause or restart button. For example, Coaching intelligence system 600 may communicate, “Do you need a few moments?”, and the user may say “Yes?”. Coaching intelligence system 600 can respond, for example, with, “Tell me when you're ready and we'll finish our set, or let me know if you want to stop completely”

In another example related to positive coaching, coaching intelligence system 600 can initiate a conversation when form correction identifies a fault by communicating an inquire such as “How does that feel?”. Following an answer by the user, coaching intelligence system 600 can offer a suggestion to correct the fault. As human movement recognition system 200 observes the form correction, the conversation can proceed with positive reinforcement cues such as coaching intelligence system 600 communicating, “Right there . . . did you feel your weight shift from your ball of your foot through your midsole to your heel”. The user can respond with, “Yes,” and coaching intelligence system 600 can conclude for example, “Great correction . . . remember that feeling, heavy heels”. In this example conversation, voice interaction is used to initiate positive coaching and kinesthetic learning, where the coaching strategy focuses on how the technique feels to the user, not how it looks. The initial communication may be triggered by human movement recognition system 200 observing an error in form that causes the inquiry into how the technique feels.

In a further example, voice recognition can be used as an additional signal for rep counting. In certain situations where performance of the movement recognition may be impeded, such as due to the speed of movement or by lighting conditions, coaching intelligence system 600 can suggest that the athlete count reps out load so that coaching intelligence system 600 can track performance and verbally inform coaching intelligence system 600 that the set is completed. This allows voice recognition to be used as a sensor fusion technique to address degradation of movement recognition, if any.

While the foregoing provided numerous specific examples of using voice recognition and synthesizing techniques to provide cues from coaching intelligence system 600, the embodiments disclosed herein are not limited to only the above examples. Coaching intelligence system 600 can be configured to provide for verbal interaction from beginning to end of a workout, without requiring screen presses or interaction with a physical device.

Embodiments disclosed herein can be used in an at-home environment, as a well as in brick and mortar facilities, such as training facilities, gyms, health clubs, boutique fitness studios, boxing studios, rowing studios, yoga studios, etc. Collectively these facilities are referred to herein as “connected gyms”. Embodiments disclosed herein can provide at-home experiences that can be used to elevate the experience delivered by an in-studio experience at connected gyms. Additionally, embodiments disclosed herein can provide an in-studio experiences that is elevated by real-time human movement recognition of multiple individuals in the studio. Furthermore, embodiments disclosed herein can provide in-studio observations that can be used to drive at-home experiences informed by earlier practice, such as in-studio. Accordingly, the embodiments disclosed herein provide for personalization of omnichannel fitness experiences that seamlessly move a customer along a journey that involves a blend of practice at-home and in-studio at connected gym, in one or more studios or modalities. Omnichannel may refer to an operator who operators a brick and mortar facility and a digital offering for use remote from the brick and mortar facility. An illustrative example of an omnichannel fitness experience may be a local yoga studio that people can attend an in-person class, which also offers a remote or at-home work out program using live or on-demand classes through an application executed on a user system. In this case, the in-person and remote experiences may be seamlessly integrated.

Connected gyms can comprise multiple mechanisms for collecting raw data that can be used for human movement recognition of multiple individuals in the room. In one example, a number of stations may be provided about a capture volume of a studio. Each station may be spaced apart, and each station comprise one or more sensors configured for collecting raw data for a single person. For example, a station may comprise a connected apparel product having sensors affixed thereto, a camera incorporated into connected fitness equipment (e.g., spin bike or like) may be provided at each station, a tablet or smart device may be mounted near a connected fitness equipment, a user system (e.g., smartphone) may be removable attached to connected fitness equipment, etc. In any case, each station is configured to collect raw data from which human movement recognition can be performed and associated with each user, for example, through a user ID. In another example, human movement recognition is performed on every individual in a capture volume at once, using an array of sensors affixed about the capture volume that collect raw data of multiple individuals at once.

In some implementations, an individual may be constrained to a single piece of connected equipment (such as being assigned a bike or rowing machine) for the duration of the workout. In other implementations, an individual may be tracked and followed as they move around the capture volume. Tracking may be performed using computer vision technology, with methods including bone length analysis, facial recognition, color heuristics of the clothing they are wearing, and other visual cues that combined create a “unique signature” for each person in the room. In another example, tracking may be performed by generating a bounding box around each user and following the bounding box as each person moves around the capture volume. In another example, a radio beacon or similar radio frequency emitting device, such as RFID on a phone, in a badge, dongle, clothing, etc., can provide insight into who is in which part of a capture volume, or using what equipment. Collectively, these “athlete identification” technologies can provide for distinguishing between individuals to facilitate recognizing human movement of discrete individuals in a multi-person environment.

In some implementations, the ability to track multiple persons may be used to provide human movement recognition of two or more persons in a capture volume. For example, sensors as described above may collect raw data of each person, and tag raw data with a unique ID associated with each user (along with timestamps as described above). Thus, raw data can be associated with each individual in the capture volume. From the raw data, human movement recognition system 200 may be used to perform human recognition for each individual, as described above. Human movement recognition system 200 may perform human movement recognition for each person simultaneously, sequentially, or at random. Recognized postures and movements can be tagged with the unique ID associated with the user, which can be used by coaching intelligence system 600 to provide insights and recommendations on a user by user basis (or as a class depending on the application). In another example implementation, the above described capability may be used to isolate an individual from a crowd, and prevent the appearance of other individuals in the capture volume from affecting the quality of human movement recognition of the isolated individual.

Human movement recognition system 200 for each individual can be executed on the same network or different networks. In one example, raw data from sensors may be streamed to a user system on a person, such as a smartphone or smart watch. In another example, the raw data can be streamed to connected fitness equipment a person is using, such as a local connected mirror or spin bike. And in yet another example, the raw data can be streamed to a central server, which can be hosted either on-premise or in a cloud computing environment.

In an example implementation of a connected gym scenario, a connected gym can offer human movement recognition for an individual through its brick and mortar facility as well as in a remote environment, such as at-home. For example, a connected gym may allow participants to enjoy a solo experience, powered by human movement recognition system 200, without the need for connected apparel or their own smartphone by offering one or more sensors that can collect raw data for the human movement recognition. The solo user may authenticate themselves or otherwise log into a motion capture system in the gym or studio. The motion capture system of the connected gym may collect raw data of the user as they perform movements and move about the gym. In an example implementation, a user's own device can assist with collecting raw data and tracking movement about the gym, from location to location. In this implementation, several individuals in the same facility may be following a common program, each completely independent of the other, but using a common motion capture system.

In another implementation, such as a group fitness class, an entire class may be tracked as everyone participates in the same workout for human movement recognition. For example, in a rowing class, raw data may be collected on each member of class for human movement recognition as they follow the same workout being led by an instructor, either in-person or streamed into the class from a remote location. These members can experience personalization of their group workout through above described capabilities human movement recognition system 200 and/or coaching intelligence system 600.

In another example implementation, a single class can be broken down into stations where members can take turns on different pieces of equipment. For example, in a High Intensity Interval Training (HIIT) class, members may take turns moving from treadmills, to rowing machines, to floor exercises in rotation. In this scenario, human movement recognition system 200 can function to track individuals as they move from station to station and collect raw data for each individual. Coaching intelligence system 600 can function to provide individualized coaching cues and feedback, as described above, contextual to the equipment and/or exercises they are performing. Coaching intelligence system 600 may function to accumulate each individual's results across multiple pieces of equipment.

In yet another implementation, members may be grouped into teams, for example, team-based workouts similar to those described above. For example, in an in-person rowing studio for instance, a class may be split into teams of 8, 4, 2, etc. representing “boats” and synchronization of their performance can be used to impact a team score, as described above. In a HIIT class, individuals may be grouped into pairs, where a previously solo leaderboard experience can be become a team score, with pairs versus pairs, half the class versus the other half of the class, or pitting one studio against another studio in a different location.

At-home participants can join synchronously with in-studio participants, so to follow a common workout at the same-time. For example, using at home equipment and motion capture systems, human movement recognition system 200 can be used to perform recognitions of an at-home user and coaching intelligence system 600 and add the at-home users results to the in-studio users results to synchronize the experience.

Leaderboards with metrics pertaining to biometrics such as heart-rate, or output metrics such as watts from a bike or ergometer/rowing machine can be displayed for a group fitness class, either in-studio or on an at-home user system. Coaching intelligence system 600 can supplement these metrics with additional biomechanics (such as rep count, quality, range of motion, performance measures, scores, and others disclosed herein) through the information channel. For example, biometrics noted above can be aligned with metrics related to the recognition of exercises, tabulating the performance of exercises at an individual and or group/team level. For example, metrics may be recognizing count of exercises that meet an individual or group standard; score based on qualities such as, but not limited to, a degree of correctness of a movement, a range of motion of a movement (such as depth of a squat, or height of a kick), a coordination of a movement through individual postures or poses so as to demonstrate correct technique, a consistency of execution such as streaks of correct movement, a synchronization of the movement with another individual or individuals (such as an in-person or on-screen instructor, a partner, or a collection of team-members), among others. Metrics may be available in real-time for display in-studio, on a website or server in real-time, in a companion application or dedicated hardware such as an at-home rowing machine, where such application or hardware is being viewed by either a participant or spectator of a class or workout, to name a few examples.

Coaching intelligence system 600 can also be configured to provide programs that can be unique to a connected gym. For example, coaching intelligence system 600 can be configured with a group warmup program. In this case, as each individual warms up, either in a series of predefined warmup exercises or in the initial stages of a class, human movement recognition system 200 can perform a movement mobility screen on each individual looking for improvements or deteriorations that can be used to adjust the practice each individual undertakes in the ensuing class. In another example, observations from the group warmup program, or from mobility screening throughout a class, may inform recommended cool down exercises or post-workout exercises that can be communicated by coaching intelligence system 600 to individuals.

Coaching intelligence system 600 can also be configured to provide a technical warmup program as distinct from a warmup intended to get blood flowing and heart rate elevated. A technical warmup may serve as an opportunity for members of the class to practice some technical skills or drills leading into the class. Human movement recognition system 200 can observe members as they follow a technical warm up. In an example, coaching intelligence system 600 can provide coaching and corrective cues to athletes individually (personalizing the group experience) with digital intervention through multimedia content. In another example, coaching intelligence system 600 can direct a coach in the studio to a member requiring attention and provide insight into the reason for intervention, along with a recommendation for the intervention or coaching to provide (e.g., SuperCoach implementation). Content can be communicated via a class dashboard, routed to an audio headset the coach is wearing, or routed to wrist worn device such as a smart watch.

In another implementation, coaching intelligence system 600 can be configured to personalize a class based on observation of one or more individuals in the class. For example, human movement recognition system 200 may observe progressions and/or regressions in techniques and coaching intelligence system 600 can recommend alternative exercises based on the observations. Recommendations maybe may on a class basis and/or individual basis. In an example, coaching intelligence system 600 may recommend an individualized cool down for an individual at the end of a workout, or a particular stretch during an active rest, to address a specific mobility challenge, regression, or progression. To further personalize this experience, coaching intelligence system 600 may communicate a reasoning to the entire class as to why a recommendation was made.

In another example implementation, in a group class, coaching intelligence system 600 may design a cool down for an entire class that is designed to address common movement and mobility challenges observed by human movement recognition system 200 in the aggregate. The coach can be informed by coaching intelligence system 600 how to explain the cool down to the class, for example, “the human movement recognition system is observing that a large number of us could work on our ankle flexion, so here's a stretch we're all going to do together.”

The SuperCoach feature described above can be provided to allow a coach on the floor to deliver personalized instruction of a level that might be expected if there were more coaches on the floor. Through the SuperCoach functionality, coaching intelligence system 600 can function as an “assistant” coach capable of watching every athlete at once, directing a coaches attention towards the students that need the most help, directing teaching and coaching points for the group towards coaching points that would be applicable to a collection of members, etc. Furthermore, the “SuperCoach” functionality can be used to allow an organization to ensure that coaching is being delivered according to best-practices for the organization, by augmenting the real-world coach with “extra eyes” and an encyclopedic knowledge of the coaching strategies.

In connected gyms where members may workout independent of each other, personal trainers may be present on the gym floor or in offices, where they are underutilized as a resource. In an example implementation, human movement recognition system 200 can be configured to recognize that a member could use correction or guidance for a particular modality or exercise that they are practicing. Coaching intelligence system 600 can then either recommend corrective cues or communicate with an underutilized resource to request assistance for the member. In another example, human movement recognition system 200 may recognize an opportunity to progress and teach a member a new skill and coaching intelligence system 600 can function as a broker between member and personal trainer.

In an illustrative example, Diana may be practicing on a gym floor. Diana is using kettlebells. Human movement recognition system 200 may observe that Diana is performing errors in executing single arm kettlebell swings, and coaching intelligence system 600 determines that Diana may benefit from coaching on the single arm kettlebell swing. In one case, a trainer on the floor can be notified by coaching intelligence system 600 that Diana needs coaching and direct the trainer towards Diana, opening the opportunity for a coaching session/correction. In another case, Diana could be notified by coaching intelligence system 600 that she would benefit from coaching, and that a trainer is available either immediately, or later in her practice, to give her some coaching points. In yet another example, human movement recognition system 200 may observer that Diana shows a level of progression and accomplishment, and coaching intelligence system 600 unlocks an opportunity for a personal training session that will take her practice to the next level by introducing her to new skills or exercises that move her forward in her practice.

According to various embodiments, coaching intelligence system 600 may hold knowledge and expertise about how an athlete is performing (e.g., in a training journal) that is applicable as they move from one exercise/modality to another. For example, human movement recognition system 200 may observe an athlete who warms up, then moves to a rowing machine for 15 minutes of cardio, and then moves to a TRX station to workout using a suspension trainer. Finally, human movement recognition system 200 observers that the athlete moves to a connected fitness product such as a connected boxing bag. While each of these modalities are disconnected and discrete experiences, coaching intelligence system 600 is able to provide context and continuity as the athlete moves from one product to the next through human movement recognition executed by human movement recognition system 200. The notion of information about their practice and performance that is discerned by observing and understanding movements on every piece of equipment, can provide for tailoring and personalization of the experience by coaching intelligence system 600. The data for a given user can be tracked across different pieces of equipment and locations and stored as an “athlete passport” that can be held, for example, in asset management system 604 or datastore 616.

In an illustrative example, a smart warmup program executed by coaching intelligence system 600 may reveal a mobility deficiency that leads to a recommendation, by coaching intelligence system 600, on a rowing machine to adjust the position of the foot stretcher. While rowing, sub optimal power output in the stroke might be observed by human movement recognition system 200, which triggers a suggestion by coaching intelligence system 600 of a need for dynamic leg strengthening exercises. When the member approaches the TRX, coaching intelligence system 600 may recommended the user perform “Single Leg Plyo Squats” or “TRX Skaters” with an explanation of “so that we can improve the power we just saw in your rowing stroke”. Even as a member moves between in-gym or at-home practice, or moves between physical locations, their “Athlete Passport” can be accessed with them, allowing contextual personalization of the content delivered to them.

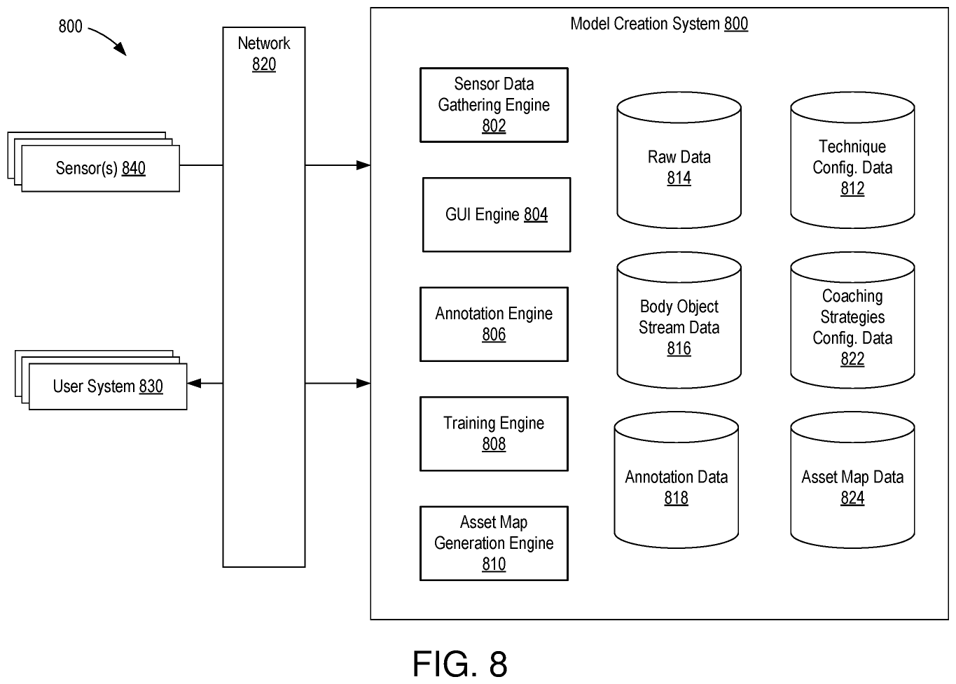

FIG. 8 is a schematic block diagram of an example model creation system 800 in accordance an embodiments of the present disclosure. Model creation system 800 may be an example implementation of model creation system 118, described above in connection with FIG. 1. Model creation system 800 can function to create information and definitions for configuring the human movement recognition system 200 and/or coaching intelligence system 600. Model creation system 800 may provide an interface from which a coach or instructor can define aspects that are executed by the human movement recognition system 200 and/or coaching intelligence system 600, such as but not limited to, techniques, exercises, sequence movements, nuance movements, comparators, traits, as well as asset maps and coaching strategies including exercises programs, as detailed above. Model creation system 800 can be implemented to create any configuration file as needed for defining the various parameters of human movement recognition system 200 and/or coaching intelligence system 600 for performing the above-described functionality and processes.

FIG. 8 depicts model creation system 800 communicable coupled to user system(s) 830. In one example, model creation system 800 may be coupled to sensors via a network 120 (as shown in FIG. 1), while in another example, model creation system 800 may be executed on a device on which sensors 840 are installed. User system(s) 830 may be substantially similar to user system(s) 130.

Model creation system 800 can be utilized to define coaching strategies, asset maps, and known movements for storage in the technique dictionary. For example, model creation system 800 may be utilized to populate a coaching strategy configuration file 612 or asset map configuration file 610, described above in connection with FIG. 6. As described above, intelligence of coaching intelligence system 600 can be defined by configuration files 610 rather than code, so coaching intelligence system 600 can be programed for coaching and content presentation strategies, without coding knowledge. Further, the use of configuration files allows development teams to render a dynamic personalized real-time experience without any need to understand the underlying coaching strategies or content to deliver them. Conventionally, fitness applications relied on hard coding of strategies and content presentation into an application, which minimized configurability and flexibility for effectuating specific coaching strategies. By moving these strategies into highly customizable configuration files, the coaching intelligence system 600 can be configured for user-friendly tooling that enables easy configurability without any coding knowledge, and without having to redeploy applications. Accordingly, for an application developer, there is very little coding required to drive the end user-experience and the code that is required, does not require domain knowledge of the sport, fitness modality or exercise that is to be performed, or how that exercise might be performed. Model creation system 800 provides tools that can be used by exercise scientists, movement specialists, coaches, and content teams, to easily populate configuration files that drive the coaching intelligence system 600.

Model creation system 800 comprises a sensor data gathering engine 802, UI engine 804, an annotation engine 806, a training engine 808, and an asset map generation engine 810. Model creation system 800 also comprises an raw data datastore 814, a body object datastore 816, an annotation datastore 818, a technique recognition configuration datastore 812, a coaching strategies configuration datastore 822, and an asset map configuration datastore 824. In an example implementation, UI engine 804 can function to generate a visualization of raw data, for example, in the case of raw data collected by a camera raw data may be presented as a video of movements performed by a human captured by the camera. In another example, UI engine 804 can function to generate a visualization of the body object stream, for example, as an avatar displayed on a screen that performs the postures of the body object stream. In an illustrative example, the avatar may be a 3D avatar and UI engine 804 may provide for 3D viewing of the avatar from any angle and level of zoom. Additionally, UI engine 804 can receive inputs to move progress or rewind the avatar (or raw data) in time through fast forwarding and/or rewinding functionality.

The sensor data gathering engine 802 can function to gather raw data collected by from sensors 840 (sometimes referred to herein as raw training data). For example, sensors 840 may collect raw that can be held in raw data datastore 814 and/or obtain raw data directly from sensors 840. Sensor data gathering engine 802 may be substantially similar to sensor data gathering engine 202 of FIG. 2. In some implementations, sensor data gathering engine 802 and sensor data gathering engine 202 may a common module executed by model creation system 800 or human movement recognition system 200 depending on the desired implementation.

Raw data can be made available to human movement recognition system 200 for performing human movement recognition on the raw data. For example, sensor data gathering engine 802 can forward raw data directly to human movement recognition system 200. In another example, sensor data gathering engine 802 can store raw data in raw data datastore 814, which can be accessed by human movement recognition system 200. Human movement recognition system 200 can function to detect a series of postures from the raw data, as described above. Thus, using the stream of raw data, human movement recognition system 200 generates a body object stream comprising a plurality of postures provided as model representations for each slice of the raw data stream. As described above, each model representations are constructed of a number of body object segments, each of which includes one or more segments and a quaternion node defining position, orientation, and heading direction (if any). The body object stream (which may be referred to herein as a training body object stream) can be stored, for example, in body object datastore 816 for use by model creation system 800. Each body object stream may be tagged with a unique ID for use in tracking data associated with the body object stream. The body object stream and the raw data may be collectively referred to herein as “Capture Files”.

GUI engine 804 can function to generate a UI that can be executed on a user system 830, for example, by a companion application or web browser running on the user system 830. UI engine 804 can be used by the user system to provide user inputs to model creation system 800 and/or interface with sensors installed on the user system 830. UI engine 804 can function to generate a plurality of visualizations, for example, as screens, that can be displayed on the user system 830. A user may interact with the visualizations (e.g., through conventional mouse/keyboard inputs, gestures, voice command, etc.) to input commands into model creation system 800 for creating configuration files.

Annotation engine 806 can function to generate annotations for one or more slices of a given body object stream. For example, annotation engine 806 can obtain a model representation of a posture for a slice of the body object stream and generate one or more annotations that define proper or ideal execution of the posture. For example, annotation can include descriptions and/or thresholds for positions of body object segments in executing a posture correctly. Annotations of a move can include terms that define a posture of the move, such as angles and orientations of limbs, back, joints, speed, acceleration, torque, momentum, steadiness, stillness, smoothness of motion, etc. in correctly executing the move. Annotation engine 806 can also function to create annotations for the body object stream, for example, by creating annotations between two or more postures of the body object stream. Such annotations may describe how one would ideally transition from one posture to the next. For example, in transitioning from upright posture to maximum depth posture of a squat, an annotation may be to bend legs by 100 degrees, and lower their torso 1 foot in performing). Annotation engine 806 can also function to tag one or more slices of the body object stream as a key postures of a sequence movement and/or nuance movement. In various implementations, the annotation engine 806 can add timestamps to annotations for correlating annotations with slices of the body object data. Annotation engine 806 can also tag annotations with a body object stream ID and in some embodiments a unique ID for the body object segment for which the annotation is associated.

In an example implementation, user input received via UI engine 804 can be used by annotation engine 806 to create annotations. For example, a user can annotate slices of a body object stream with information about a technique (or exercise) that is necessary to teach the technique (or exercise). In an example implementation, UI engine 804 may function to present a body object stream in the form of an avatar, which the user can manipulate and annotate. Through UI engine 804 the user tag individual slices or a sequence of slices of the body object stream that represent key posture of a sequence movement, including a starting posture and ending posture, along with any intermediate postures desired. A user may also annotate slices with comments, provided as a voice input, video upload or textual comments, describing what is expected to be observed in a posture to deem this posture as a lowest common denominator (e.g., key postures) and/or an ideal execution in the case of nuance movements. As an illustrative example, the user may say “I am looking for the feet shoulder width apart, legs straight, hands on hips with the body upright and facing forward”, which annotation engine 806 can convert to text via a speech-to-text translator for storage as an annotation or stored as an audio file. In another example, a user can input comments on slices describing mistakes they would like train the system to look out for. For example, a user can input a comment such as “Make sure the feet aren't wider than the shoulders” or “Make sure the person doesn't push their hips forward, I want to see shoulders above the hips not behind the hips,” which annotation engine 806 can store as an annotation.

In an example implementations, annotations may be generated based on artificial intelligence (AI) and machine learning algorithms configured to convert natural spoken language into code that can be used as a configuration file (or part thereof). For example, annotation engine 806 and/or training engine 808 may comprise a speech synthesizer configured to convert speech to machine readable text, which an AI bot can ingest and interpret for generating an annotation according to the spoken language. In an illustrative example, a coach nay say in natural language, while a body object is provided via the UI engine 804, “in this pose, I'm looking for feet shoulder width, with arms extended straight in front, finger tips at shoulder level” and an large language model or generative AI system (e.g., AI bot) trained on a large library of comments and/or annotations and the underlying configuration code utilized by model creation system 800, ingests the spoken language and generates comparators, nuance movements, postures, and sequence movements necessary for the technique automatically using a generative pre-trained transformer as a programming assistant. Examples of the AI system includes, but are not limited to, GitHub Copilot and the like.

Training engine 808 can function to create training on how to recognize a technique (or exercise), which can be stored in technique recognition configuration datastore 812 (e.g., in the technique dictionary). Training engine 808 can generate training using a body object stream of a performed technique (or exercise) and annotations of the body object segment. For example, training engine 808 can obtain a body object stream from body object datastore 816 and associated annotations from annotation engine 806 using the body object stream ID and/or a body object ID. Training engine 808 can use the information to generate training data that can be used to inform human movement recognition system 200 on how to recognize a technique (or exercise) using annotations and how to measure the performance. In some embodiments, training engine 808 can function to ingest annotations and generate comparators for each posture.

In an example implementation, UI engine 804 may function to present a body object stream in the form of an avatar along with a presentation of one or more annotations (e.g., a drop down menu, listing, etc.), which a user can manipulate to input training data. In another example, UI engine 804 may display the raw data (such as a video) along with annotations. In some cases, the raw data and avatar may be presented simultaneously (e.g., side by side, picture in picture, overlaid, etc.). In an example implementation, an individual can manipulate the avatar and access annotations through UI engine 804. Using UI engine 804 the user can define configurations and edit the annotation. For example, the user may define postures, movements, sequence movements, techniques, exercises, nuances movements and other elements model creation system 800 can use as training data for recognizing a technique (or exercise). Training engine 808 can define an ordered list of comparators for each tag posture. In one example, user input can be used to define the order. In another example, training engine 808 can define the order through recognition of a time sequence of postures and movements.

In another implementation, training engine 808 can function to provide for testing and/or de-bugging of a training data. Training engine 808 can execute the capture files so to display the body object stream (e.g., as an avatar of the model representation) and raw data (e.g., a video) simultaneously. Training engine 808 can also execute technique recognition configuration data for the body object stream. Training engine 808 can then function to use human movement recognition system 200 to perform human movement recognition on the raw data using technique recognition configuration data, and compare the recognition against the avatar, while reviewing annotations. In some examples, the UI engine 804 can be used by the user to pause, change a playback speed, rewind, and forward wind the raw data in tandem with the avatar, to review annotations. For example, a user can review various postures and annotations related thereto, such as comparators and nuances, to further fine tune the recognition training. In this way, the technique recognition data stored in technique recognition configuration datastore 812 can be updated to provide improved recognition.

Training engine 808 can also function to generate coaching strategy configuration data, which can be stored in coaching strategies configuration datastore 822. For example, using the UI engine 804, a user may input various exercises and/or techniques according to a desired exercise routine and/or coaching strategy. Exercise and/or techniques may be provided in an ordered list or an unordered listing (e.g., in the case of free practice). Training engine 808 can receive the listing of exercises/techniques (order or not) to technique recognition data from technique recognition configuration datastore 812. In the case of an exercise, the exercise can be broken down into the individual techniques, which can be used to obtain technique recognition data. In another example, technique recognition data may be created using an exercise, which training engine 808 can obtain. Using the obtained technique data, training engine 808 can construct a coaching strategy configuration file by populating the file with technique recognition data according to the techniques/exercises input by the user.

In some implementations, training engine 808 can function to parametrize a coaching strategy for populating the coaching strategy configuration file. For example, a user may input annotations on nuance movements to focus on during a specific coaching strategy. Nuance movements may be ordered according to importance dependent on the particular coaching strategy as well. Furthermore, a user can input success and fail stop criteria, through manipulation of the UI engine 804, for example, though interaction with the avatar. In another example, a user can use the UI engine 804 to define an exercise routing or program, as well as to condition coaching cues as desired. For example, a user may input a number of allowances for a given mistake, as well as indicate whether or not to look for consecutive mistakes (e.g., “only correct this mistake the 3rd time you see it”, or “Correct this mistake if it happens 4 times in a row”. Training engine 808 can take in the various annotation data and populate the coaching strategy configuration file, thereby defining a particular coaching strategy.

Model creation system 800 can then export the coaching strategy configuration file for use in human movement recognition. For example, coaching intelligence system 600 may request a coaching strategy configuration file from model creation system 800 for a run-time execution, which model creation system 800 exports an instance of coaching strategy configuration file 612.

Asset map generation engine 810 can function to generate an asset map configuration file, which can be stored in asset map configuration datastore 824. In an illustrative example, the asset map configuration file may be provided as a look up table of conditions for fetching content, for example, from an asset management system (e.g., asset management system 604). In some implementations, the asset map comprises references to results of recognizing nuances movements, sequence movements, measures of performance and/or coaching strategies associated with algorithms for performing calculations to locate associated multimedia content. In an example implementation, the asset map comprises programming language to calculate an output (e.g., content) from a given input (e.g., results from human movement recognition system 200 and/or coaching intelligence system 600). For example, the asset map can comprise descriptive language that can function to convert input JavaScript Object Notation (JSON) objects into output JSON objects. As described above, the asset map configuration file may contain aspects of movements, such as errors, that can be associated with certain multimedia content for commenting on the aspect (e.g., correcting the error). The asset map configuration file can be populated with conditions associated with content. For example, threshold numbers of instances that a certain aspect is observed for a piece of content. Different types of content may be associated with the same aspect according to different thresholds. As another example, threshold performance measures can be associated with content, for example, performance below a certain threshold may be associated with corrective content while performance above another threshold may be associated with congratulatory content. Various other examples of associations are described above in connection with FIG. 6.

In an illustrative example, a user (such as a content team and/or a coaching team) can use UI engine 804 to input commands that asset map generation engine 810 can ingest to define the mappings and rules for the asset map configuration file. Thus, users can easily create mappings of content to conditions while the coaching strategy configuration drive the conditions for selecting content to ensure content is presented in real-time and at the right time.

Model creation system 800 can then export the asset map configuration file for use in human movement recognition. For example, coaching intelligence system 600 may request an asset map configuration file from model creation system 800 for a run-time execution, which model creation system 800 exports as an instance of asset map configuration file 610.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up infrastructure 100 of FIG. 1, human movement recognition system 200 of FIG. 2, coaching intelligence system 600 of FIG. 6, and/or model creation system 800 of FIG. 8. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904. Processes and functionality described above in connection with FIGS. 1-8 may be stored in main memory 908, as instructions that may processor 904 may fetch, decode, and execute to perform and/or control the processes and functionality described herein.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects, and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An method comprising:
obtaining a raw sensor data stream associated with one or more movements executed by a moving body;
generating a body object data stream from the raw sensor data stream, the body object data stream comprising a plurality of model representations of postures indicative of the one or more movements;
determining one or more techniques corresponding to the one or more movements executed by the moving body by comparing at least one first model representation of the body object data stream to one or more reference postures corresponding to a plurality of techniques defined in a technique dictionary; and
assessing a performance in executing the one or more techniques by comparing at least a second model representation of the body object data stream to the determined one or more techniques defined in the technique dictionary; and
providing multimedia content corresponding to the one or more techniques according to the assessment of the performance in executing the one or more techniques.

2. The method of claim 1, wherein the raw sensor data stream corresponds to an amount of time in executing the one or more movements, the amount of time comprising a plurality of slices of raw sensor data, and wherein generating the body object data stream from the sensor data stream comprises, for each slice of the raw sensor data:
detecting a plurality of body elements of the moving body and position information associated with the plurality of body elements from a respective slice of the raw sensor data;
creating a plurality of body object segments corresponding to the plurality of body elements;
generating a quaternion for each body object segment, each quaternion comprising positional information and orientation information associated with a respective body object segment; and
constructing a model representation of a posture using one or more of the plurality of body object segments and associated quaternions.

3. The method of claim 2, wherein generating the quaternion for at least one body object segment comprises:
inferring orientation information for the at least one body object segment using quaternions associated with one or more other body object segments.

4. The method of claim 1, wherein the plurality of model representations are 3D models of the postures.

5. The method of claim 1, wherein the raw data stream is a plurality of image frames generated by one or more image sensors that capture the one or more movements of a portion of the moving body, and wherein each model representation of the plurality of model representations corresponds to a pose of a portion of the moving body in an image frame of the plurality of image frames.

6. The method of claim 1, further comprising:
storing a plurality of reference techniques in the technique dictionary, each reference technique comprising:
a sequence movement comprising an ordered list of key postures, wherein the key postures are ordered according to the respective technique; and
one or more nuance movements, each comprising one or more nuance postures.

7. The method of claim 6, wherein determining one or more techniques for the one or more movements executed by the moving body comprises:
comparing the first model representation of the body object data stream to the sequence movement;
determining that the first model representation of the body object data stream is indicative of a first key posture of the ordered list based on the comparison.

8. The method of claim 7, wherein the body object data stream comprises a third model representation, wherein determining one or more techniques corresponding to the one or more movements executed by the moving body comprises:
determining that the third model representation of the body object data stream is indicative of a second key posture that is subsequent to the first key posture in the ordered.

9. The method of claim 6, wherein assessing the performance in executing the one or more techniques comprises:
comparing the second model representation of the body object data stream to at least one nuance movement of the one or more nuance movements;
calculating a degree of closeness between the second model representation of the body object data stream and a nuance posture of the at least one nuance movement.

10. The method of claim 1, further comprising:
incrementing or decrementing a value of a counter based on the performance in executing the one or more techniques,
wherein providing the multimedia content is responsive to incrementing or decrementing a counter, the multimedia content configured to communicate the value of the counter to a user.

11. The method of claim 1, wherein the multimedia content is provided in real-time for real-time presentation of the multimedia content on a user system.

12. The method of claim 1, further comprising:
identifying one or more faults in the execution of the one or more techniques based on the assessed performance in executing the one or more techniques; and
responsive to identifying the one or more faults, selecting multimedia content responsive targeted at correcting the identified one or more faults and providing the multimedia content.

13. A system, comprising:
a datastore configured to store a technique dictionary;
one memory configured to store instructions; and
one or more hardware processors communicatively coupled to the memory and configured to execute the instructions stored in the memory to:
obtain a raw sensor data stream associated with one or more movements executed by a moving body;
generate a body object data stream from the raw sensor data stream, the body object data stream comprising a plurality of model representations of postures indicative of the one or more movements;
determine one or more techniques corresponding to the one or more movements executed by the moving body by comparing at least one first model representation of the body object data stream to one or more reference postures corresponding to a plurality of techniques defined in a technique dictionary; and
assess a performance in executing the one or more techniques by comparing at least a second model representation of the body object data stream to the determined one or more techniques defined in the technique dictionary; and
providing multimedia content corresponding to the one or more techniques according to the assessment of the performance in executing the one or more techniques.

14. The system of claim 13, wherein the raw sensor data stream corresponds to an amount of time in executing the one or more movements, the amount of time comprising a plurality of slices of raw sensor data, and wherein the one or more hardware processors are further configured to:
detect a plurality of body elements of the moving body and position information associated with the plurality of body elements from a respective slice of the raw sensor data;
create a plurality of body object segments corresponding to the plurality of body elements;
generate a quaternion for each body object segment, each quaternion comprising positional information and orientation information associated with a respective body object segment; and
construct a model representation of a posture using one or more of the plurality of body object segments and associated quaternions.

15. The system of claim 13, further comprising:
one or more image sensors configured to capture the one or more movements and generate the raw data stream as a plurality of image frames of the one or more movements,
wherein each model representation of the plurality of model representations corresponds to a pose of the moving body in an image frame of the plurality of image frames.

16. The system of claim 15, further comprising:
a user device comprising at least the one or more hardware processors, the memory, and the one or more sensors, wherein the user device is one of a desktop computer, a laptop computer, a tablet computer, a smart phone, a wearable mobile device, connected fitness equipment, a game console, a television, a set-top box, and an electronic kiosks.

17. The system of claim 16, wherein the user device comprises at least one of a display and one or more speakers, wherein the one or more hardware processors are further configured to:
present the multimedia content to a user using at least one of the display and one or more speakers.

18. The system of claim 15, further comprising:
a user system associated with a facility, the user system comprising at least the one or more hardware processors, the memory, and the one or more sensors.

19. The system of claim 13, wherein the one or more hardware processors are further configured to:
obtain a raw training data stream of one or more training movements;
generate a training body object data stream from the raw training data stream;
receive annotations for the body object data stream based on user input;
generate a reference technique based on the training body object data stream and the received annotations; and
store the reference technique in the technique dictionary.

20. A non-transitory computer readable medium storing instructions that, when executed by at least one hardware processor, cause the at least one hardware processor to:
execute movement recognition system configured to generate a body object data stream from raw sensor data of one or more movements executed by a moving body, recognize one or more techniques for the one or more movements based on the body object data stream, and assess a performance in executing the one or more techniques; and
execute a coaching intelligence system configured to select multimedia content descriptive of the recognized one or more techniques according to the performance in executing the one or more techniques and based on one or more configuration files defining coaching strategies and a mapping of techniques and performance in executing the techniques to a plurality of multimedia content.
